(19) United States
(12) Patent Application Publication
(10) Pub. No.: US 2013/0090941 A1
(43) Pub. Date: Apr. 11, 2013

(54) METHOD OF PROVIDING COMPLICATION INSURANCE AND DISCOUNTS ON MEDICAL SPECIALTY TREATMENTS

(71) Applicants: Trish J. Taylor, Austin, TX (US); Gary H. Hickox, Rancho Mirage, CA (US)

(72) Inventors: Trish J. Taylor, Austin, TX (US); Gary H. Hickox, Rancho Mirage, CA (US)

(21) Appl. No.: 13/423,813

(22) Filed: Mar. 19, 2012

Related U.S. Application Data
(63) Continuation-in-part of application No. 13/267,833, filed on Oct. 6, 2011.

(51) Int. Cl. G06Q 40/08; G06Q 50/22

(52) U.S. Cl. 705/2

(57) ABSTRACT

The present invention is a method for providing consumers with complication insurance and discounts on medical specialty treatments, products, and services through a membership program. More specifically, the method provides consumers with insurance for complications that might be experienced through specialty medical treatments and discounts on the actual specialty medical treatments. The invention requires the participation of the customer (patient and/or intended parents), the specialty medical provider, an insurance agency/provider, and a third party administrator.

### CROSS-REFERENCES OF RELATED APPLICATIONS

This Application is a Continuation-in-Part of U.S. Non-Provisional patent application Ser. No. 13/267,833, filed on Oct. 6, 2011, entitled “METHOD OF PROVIDING DISCOUNTED PRODUCTS AND SERVICES”, by inventors Trish J. Taylor and Gary H. Hickox, the contents of which are expressly incorporated herein by this reference, and to which priority is claimed.

### FIELD OF THE INVENTION

The invention relates, generally, to a method for providing consumers with complication insurance and discounts on medical specialty treatments, products, and services through a membership program. More specifically, the method provides consumers with insurance for complications that might be experienced through specialty medical treatments and discounts on the actual specialty medical treatments. The invention requires the participation of the customer (patient and/or intended parents), the specialty medical provider, an insurance agency/provider, and a third party administrator.

### BACKGROUND OF THE INVENTION

Each year, thousands of couples discover that having a baby will be more difficult than they thought due to infertility. The medical and pharmaceutical industries have developed treatments and drugs in order to help those couples overcome infertility problems. Although many of these treatments and drugs are effective, they can be very expensive. Furthermore, the treatments and drugs might require months or even years to be effective. Accordingly, in order to have a baby, infertile couples must sometimes spend thousands or even tens of thousands of dollars over the course of several years.

Although infertility is typically a medical problem, the costs of treating the infertility are not covered by many standard health insurance plans or companies. As such, the high costs of fertility treatments and drugs are borne completely by the couple seeking the treatments or drugs. Although infertility insurance is available, for individuals or for insurance plans, this insurance is expensive and is not affordable for many couples. Moreover, the costs, which at first may seem achievable to some couples, can quickly escalate if problems arise.

Currently, Risk Shared programs are provided by some In Vitro Fertilization (IVF) centers or providers and these Risk Shared programs provide some discounts in medical specialty services. However, these Risk Shared programs are not offered in conjunction with insurance coverage and no discounts on infertility medications are offered. As a result, a patient or customer has to search for an IVF center with a Risk Shared program and then search for insurance coverage separately. Another problem with the Risk Shared program is the qualifying criteria are very high and only acceptable, pre-screened customers are allowed to participate. Thus, participation is very limited.

Therefore, what is needed is a plan, program, and method that provides consumers with insurance for complications that might be experienced through specialty medical treatments and discounts on the actual specialty medical treatments.

### SUMMARY OF THE INVENTION

To minimize the limitations in the prior art, and to minimize other limitations that will become apparent upon reading and understanding the present specification, the present invention discloses a new and useful method for providing consumers with insurance for complications that might be experienced through specialty medical treatments and discounts on the actual specialty medical treatments.

The present invention is a method of providing and administrating a program that provides insurance and discounts on medical services and goods. More specifically, the present invention is a program for enabling participants to obtain both complication insurance and discounts on medical specialty treatment, goods, and services through use of a discount membership card. Preferably, the medical specialty treatment, goods, and services are related to infertility treatments, drugs, and procedures.

In order to provide the combination of complication insurance, discount medical specialty treatment, and services, the program administrator negotiates contracts with providers of medical specialty services, pharmacy services, and insurance providers. The user preferably enrolls in the administered program and obtains: (1) insurance from the insurance provider; (2) discounted specialty medical treatments from the medical specialty provider or clinic; and (3) discounted pharmaceuticals from a participating pharmacy. The user is granted a discount membership card, which is used to obtain the discounted services and drugs. Preferably, the discounts on pharmaceuticals cover certain agreed to and prescribed medications to treat the specialty medical condition. The pharmaceutical discounts are preferably negotiated in the contract between the administrator (or third party administrator) and the pharmaceutical company and/or the pharmacy. Preferably, the discounts on specialty medical treatment cover certain agreed to and prescribed treatments to treat the specialty medical condition. The specialty medical treatment discounts are preferably negotiated in the contract between the administrator (or third party administrator) and the specialty medical treatment provider and/or clinic such as an IVF center. Preferably, the method of the present invention offers the discounts directly to the patient through several different marketing channels. The present invention allows the specialty medical treatment provider or clinic, such as an IVF center, the pharmaceutical company, and/or the pharmacy an avenue to brand themselves individually and/or together to the public and distribute their discounts directly to the patient, with or without traditional insurance.

It is an object of the present invention to overcome the limitations of the prior art.

It is an object of the present invention to a global one-time pay fee for a specialty medical problem, disorder, or disease, such as infertility. This alleviates the stress of the financial burden to the patient so they have a known total investment in the process of attempting to start expand their family.

It is an object of the present invention to offer specialty medical treatment, such as IVF treatment and insurance, specifically complication insurance, in a single program.

It is an object of the present invention to have a qualifying criteria is minimal compared to Risk Shared programs, which limits patient use.

It is an object of the present invention to provide a choice of several programs that provide insurance or supplemental insurance that fills the gap in a patient's personal health coverage.

It is an object of the present invention to allow a user to control the amount spent by charging a single set of out-of-pocket prices to provide peace of mind while being treated for infertility to achieve a successful pregnancy.

It is an object of the present invention to reduce exposure to unforeseen expenses of specialty medical treatments, such as fertility treatments, testing, and services. It is an object of the invention to contain the total out of pocket costs paid by the user to a sum certain, depending on a treatment plan prescribed by a doctor.

It is an object of the invention to reduce the administrative costs of providing specialty medical treatments, such as fertility treatments by covering under one payment, the cost of insurance, consultations, fertility treatments, testing, and other services provided within the proscribed treatment and corresponding plan.

It is another object of the present invention to be used for any known risk medical specialty that is not covered by traditional medical or health insurance.

It is an object of the present invention to provide a method managing discounts for prescribed fertility medications and services.

It is a further object of the invention to provide patients the financial ability to continue their desired medical treatment until success.

It is another object of the present invention to have access to a discount program that: a) provides more patient access to prescription medication discounts with immediate value being available in retail stores with in-pharmacy services and inside OBGYN offices and fertility centers; b) provides patients with immediate face-to-face consultation for their discounted medications when purchased in the pharmacy or store or fertility center; c) provides patient direct discounts on fertility medications where no other discounts are available to the patient directly outside of the fertility doctor; d) provides cash paying patients with no traditional insurance or limited to no prescription medication or limited to no fertility medication coverage a substantial discount on their medication needs; e) provides an avenue of branding for the pharmaceutical companies that participate on the card; f) provides an avenue of branding for the pharmacies that participate on the card; g) provides the opportunity for the pharmaceutical company and the pharmacy company to associate their brand's together for maximum market impact; and h) allows makers of retail products, i.e. pregnancy test kits, to offer their users substantial discounts on fertility medications by way of co-marketing features of present invention on the product packaging.

It is an object of the present invention to provide a method of providing discounts of fertility care drugs through a care card. The card may be sold by the program provider, a pharmacy, a fertility doctor or clinic, a retail store, an insurance agency, or a pharmaceutical company. The card may be bought at a physical location or online Once purchased, the customer registers his or her information with the online discount program administrator. The card may then be used to purchase prescription fertility medicines. The pharmacy fulfilling the prescription, provides the promised medication discounts and processes the patients' payment for the prescription over the phone or in the pharmacy. The prescription is picked up at the in-store pharmacy or the pharmacy mails the medication direct to the patient. Preferably, there is a special identification between the particular pharmaceutical drug company and the pharmacy in order to track sales and identify each medication discount. If the customer buys the card, he or she preferably receives a gift card for the amount paid to enroll in the discount program and receive the discount card. The gift card is preferably redeemable at the store/pharmacy where the discount card was sold.

One embodiment of the invention is a method of providing discounted specialty medical treatment and complication insurance on the specialty medical treatment, the steps comprising: contracting between a specialty medical treatment provider, an insurance agency, and an administrator to provide one or more patients with a discount on a specialty medical treatment and a complication insurance on the specialty medical treatment; administrating by the administrator the specialty medical treatment and the complication insurance on the specialty medical treatment; applying with the administrator by a patient for the complication insurance on the specialty medical treatment and for the specialty medical treatment; purchasing by the patient the complication insurance on the specialty medical treatment and purchasing the specialty medical treatment; providing to the patient by the specialty medical treatment provider with the discount on the specialty medical treatment; providing to the patient by the insurance agency with the complication insurance on the specialty medical treatment. Preferably, the method also includes the following: wherein the specialty medical treatment provider is an In Vitro Fertilization center; wherein the patient is one or more intended parents; wherein the applying step includes completing at least a female application; wherein the applying step includes completing a male application; completing a HIPAA form by the patient; wherein the female application is approved by the insurance agency and a medical doctor; creating by the administrator an electronic and paper file for the patient; creating by the administrator an electronic membership enrollment profile for the patient; issuing by the administrator a membership ID card to the patient; issuing an insurance certificate to the patient; submitting by the specialty medical treatment provider a regular online report to the administrator regarding one or more enrolled patients of the specialty medical treatment provider; paying by the administrator the specialty medical treatment provider every month for the one or more enrolled patients until one event occurs from the events consisting of: pregnancy, exhausting of cycles, and payment in full; providing the one or more enrolled patients with a gift card and a pharmacy discount card.

Another embodiment of the invention is computer-based method of administrating and providing discounted specialty medical treatment and complication insurance on the specialty medical treatment, the steps comprising: contracting between a specialty medical treatment provider, an insurance agency, and an administrator to provide one or more patients with a discount on a specialty medical treatment and a complication insurance on the specialty medical treatment; providing a computer-based program for administering the specialty medical treatment and complication insurance; wherein the computer-based program for administering the specialty medical treatment and the complication insurance is operated by the administrator and is accessible to the insurance agency and the specialty medical treatment provider; applying with the administrator by a patient for the complication insurance on the specialty medical treatment and for the specialty medical treatment; purchasing by the patient the complication insurance on the specialty medical treatment and purchasing the specialty medical treatment; providing to the patient by the specialty medical treatment provider with the discount on the specialty medical treatment; providing to the patient by the insurance agency with the complication insurance on the specialty medical treatment; wherein the specialty medical treatment provider is an In Vitro Fertilization center; wherein the patient is one or more intended parents; wherein the applying step includes completing at least a female application; wherein the applying step includes completing a male application; completing a HIPAA form by the patient; wherein the female application is approved by the insurance agency and a medical doctor; creating by the administrator paper file for the patient; creating by the administrator an electronic file for the patient on the computer-based program for administering the specialty medical treatment and complication insurance; creating by the administrator an electronic membership enrollment profile for the patient on the computer-based program for administering the specialty medical treatment and complication insurance; issuing by the administrator a membership ID card to the patient; generating an insurance certificate by the computer-based program for administering the specialty medical treatment and complication insurance; issuing the insurance certificate to the patient; submitting by the specialty medical treatment provider a regular online report to the administrator regarding one or more enrolled patients of the specialty medical treatment provider on the computer-based program for administering the specialty medical treatment and complication insurance; paying by the administrator the specialty medical treatment provider every month for the one or more enrolled patients until one event occurs from the events consisting of: pregnancy, exhausting of cycles, and payment in full; and providing the one or more enrolled patients with a gift card and a pharmacy discount card; wherein the pharmacy discount card is part of a computer-based discount management program.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of the HIPAA Form of the present invention.

FIGS. 2 a-g are an illustration of one embodiment of the female application of the present invention.

FIG. 3 a-g are an illustration of one embodiment of the male application of the present invention.

FIGS. 4 a-i are an illustration of one embodiment of a letter of agreement between an insurance agency and a specialty medical treatment provider.

FIGS. 5 a-s are an illustration of one embodiment of an enrollment certificate for complication insurance of the present invention without surrogacy coverage.

FIGS. 6 a-v are an illustration of one embodiment of an insurance certificate for complication insurance of the present invention without surrogacy pregnancy coverage.

FIGS. 7 a-u are an illustration of one embodiment of an enrollment certificate for complication insurance of the present invention with surrogacy coverage.

FIGS. 8 a-w are an illustration of one embodiment of an insurance certificate for complication insurance of the present invention with surrogacy pregnancy coverage.

FIG. 9 is an illustration of one embodiment of a medical authorization of pregnancy form.

### DETAILED DESCRIPTION OF THE INVENTION

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “discount card” refers to any card that provides discounts for current purchases of fertility-based pharmaceutical products and may be in the form of, without limitation, PEG cards, gift cards, phone cards, credit cards, pharmacy cards, and coupon cards. The term “third party” refers any entity other than the patient, and may include, without limitation, insurance companies, pharmacies, pharmaceutical drug companies, retail stores, administration companies, or government agencies.

Although the present invention is a method of providing complication insurance and specialty medical treatment for various types of conditions and diseases, including, but not limited to diseases pertaining to: Allergy and Immunology; Anaesthesiology; Pathology; Cardiology; Paediatric cardiology; Cardiothoracic surgery; Child and adolescent psychiatry and psychotherapy; Clinical neurophysiology; Dermato-Venereology; Endocrinology; Gastroenterology; Geriatrics; Gynaecology and obstetrics; Health Informatics; Infectious diseases; Internal Medicine; Interventional Radiology; Vascular medicine; Microbiology; Nephrology; Neurology; Neurosurgery; Nuclear medicine; Occupational medicine; Ophthalmology; Orthopaedics; Oro-Maxillo-Facial Surgery; Otorhinolaryngology; Paediatrics; Paediatric allergology; Paediatric endocrinology and diabetes; Paediatric gastroenterology, hepatology and nutrition; Paediatric haematology and oncology; Paediatric infectious diseases; Neonatology; Paediatric Nephrology; Paediatric respiratory medicine; Paediatric rheumatology; Paediatric surgery; Physical and Rehabilitation Medicine; Plastic, Reconstructive and Aesthetic Surgery; Pneumology; Psychiatry; Public Health; Radiology; Neuroradiology; Radiotherapy; General surgery; Urology; and Vascular surgery; the present invention is preferably directed to infertility and insurance and treatments for infertility.

In a preferred embodiment, invention is an insurance program for infertile patients with limited or no traditional insurance coverage for IVF and/or for people that need a surrogate because they are unable or choose not to carry their unborn baby that is conceived through IVF. The present invention provides one global price for the actual IVF procedures and cycle complication insurance pertaining to IVF or surrogate pregnancies. The entire process is offered in one global price from the infertility diagnosis through IVF treatment and all medically necessary procedures at the reproductive endocrinology doctor's office until and through maternity care and child birth whether or not it is a delivery by the mother or by a surrogate. The method of the invention includes negotiated rates for IVF treatments and all services, procedures, testing that occurs in-clinic that are related to infertility and enabling patients to achieve pregnancy through IVF. The plan also preferably includes discounts on specific infertility medications.

The present invention, which will be offered under the Trademarked name Assisted Reproduction Insurance Program® has several new and one of a kind offerings to the IVF patient that have never been offered in combination. These offerings include:
a) The offering of insurance and discounted medical specialties and discounted pharmacy medications in one cohesive program.
b) The offering of insurance and discounted medical specialties and discounted pharmacy medications in one cohesive global price with several plans to choose.
c) The offering of IVF maternity and IVF cycle insurance and discounted medical specialties and discounted pharmacy medications in one cohesive program.
d) The offering of IVF maternity and IVF cycle insurance and discounted medical specialties and discounted pharmacy medications in one cohesive global price with several plans to chose from and as diagnosed by the doctor.
e) The administering of insurance and discounted medical specialties and discounted pharmacy medications by a Third Party Administrator (TPA).
f) The administering between or contracting thereof a medical facility, an insurance agency, and a third party administrator. The program provides a third party agreement between a licensed Third Party Administrator (TPA) and an insurance agency, and the IVF center. This agreement binds all three parties to the following: the IVF center agrees to one global price, or program fund paid by patients/users to achieve pregnancy including all in-clinic IVF treatment, testing, consultations, surgeries, and services. p1 g) The TPA preferably agrees to manage and administer the program fund for the IVF center and pays the IVF center on a monthly basis until or if pregnancy occurs. The TPA pays insurance claims from cycle complications and pregnancy according to which of the several plans are selected, based on diagnosis.
h) The insurance agency preferably coordinates the enrollment of the IVF centers into the present invention. The insurance agency also preferably coordinates the offering for sale and sale of the complication insurance and IVF services and treatments provided by the IVF centers, to the IVF patients and intended parents. The IV center once enrolled becomes a program provider. The insurance agency provides referrals of patients and intended parents to the program providers. The insurance agency charges the patients a premium and a broker fee, as agreed to within the program provider agreement.
i) The goods and services provided through the method of the present invention is preferably offered to the general public not exclusive to any specific IVF center, but preferably is only available to the IVF centers that have contracted to become program providers.
j) The present invention preferably assures that all medically necessary fees, from in-clinic IVF charges to cycle complications, to and through IVF pregnancy, are covered under one global price (which is selected through several plan choices/diagnosis).
k) The present invention preferably includes cycle complication and IVF pregnancy insurance in its pricing to the patients and intended parents.
l) The present invention is a stand-alone insurance program that can be purchased for a known risk of infertility, IVF pregnancy, and/or surrogacy pregnancy.
m) The present invention is the only program that offers discounted in-clinic IVF treatment, testing, consultations, surgeries, and/or services for one global price.
n) The present invention is the only program that offers the combination of discounted in-clinic IVF treatment, testing, consultations, surgeries, services and insurance coverage combined.
o) The present invention is the only program to offer IVF pregnancy coverage as a known potential risk.
p) The present invention is the only stand-alone insurance program that provides underwriting on an IVF patient, IVF pregnancy, or surrogate pregnancy.
q) The present invention is the only stand-alone insurance program that provides insurance for a known risk of IVF cycles and procedures.
r) The present invention is the only stand-alone insurance program that provides insurance for a known risk of infertility.
s) The present program is the only program that preferably offers regional benefits to the first IVF Center within a particular region that signs up to become a program provider. Specifically, the first program provider in a region is preferably contractually ensured that his costs will not be beat by later program providers.

The present invention offers numerous advantages over currently available specialty medical plans and insurance programs including, preferably, the following: no stand-alone insurance program exists that covers a known medical event for the disease, such as infertility, for the patient or intended parent; no stand-alone insurance program exists that covers a known medical event for the disease of infertility and for the known medical expense of IVF cycling, IVF pregnancy or surrogate pregnancy for the patient or intended parent; no third party agreement exists that manages the cost of a known event for the disease of infertility for the patient or intended parent; and no third party agreement exists that manages the cost of a known event for the disease of infertility and for the known medical claims of IVF cycling, IVF pregnancy, and/or surrogate pregnancy for the patient or intended parent.

The present invention is advantageous for infertile patients and people who are unable to carry or choose not to carry their unborn baby, which is conceived through IVF. Other features of the present invention include, but are not limited to, providing: (1) users (the general public) with a third party guarantee of negotiated rates (or discounted rates) through the Third Party Administrator for IVF procedures and infertility services; (2) more patient access to infertility insurance and prescription infertility medication discounts with immediate value being available in retail stores with in-pharmacy services and inside OBGYN offices and fertility centers; (3) patients with infertility and IVF pregnancy insurance when they have limited infertility coverage, no traditional infertility insurance coverage, or no traditional insurance coverage at all; providing in-clinic consultations, IVF, Frozen Embryo Transfer, in-clinic testing (for male and female partners), surrogate and egg donor medical screening, and a 100% refund of the global price paid (less patient fees incurred and less the enrollment fee) all in exchange for the global price paid by the user; (4) a 50% credit of Program Fund if egg donor plan option or any other plan option is chosen when transferring from initial plan prior to a second cycle; (5) an enrollment term of up to 18 months; and (6) control with one set out of pocket prices.

Preferably, the present invention includes support from a customer care claims advocate within the third party administrator between the insurance agency, the reproductive endocrinologist doctor, and the patient or intended parents.

Preferably, the present invention may be embodied by several different plans that provide insurance or supplemental insurance that fills the gap in the patients traditional insurance for the specialty medical treatment, such as IVF treatment.

Preferably, the In-Clinic IVF treatment offered to the patient includes at least one, but possibly several, IVF cycles, and all Frozen Embryo Transfers, which result out of same cycle.

Preferably, the treatment covered by the present invention includes cycle inclusion of blastocyst and blastocyst co-culture with cumulus cells and Intracytoplasmic Sperm Injection (ICSI) with assisted hatching.

Preferably the in-clinic testing provided for the female and male partners include hormonal testing, complete blood counts, urine analysis, Erythrocyte Sedimentation Rate, pelvic ultrasound, semen analysis, and antisperm antibody.

Preferably, the present invention includes coverage for in-clinic Cryostorage as a result of plan treatment for embryo and sperm up to one year.

Preferably, the present invention provides $500,000 in negotiated rates for maternity and delivery insurance on the effective date of the insurance and shall continue in full force and replenish deductibles until the patient reaches a successful pregnancy up to 26 weeks or to maturity of the effected policy no greater than 18 months from the six week ultra sound.

Preferably the present invention provides a 100% refund on insurance certificate premiums issued on the IVF pregnancy or IVF surrogate pregnancy, less a broker fee and less all cycle premiums in the event pregnancy is not achieved.

Preferably the present invention provides insurance coverage for an in-clinic injury or sickness at $250,000 per Program Participant, combined single limit.

Preferably the present invention provides insurance coverage for an in-clinic Accidental Paralysis at $100,000 in respect of Accidental Paralysis Coverage combined single limit.

Preferably the present invention provides insurance coverage for an in-clinic Accidental Death at $100,000 in respect of Accidental Death Coverage combined single limit.

Preferably the present invention provides insurance coverage for all Medical Expenses incurred, arising out of maternity and childbirth by the insured, who has been impregnated, is carrying two fetus' or less, and will give birth as an IVF pregnancy or surrogate pregnancy.

Preferably the present invention provides an Aggregate Self Insured Retention for the IVF or surrogate pregnancy: 35 or under: $15,000.00 (one fetus pregnancy birth, per pregnancy per surrogate), $30,000.00 (two fetus pregnancy birth, per pregnancy per surrogate); or 36 or over: $25,000.00 (one fetus pregnancy birth, per pregnancy per surrogate), $37,500.00 two fetus pregnancy birth, per pregnancy per surrogate).

Preferably the present invention provides a maternity maximum Plan Benefits for an IVF pregnancy or a surrogate pregnancy: $500,000.00 (C.S.L) (any one Surrogate, any one term of pregnancy); In Patient Bed Rest: 50,000.00 (Physician ordered hospitalization, Underwriters pre-authorization required). Non Network Facility/Practitioner: Limited to amount that would be paid to a PPO Network or In Network provider within the geographic area where services were rendered.

Preferably the present invention provides insurance coverage for IVF cycle coverage and Maximum Plan Benefits: (a) Oocyte Donor screening, synchronization and related procedures provided that such Medical Expenses are incurred within ninety (90) days of the effective date—provided such expenses are incurred within (90) days of the effective date an additional 30 days of coverage will be extended; (b) recipient screening, synchronization and related procedures provided that such Medical Expenses are incurred within ninety (90) days of the effective date—provided such expenses are incurred within (90) days of the effective date an additional 30 days of coverage will be extended; and/or (c) Oocyte Donor and Recipient combined screening, synchronization and related procedures provided that such Medical Expenses are incurred within ninety (90) days of the effective date—provided such expenses are incurred within (90) days of the effective date an additional 30 days of coverage will be extended.

Preferably the present invention provides insurance coverage at: $250,000 per Oocyte Donor and per Recipient, for any one cycle, in respect of Medical Expense Coverage combined single limit; $100,000 per Oocyte Donor and per Recipient in respect of Accidental Paralysis Coverage combined single limit; and/or $100,000 per Oocyte Donor and per Recipient in respect of Accidental Death Coverage combined single limit.

The present invention provides numerous advantages for the specialty medical provider, such as an IVF center or clinic, which agree and enroll as a program provider, including, but not limited to providing:
1) the IVF center with a cohesive cost saving insurance program to offer its patients;
2) free administration of patient billing There are no billing services needed within the program providers because the present invention provides for a global monthly billing system with one payment per month for each patient until or if patient achieves pregnancy direct to the program provider (or clinic). The program provider does not bill the patients traditional insurance, which is an extreme hassle. This can cut the program provider's billing administration in half, if not eliminate altogether.
3) free marketing materials and marketing of patient referrals to the program provider (or clinic). Alternatively, the IVF centers may be charged for marketing services through the insurance agency.
4) management and administration of patient billing, patient insurance consults, and national and international brand marketing for the center.
5) Enhances the patient's financial ability to continue treatment until success, which enhances IVF center's (program provider's) profits.
6) a regional pricing program for the first center to sign up as a program provider within the present invention wherein the first IVF center to enroll in the present invention will receive the optimum set regional price for their region. No other later IVF center may enroll as a program provider within the present invention with better pricing. All other IVF centers that join the present invention may match the first regional program provider but cannot under price the first regional program provider.
7) Center Marketing, wherein the marketing programs for each center is designated by volume and levels of participation within the present invention.
8) Patient Direct Marketing, which is a patient direct marketing program that may allow all participating centers to benefit with management and production by the coordinator, administrator, or third party administrator of the present invention.

The present invention provides numerous advantages for the traditional insurance market, including but not limited to:
1) The insurance provided within the present invention becomes the primary coverage for, or carves out the high-risk of, infertility and IVF specialist treatment and IVF and surrogate pregnancy treatment for the patient and their traditional insurer, and provides seamless coverage from infertility diagnoses through IVF pregnancy and delivery, then allows the patient to continue with their traditional insurance plan as the primary coverage for conditions not related to fertility.
2) With the present invention the traditional insurance market in the United States of America can save millions and possibly billions by implementing the present invention for infertility patients and IVF pregnancies by way of one administrator managing the entire process in order to control the risk. This is accomplished by monitoring the IVF process and providing certain exclusions and pregnancies over two fetus's and implementing the appropriate deductibles to control high-risk medical procedures.

The present invention brings together the medical specialist, the program provider, and the patient in the following preferred process:
The patient contacts an insurance agency regarding getting insurance related to infertility.
An insurance consultation is set up by the insurance agency policy coordinator and links to brochures are sent with program provider choices attached.
Once a program provider is chosen the insurance agency policy coordinator reviews the general Benefits and Exclusion of the present invention with the patient. They may talk about specific Plan Options if the patient or intended parent so chooses, but the plan selected must be doctor prescribed and Plan Options that are not relevant are not recommended to the patient by the insurance agency policy coordinator.
The insurance agency policy coordinator emails (or otherwise communicates) the present invention application form to the patient. Information is also sent to prompt the patient to set up an IVF doctor appointment. A copy of this email is also sent to the program provider's contact (typically the patient financial coordinator) that is on file with insurance agency.
If Surrogate/Patient Maternity Comprehensive coverage is involved, the application with the insurance agency must be completed and approved prior to screening by the doctor. Once this application is approved, an email is sent to the intended parents and/or patient and program provider to advise whether screening may occur (if it has not already been completed).
The insurance agency policy coordinator then follows up with the Patient and IVF center (program provider) every week until the necessary applications are completed, the Plan Options are agreed to, and/or the program provider has completed the initial consultation and testing.
The IVF doctor or the program provider's patient financial coordinator will inform the patient with which Plan Options are prescribed by the doctor.
The program provider's patient financial coordinator (or other administrator) will then advise the patient to pay the global office visit fee of $600 (per the centers contract with the administrator) to the IVF Center. The global office visit fee will be deducted from the total bill of the Plan Option once the administrator of the present invention requests the total Program Fund from the Patient within the next 24 hours. The program provider may request payment prior to seeing the patient. If patient chooses not to use the program provider, the program provider will manage the office visit fee difference directly with the patient.
Once the patient agrees to the Plan Option they would like to move forward with, the program provider's Patient Financial Coordinator forwards the Account Summary Billing Statement to the insurance agency.
The insurance agency policy coordinator sends an email request to the patient or intended parents for the Program Funds and application (if this has not been submitted).
The insurance agency policy coordinator emails the Program Receipt of Funds and the Program Enrollment Certificate to patient or intended parent.
Enrollment Process—an enrollment Thank You email along with attached enrollment ID card will be sent.

If Surrogate/Patient Maternity Comprehensive coverage is involved, the following steps are preferably included:
After the insurance agency underwriting department has approved the application and the Program Plan Program Funds have been received and the IVF pregnancy or surrogate pregnancy has occurred:
   A Medical Authorization of Pregnancy is retrieved by the insurance agency from the IVF center/program provider.
   The IVF pregnancy or surrogate pregnancy insurance certificate is effected and issued to the insured.
   Pregnancy claims are paid according to insurance certificate coverage.
   Claims processing and billing system is managed by the third party administration department and online claims system.
   The online claims pay and billing system is designed specifically for the program providers and Patients.

All email communication to and from the IVF Center is preferably sent to or copied to the IVF Center contact or Patient Financial Coordinator.

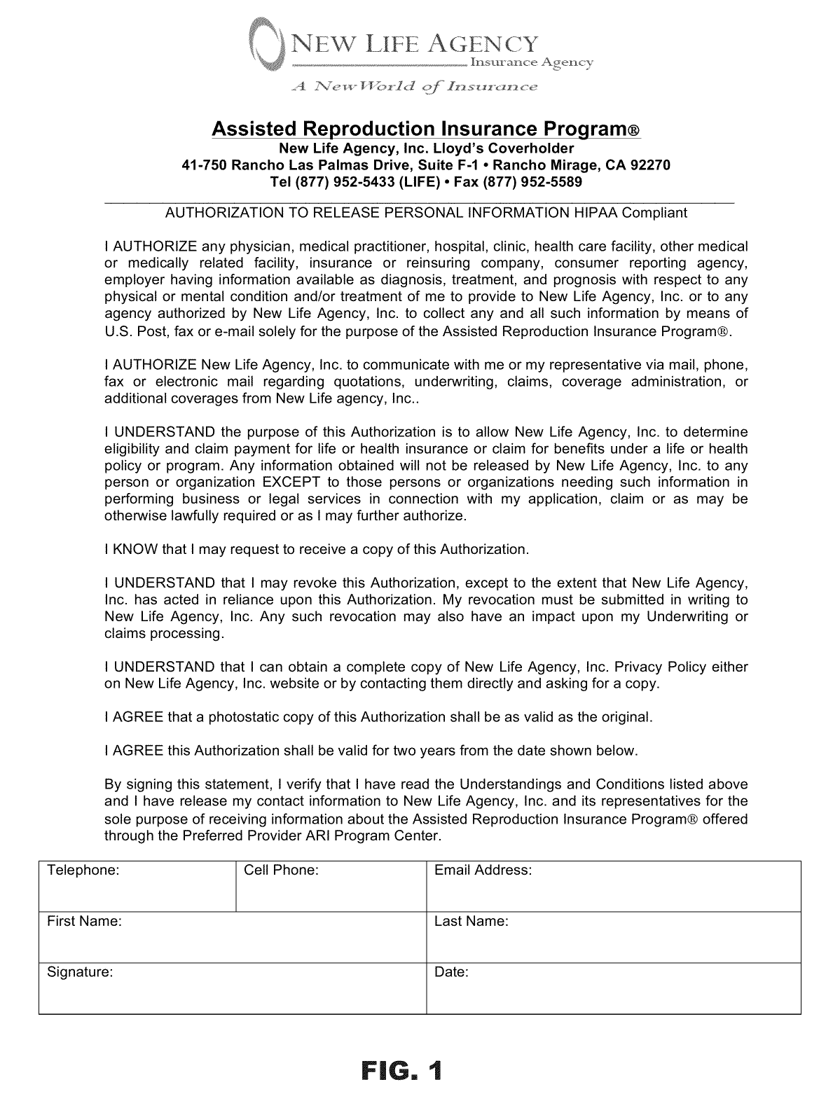

The following steps are preferably included for an IVF Center/program provider referral:
The Patient requests the present invention/program with the program provider/IVF center.
The Patient may request upfront prior to visiting the program provider, while talking with the IVF doctor, or while with the program provider's Patient Financial Coordinator.
At any time patient may be given the Program Provider brochure of the present invention and referred directly to the insurance agency for questions.
The program provider relays the potential savings that the program is designed to offer the patients who take advantage of the present invention.
Once the Patient talks with the Patient Financial Coordinator at the program provider, the program provider brochure is given to the patient and a brief overview of the Program Fund is shared with the patient.
The Patient Financial Coordinator requests that the patient sign the HIPAA form (see FIG. 1) and arranges to have the insurance agency policy coordinator contact to the patient later to answer any questions.
The Patient Financial Coordinator emails or faxes the HIPAA form to the insurance agency to proceed with the insurance consultation review for the present invention.

The method of the present invention preferably includes steps for the program providers to report online regarding the present invention, the steps including:
Each IVF center or program provider reports each month all of the IVF cycles on all patients taking advantage of the present invention.
The IVF center enters a user name password to an administration website that is set up by the administrator of the present invention.
The IVF center enters all of the information for the participants/patients in the IVF cycle (i.e., the Oocyte Donor name, number, and/or address; and/or the egg Recipients name, number, and/or address. The number of cycles the donor or recipient have participated in, and what type of Plan the patient is enrolled in is also preferably entered.
The IVF center preferably initials and signs the report and submits to the insurance agency every month.
The online administration system is preferably designed for the IVF center to go through any time in the month and add patients and save the information.
Once the online administration receives a submitted report it auto-generates each insurance certificate on the appropriate cycle and emails the insurance agency the insurance documents.
The insurance agency forwards the insurance certificates to the patients and the IVF center.
The patient now has complication insurance and access to discounted medical specialty treatment.

Once the patient signs up to be part of the program of the present invention, the patient is preferably offered a discount card for pharmaceuticals related to their medical condition, such as infertility. Preferably, a pharmacy gift card will be included within the first package of medication ordered with the discount pharmacy card. Information regarding the discount pharmacy card and pharmacy gift card may be provided to the patient in the enrollment email along with the toll free number to call and order medication. The discount will be advised by the pharmacy once patient calls the pharmacy.

In the event that the patient does not choose to enroll in the program of the present invention, the patient may still purchase the fertility pharmacy discount card. The pharmacy discount benefit may be purchased online and the brochure may be given to the patient as a standalone offering. The fertility pharmacy discount card program preferably includes:
Insurance agency producing, marketing and managing all consumer direct, pharmacy and retail store sales for the card. In addition, processing the online payment of the card and forwarding automatic online generation of the critical information needed to the pharmacy for prescription fulfillment.
Patient or doctor whom calls or faxes the prescription to the pharmacy. The patient may also walk-in the prescription to the pharmacy.
A pharmacy in fulfillment on its promised medication discounts and processes the patient's payment for the prescription over the phone or in the pharmacy. The prescription is picked up at the in-store pharmacy or the pharmacy ships the medication direct to the patient. There is a special identification between the particular pharmaceutical drug company and the pharmacy in order to track sales and identify each medication discount.
Third party administration company that coordinates the negotiates medication discount contract agreement with the pharmaceutical drug company and/or the pharmacy directly.
In-store pharmacy or the retail store assuring immediate fulfillment of the gift card by applying the exact same amount the patient spent purchasing the discount card, which may be used towards any in-store purchase.

The present invention includes several options, including, but not limited to:
The IVF center could be contracted with a traditional insurance company and the process and administration of the present invention could take place through that traditional insurer.
The present invention could contract with traditional medical insurers to offer claims administration on IVF procedures, IVF pregnancies, and surrogate pregnancies to the that insurer.
The present invention could contract with traditional medical insurers to offer reinsurance on IVF procedures, IVF pregnancies, and surrogate pregnancies to that insurer.
The retail store may offer the discount pharmacy card as any other product and have the critical information for fulfillment presented when the medication is purchased at the pharmacy.
The present invention or the discount pharmacy card could offer any negotiated discounts on any medical specialty treatment or services or medication contracted through the third party administration, together with traditional medical insurance in the event the insurance restricts or excludes the certain medical specialty treatment or services or medication.
The present invention or the discount pharmacy card could be offered as a voluntary benefit to any self-insured or self-funded group for a direct purchase by the group or by the groups employee.
The present invention could identify risk through underwriting review and acceptance/denial of a surrogate or IVF pregnancy.
The administrator of the present invention could manage total infertility claims through the third party administration.
The administrator of the present invention could only manage the surrogate pregnancy exposure.
The present invention could be offered as a coverage extension via endorsement to group plans. This would confirm coverage intent, while at the same time controlling exposures via underwriting and claims management.
Group policies may continue to provide coverage, but surrogacy pregnancy and IVF treatment would be “carve-out” via a reinsurance structure.
Coverage for surrogate and IVF pregnancy may specifically be excluded, but a “buy-back” plan may be offered to individual intended parents for their surrogates. Coverage would be written on an individual basis by the administrator of the present invention.
Insurers may choose to continue to remain silent as to surrogacy or IVF pregnancy coverage, but contract with the administrator of the present invention for claims management.

In a preferred embodiment, the present invention includes the following: a membership card; an explanatory brochure; a male application; a female application; a HIPAA contract allowing the program provider to share patient contact information with the administrator and insurance agency; an Account Summary Billing Statement; a program provider contract; a preferred provider online cycle report administration system; an Egg Donor Recipient (EDR) cycle insurance certificate; an Egg Donor Only (EDO) cycle insurance certificate; Recipient (RO) Only insurance certificate; a Surrogate Maternity Care insurance certificate.

The membership card allows the fulfillment source and the patient to be identified when insurance discount program or prescription is submitted. The peg card allows the suppliers to directly market the present invention to the patient within retail stores and pharmacy in-store locations. The male and female applications allow underwriters to identify any risk that may decline or exclude certain risks in pregnancy. The HIPAA form allows the IVF center to share patient contact information with the insurance agency. The Account Summary Billing Statement allows the insurance agency to know what and how much to invoice the patient for the chosen ARI Program Plan and gives the third party administrator the correct dollar amount to begin monthly payments to the IVF center. The program provider contract is what binds the IVF center and insurance agency. The online administration system allows monthly reports of how and where the patient is in cycling and it allows the insurance agency to auto-issue insurance certificates. The third party administration system allows the claim payments on the insurance and the auto generating of monthly payments to the IVF center. The brochure allows the insurance agency and the IVF center to present the Plan options and the way to market all parties on one platform.

The method of the present invention preferably includes the following steps: signing the program provider contract; marketing of the benefits of the present invention (preferably through a brochure and/or other media platforms); contacting the administrator, insurance agency, and/or program provider by the patient; completing by the patient the HIPAA form; completing at least the female application and alternatively completing the male application; submitting the one or more applications to the insurance agency; approving the patient who filled out the female application by the insurance agency and medical doctor; purchasing medical treatment and complication insurance on the medical treatment; enrolling the patient and/or intended parents into the program; issuing a membership ID card to the patient and/or intended parents; creating an electronic and paper file for the patient and/or intended parents; creating an electronic membership enrollment profile; paying the program provider by the administrator every month; submitting by the program provider an online report to the administrator, wherein all IVF cycles are reported for all ARI patients within each program provider once a month; generating by the online administration system an insurance certificate for each newly reported patient and/or intended parent; issuing the insurance certificate to each new patient and/or intended parents; providing all newly enrolled patients with a gift card to purchase items within a pharmacy or retail store; paying the program provider on a monthly basis until pregnancy is achieved or cycles are exhausted and the program fund is paid in full.

Table 1 below displays a preferred program fund paid by the patient to the administrator for IVF medical treatment and complication insurance. As Table 1 below shows, the specialty medical treatment and complication insurance may be provided for several different specialty medical treatments and at multiple levels and/or pricepoints for each treatment type. For treatment infertility related diseases, Table 1 shows how the treatments and complication insurance may cover: the patient; the patient and the egg donor; the patient and the surrogate; the surrogate and the egg donor; Comprehensive Surrogate IVF and Maternity Insurance; Comprehensive Surrogate & Egg Donor IVF & Maternity Insurance; Comprehensive Patient IVF and Maternity Insurance; and Comprehensive Patient and Egg Donor IVF and Maternity Insurance. The program fund prices listed are preferred prices. Although Table 1 shows specific insurance, treatment plans, and prices, any insurance, treatment plans, and prices may be part of the present invention. Any of these may vary.

TABLE 1

| | PLATINUM | GOLD | SILVER |
|---|---|---|---|
| | Three In Vitro | Two In Vitro | One In Vitro |
| | Fertilization | Fertilization | Fertilization |
| | and all related | and all related | and all related |
| | Frozen Embryo | Frozen Embryo | Frozen Embryo |
| | Transfers | Transfers | Transfers |
| Patient | $23,170 | $20,520 | $14,670 |
| Patient and | $29,170 | $26,320 | $19,420 |
| Egg Donor | | | |
| Patient and | $36,170 | $29,170 | $19,170 |
| Surrogate | | | |
| Surrogate and | $26,470 | $24,770 | $19,295 |
| Egg Donor | | | |
| Comprehensive | $50,750 | $43,750 | $33,750 |
| Surrogate | | | |
| IVF and Maternity | | | |
| Insurance Plan | | | |
| Comprehensive | $41,050 | $39,350 | $33,875 |
| Surrogate & Egg | | | |
| Donor IVF & | | | |
| Maternity | | | |
| Insurance Plan | | | |
| Comprehensive | $37,750 | $35,100 | $29,250 |
| Patient | | | |
| IVF and Maternity | | | |
| Insurance Plan | | | |
| Comprehensive | $43,750 | $40,900 | $34,000 |
| Patient and Egg | | | |
| Donor | | | |
| IVF and Maternity | | | |
| Insurance Plan | | | |

FIG. 1 is an illustration of one embodiment of the HIPAA Form of the present invention. The HIPAA form allows the administrator and the insurance agency to review the patient's medical files.

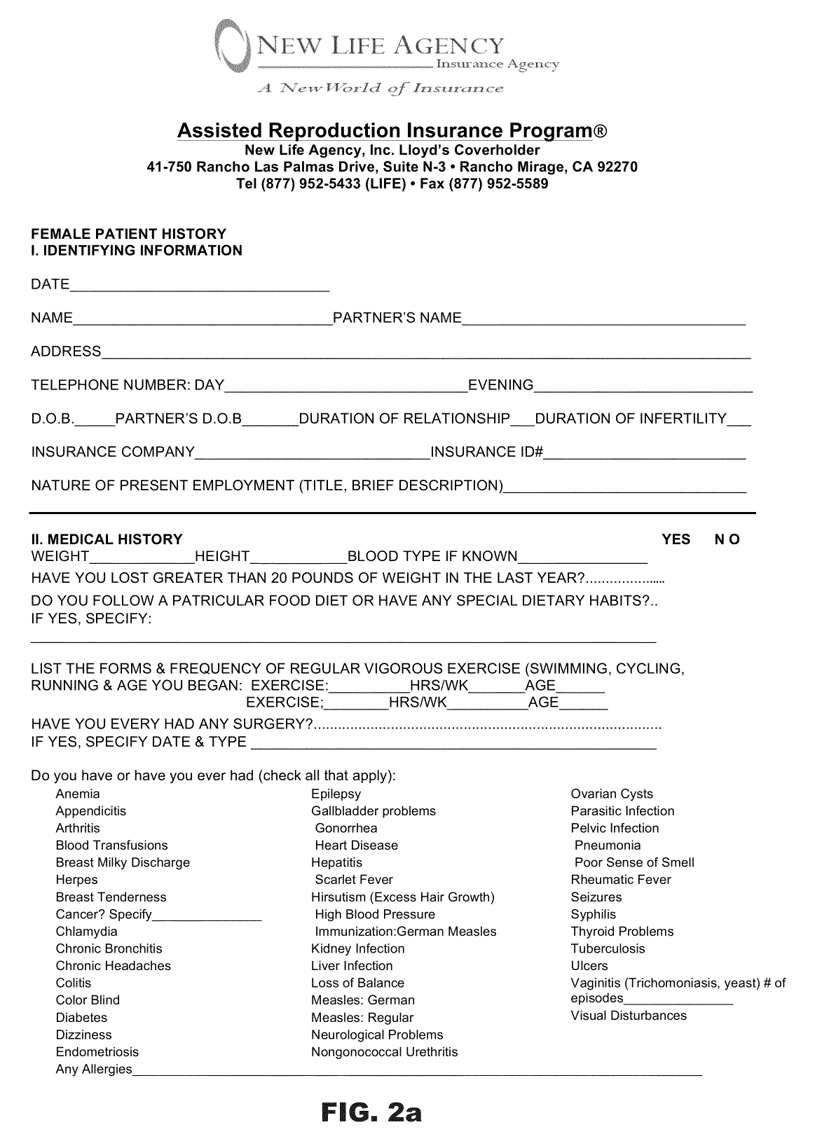

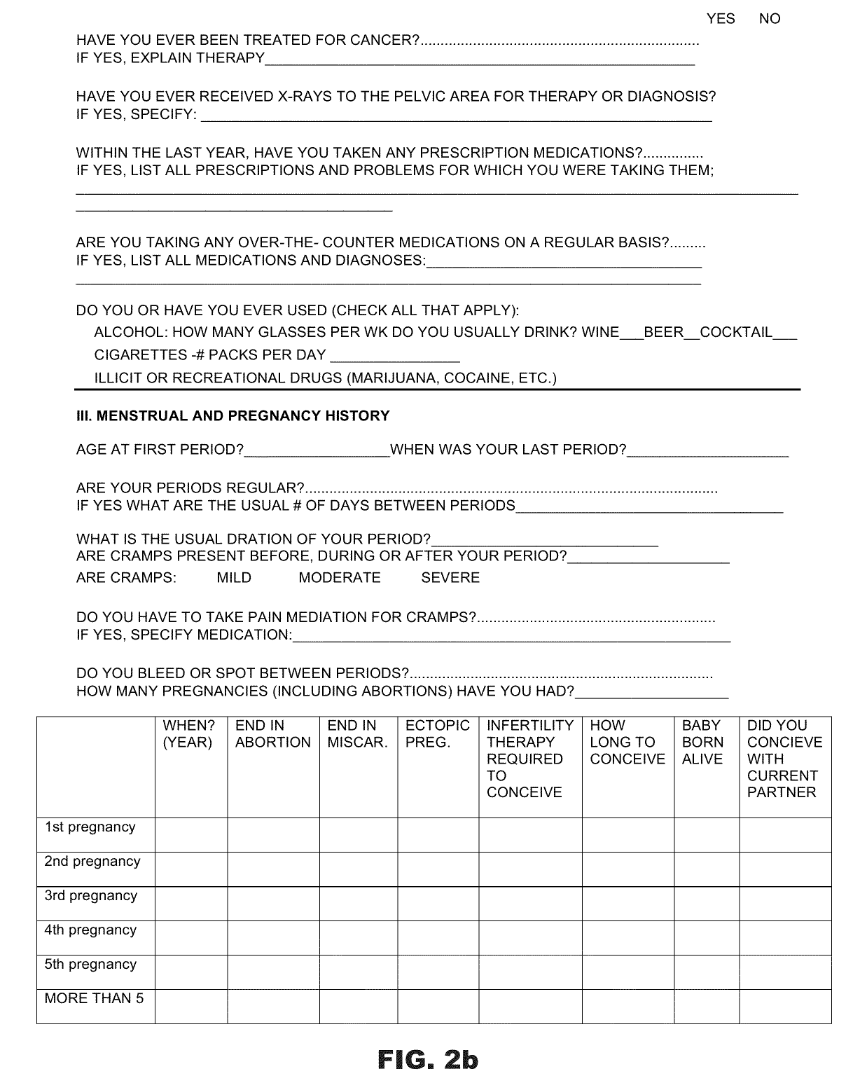

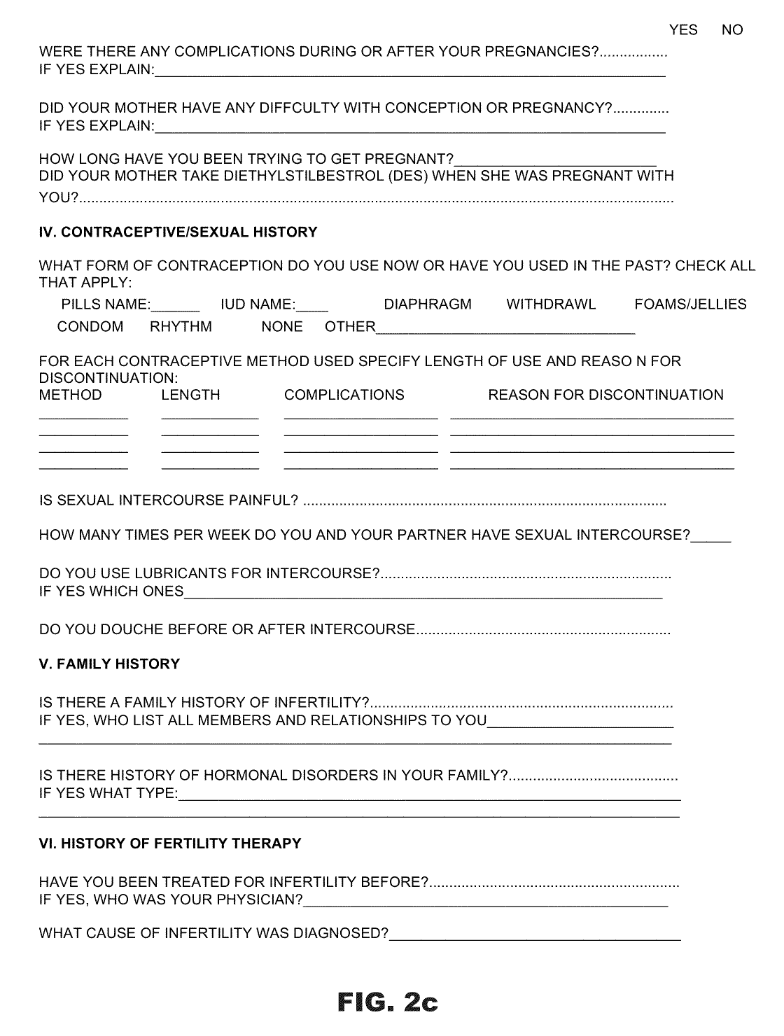

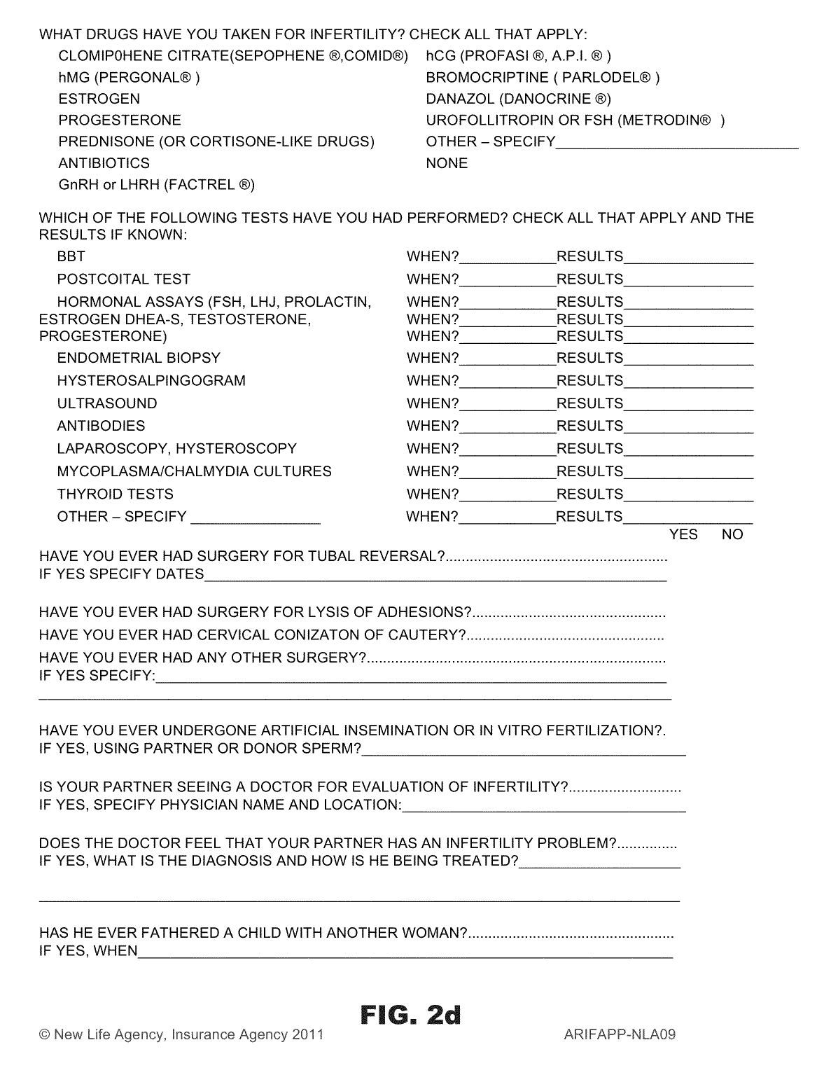

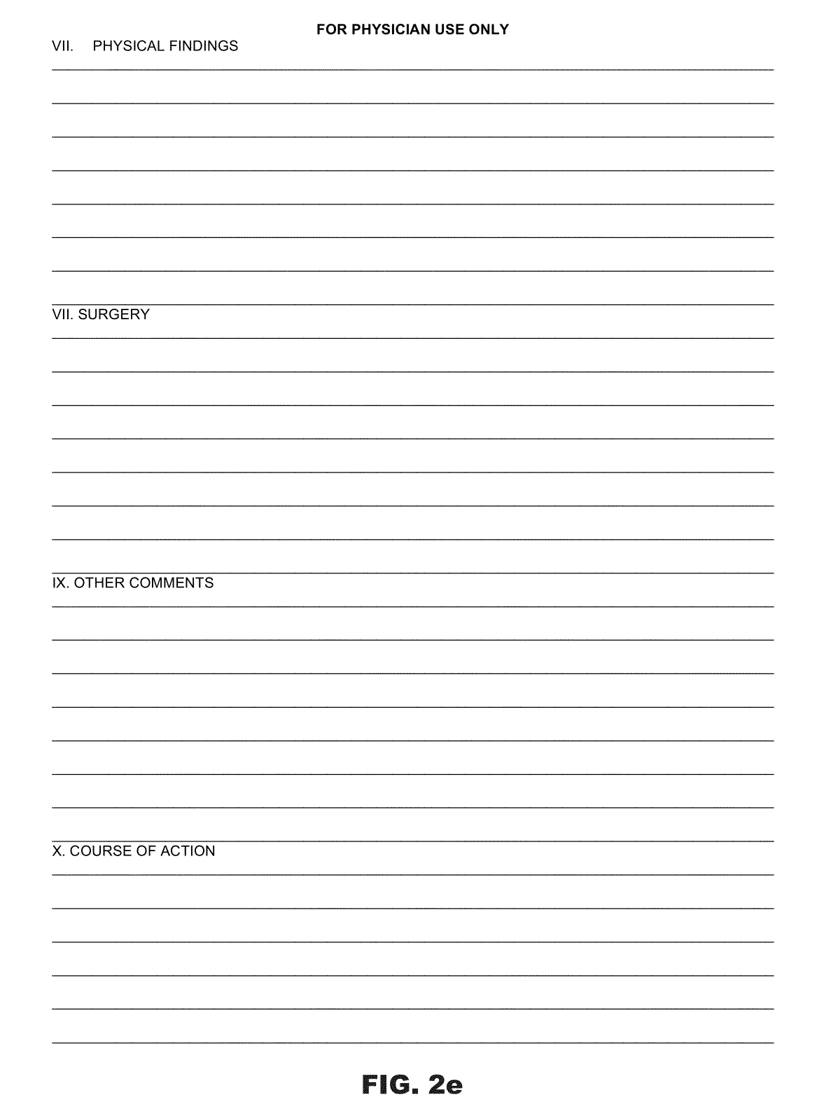

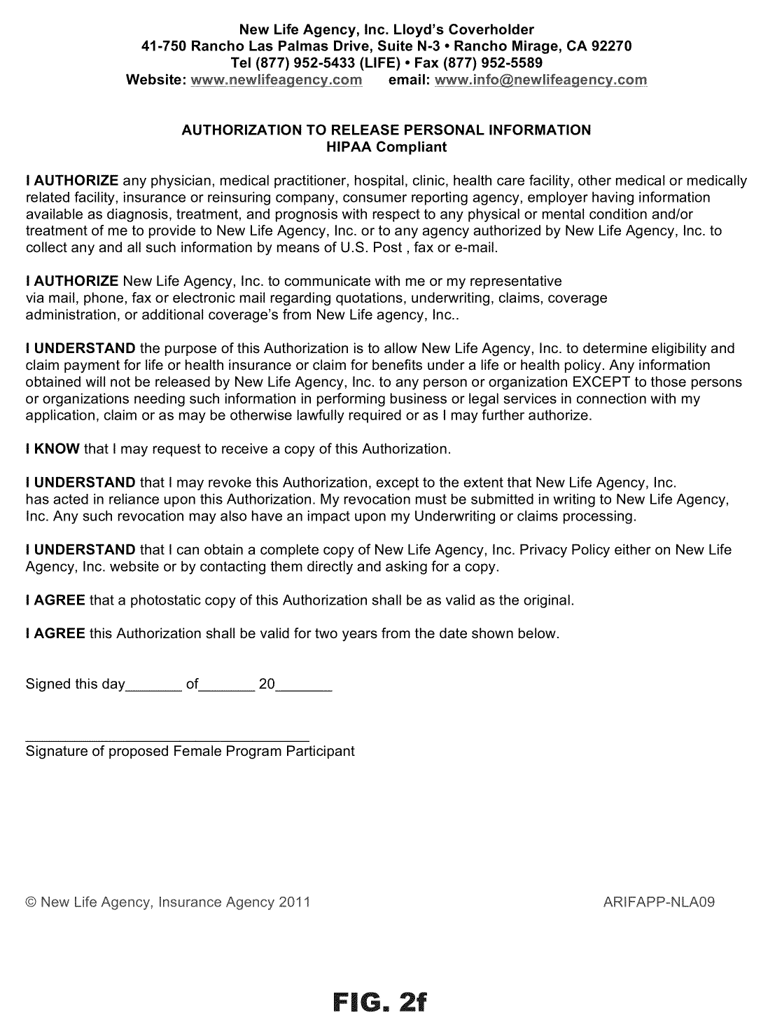

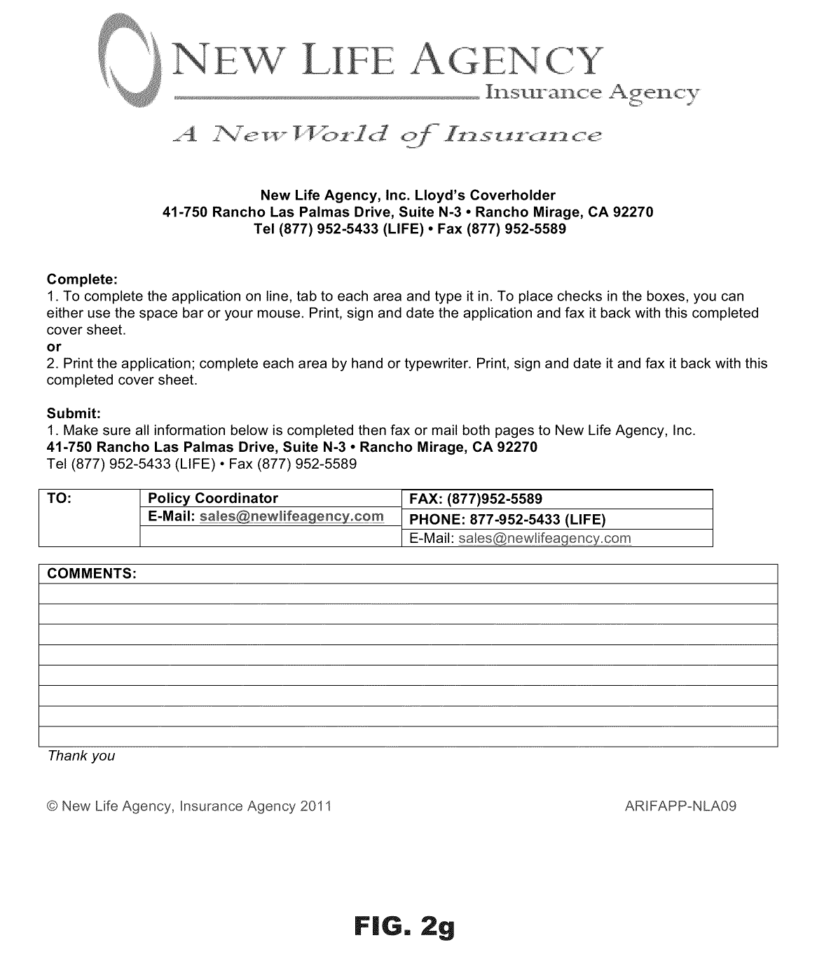

FIGS. 2 a-g are an illustration of one embodiment of the female application of the present invention. The application is completed by the person that hopes to become pregnant. As shown by FIG. 2 the female application collects information regarding the female patient so the insurance agency can determine the risks involved with insuring the patient. The female application also gathers information for the doctors that will examine the patient.

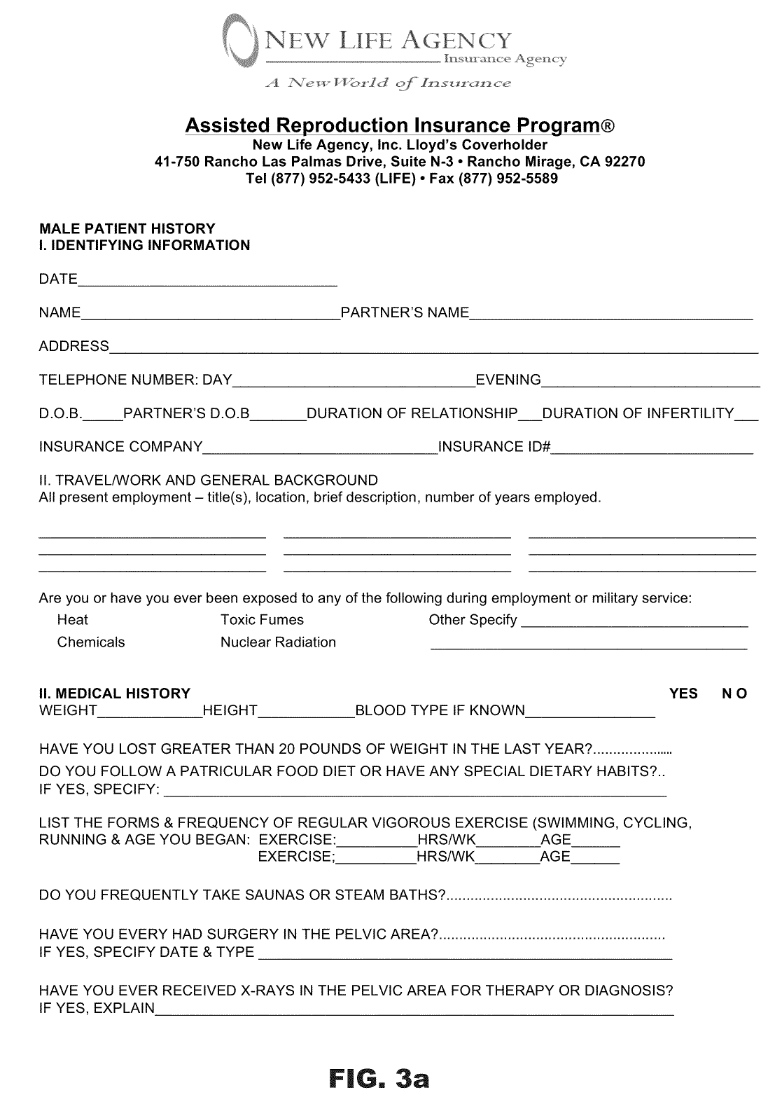

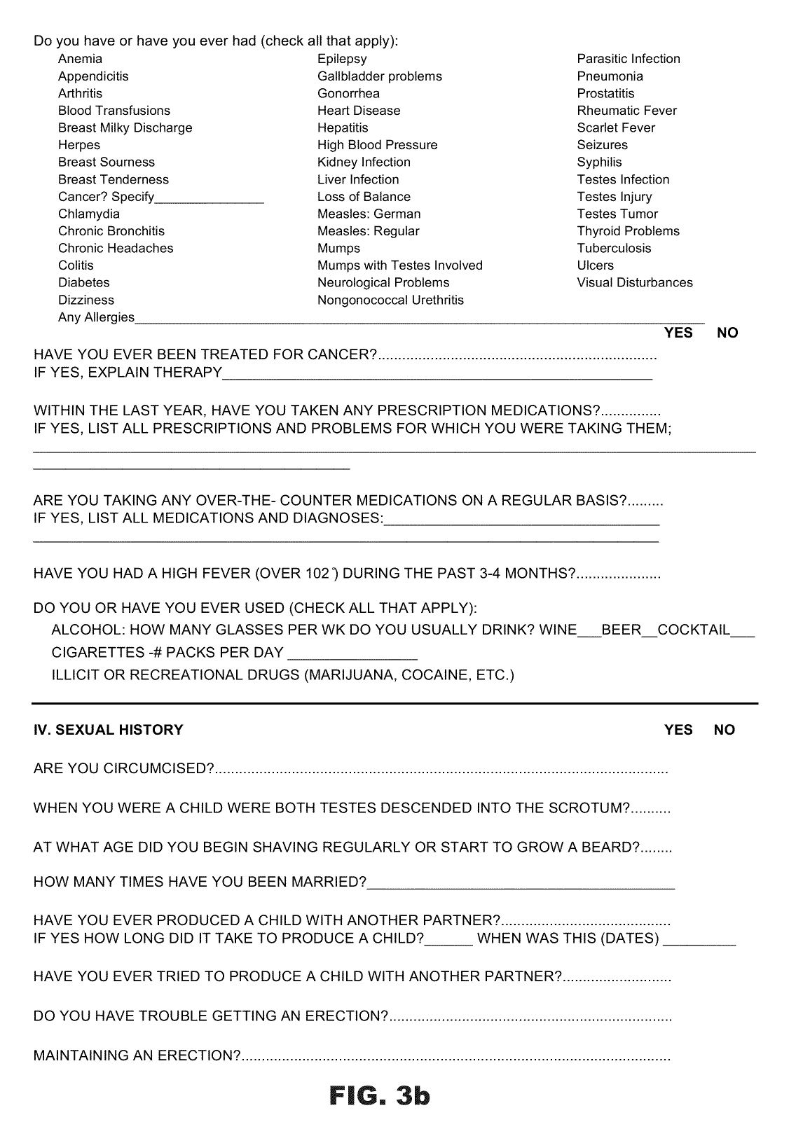

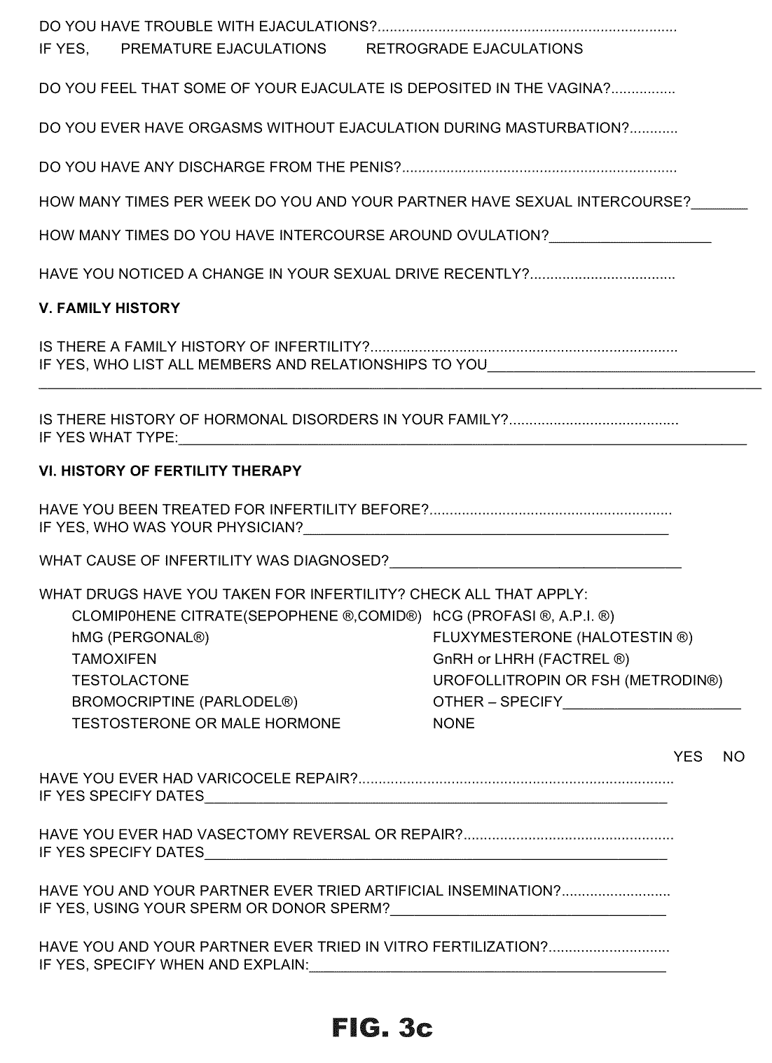

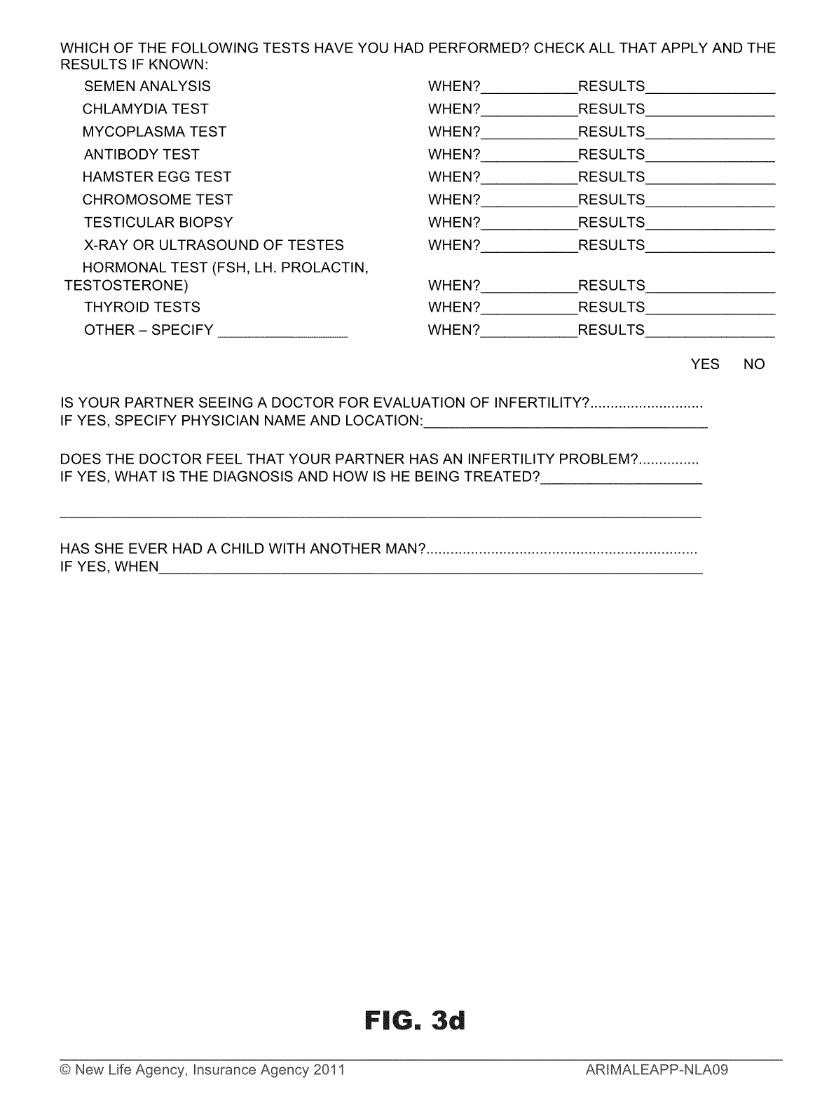

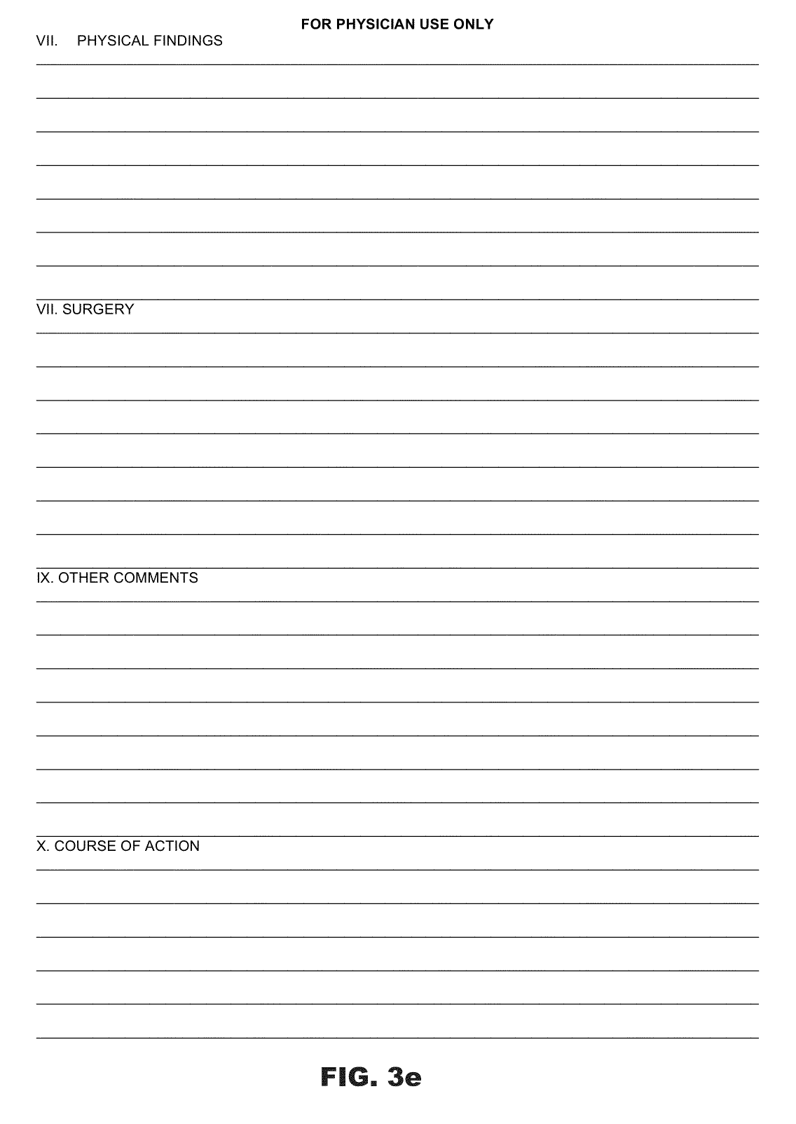

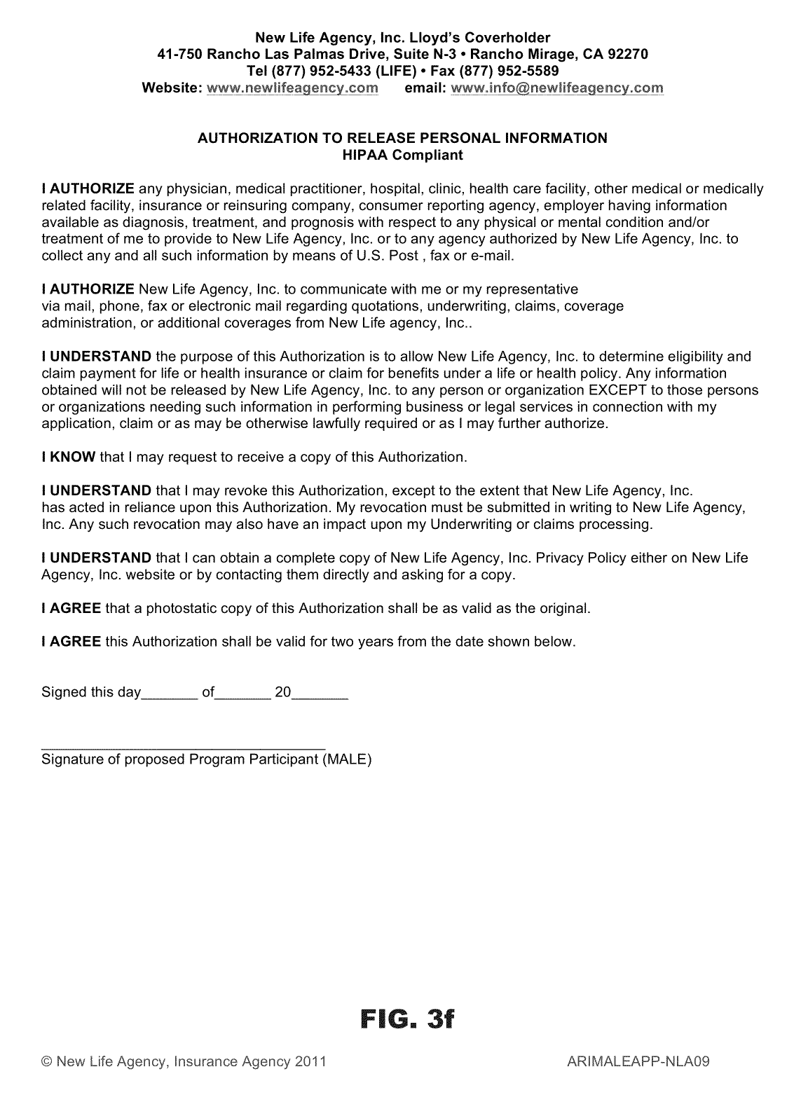

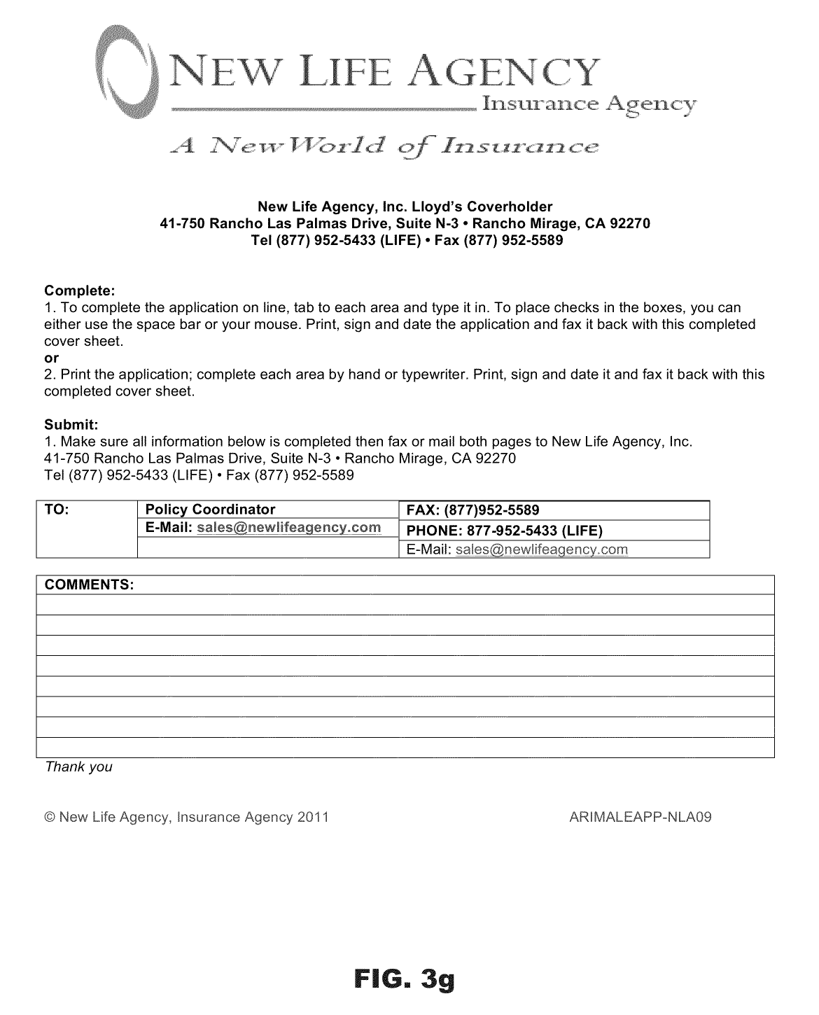

FIGS. 3 a-g are an illustration of one embodiment of the male application of the present invention. The application is completed by the person that hopes to be the father of the pregnancy. As shown by FIGS. 3 a-g the male application collects information regarding the male patient so the insurance agency can determine the risks involved with insuring the patient.

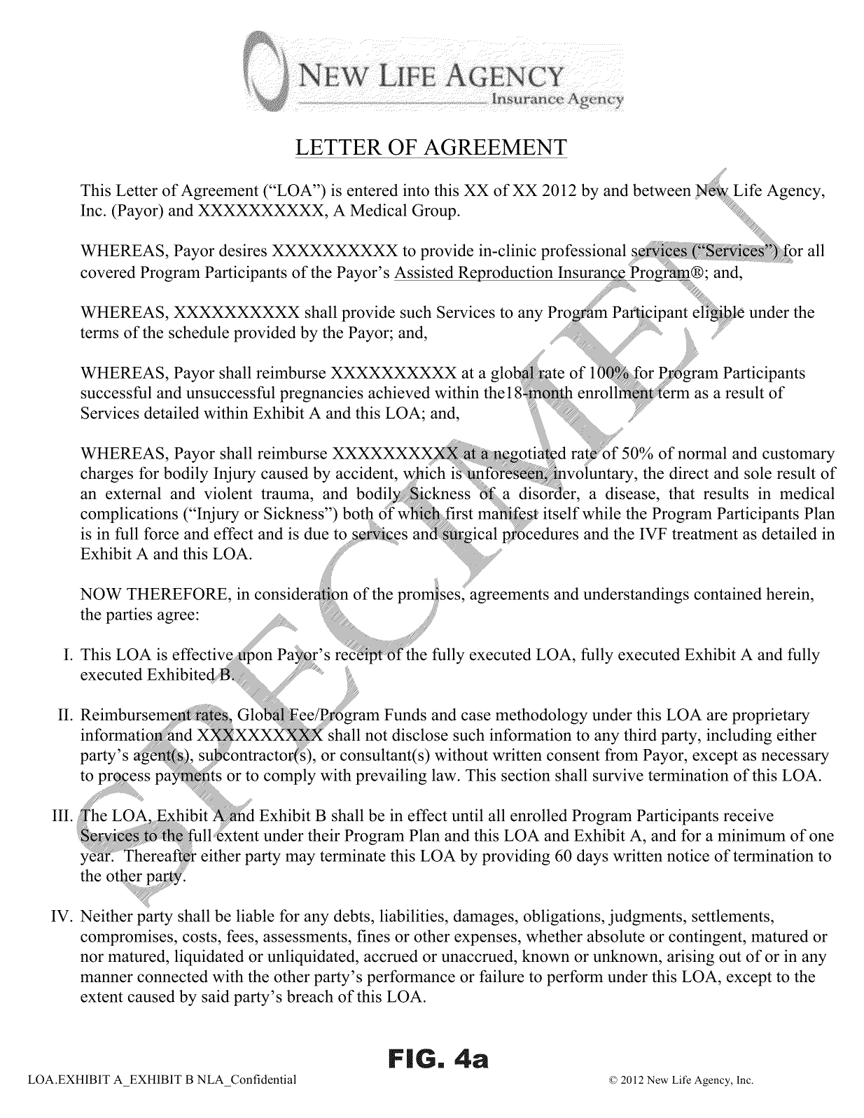

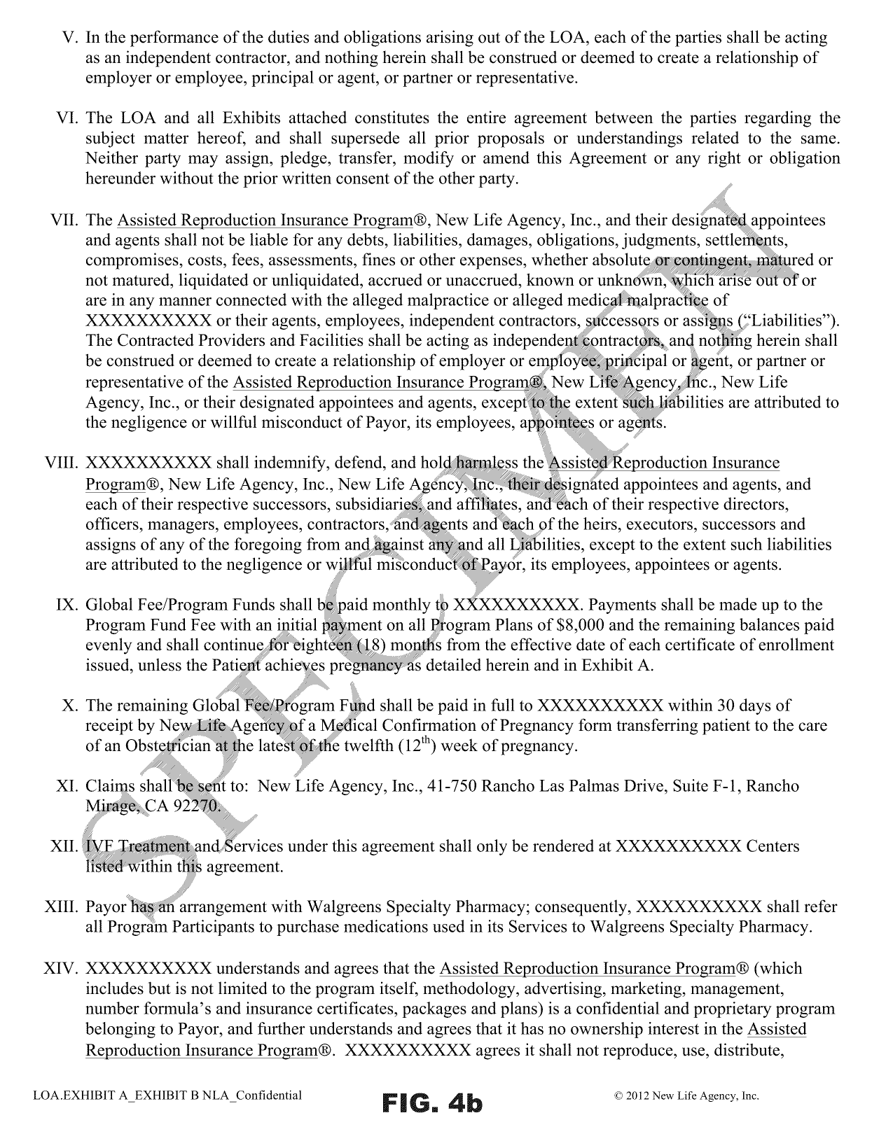

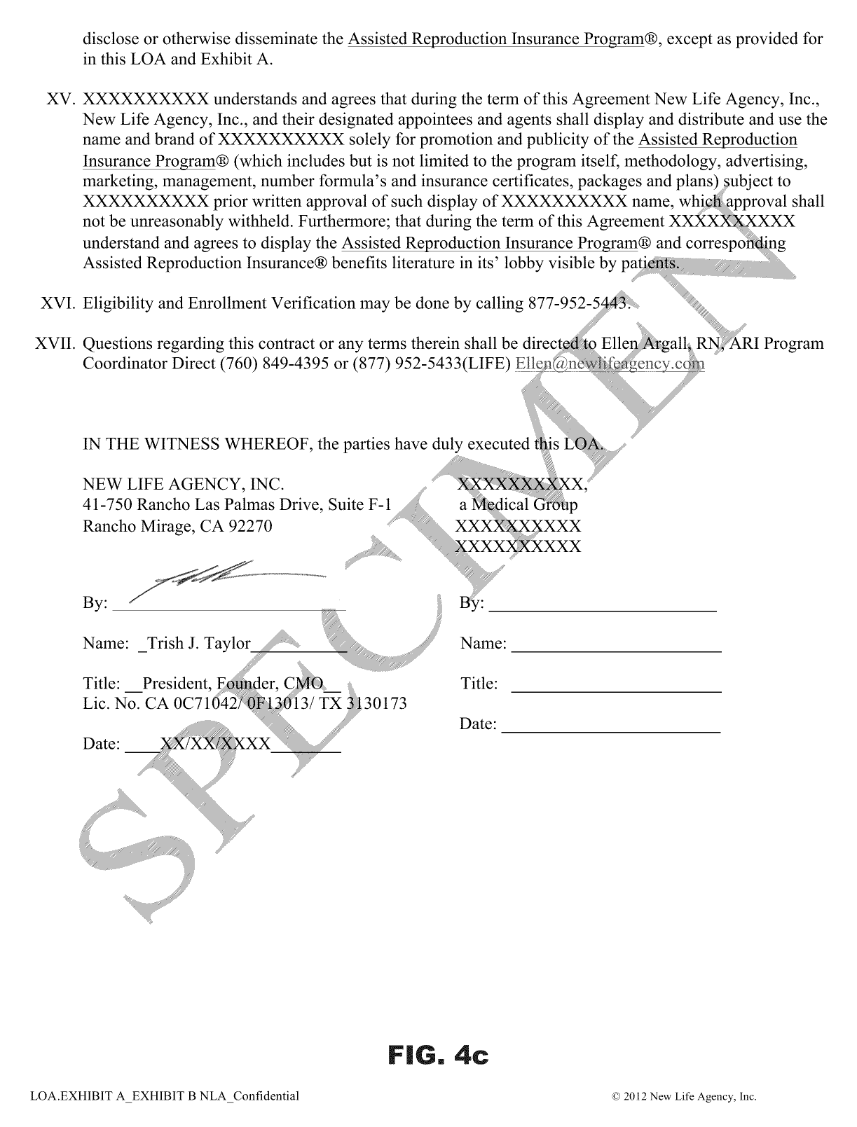

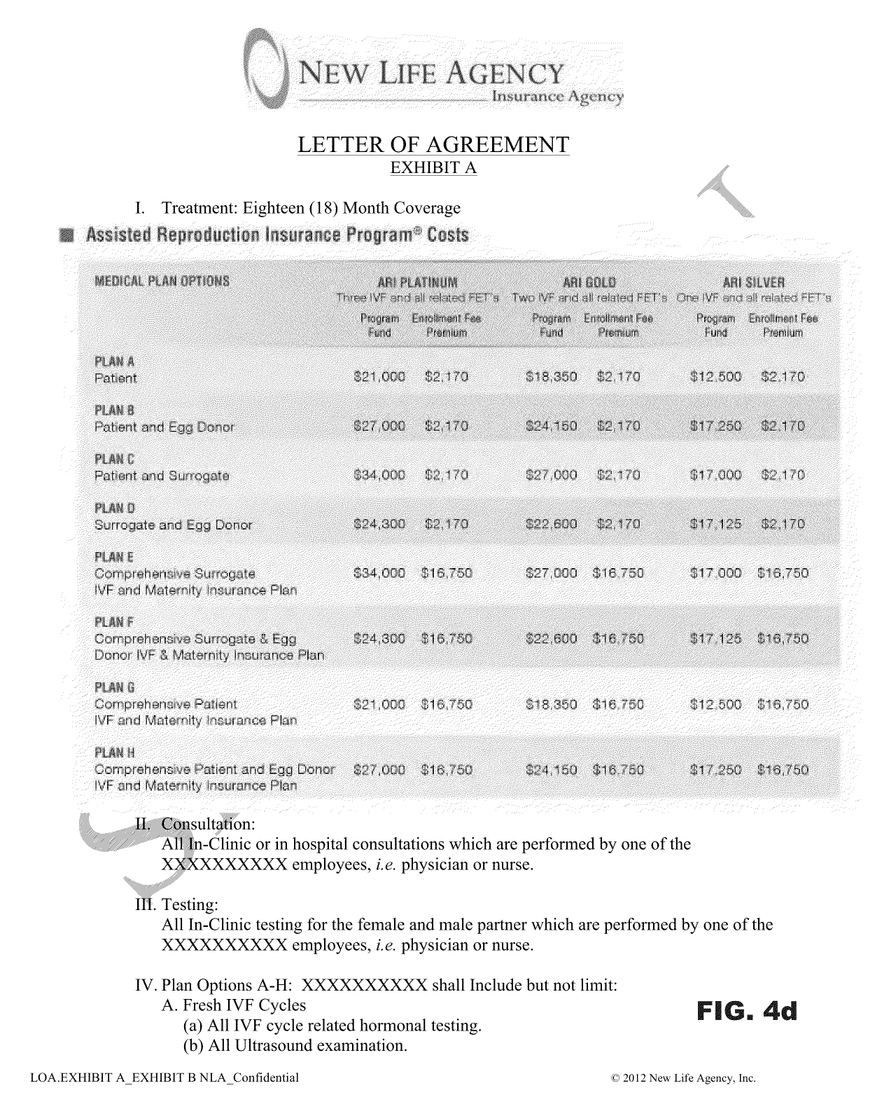

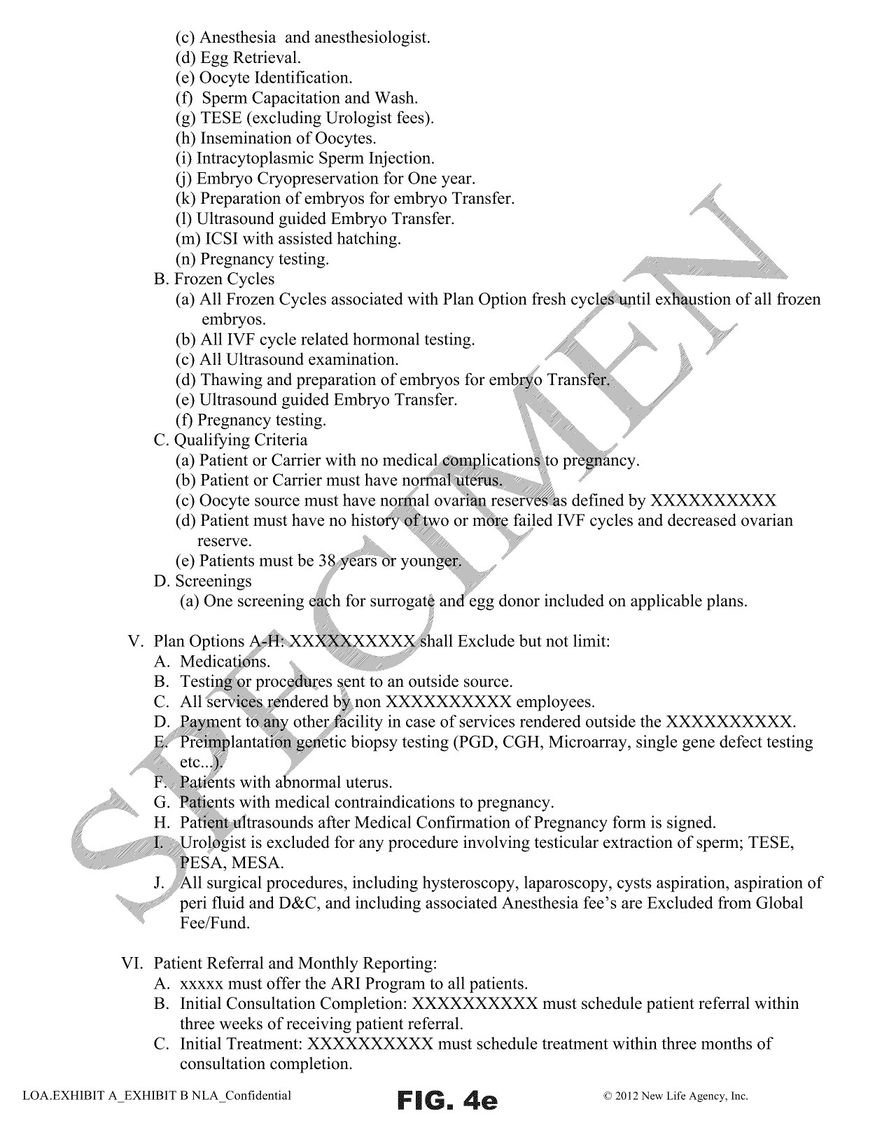

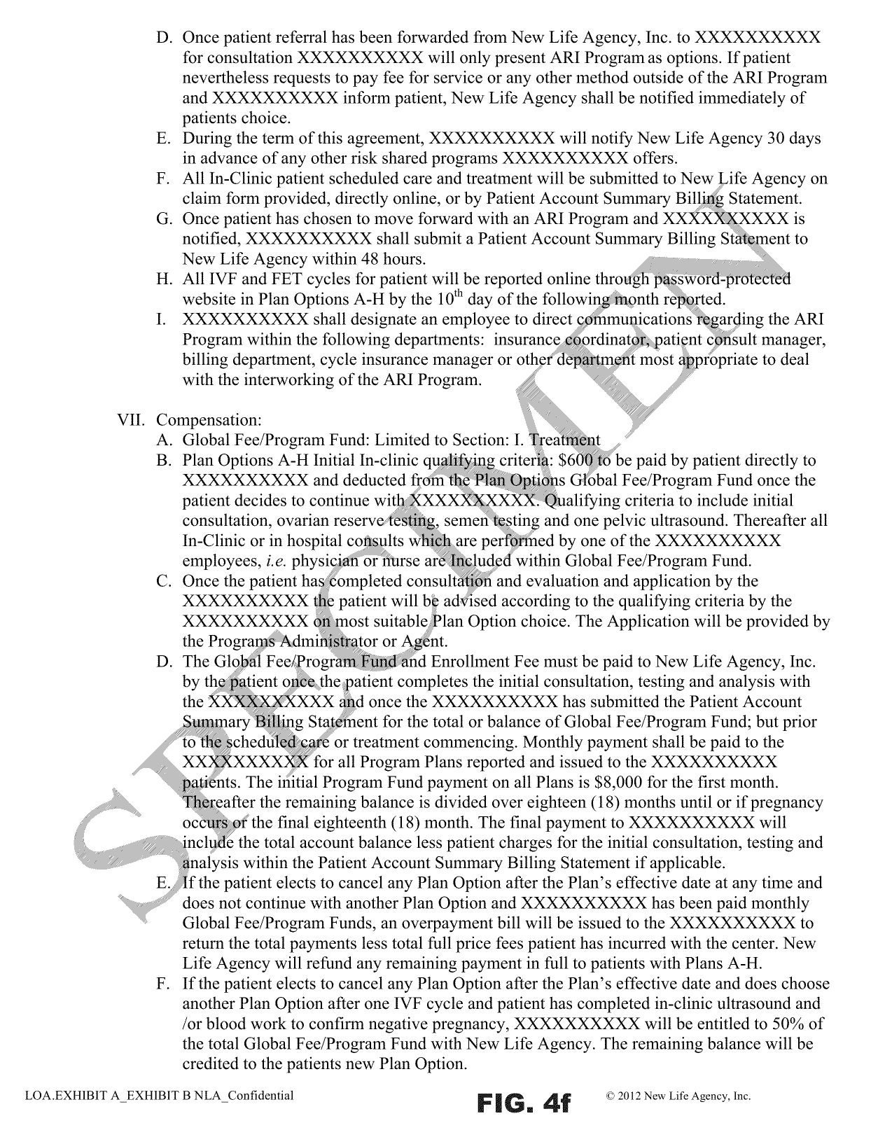

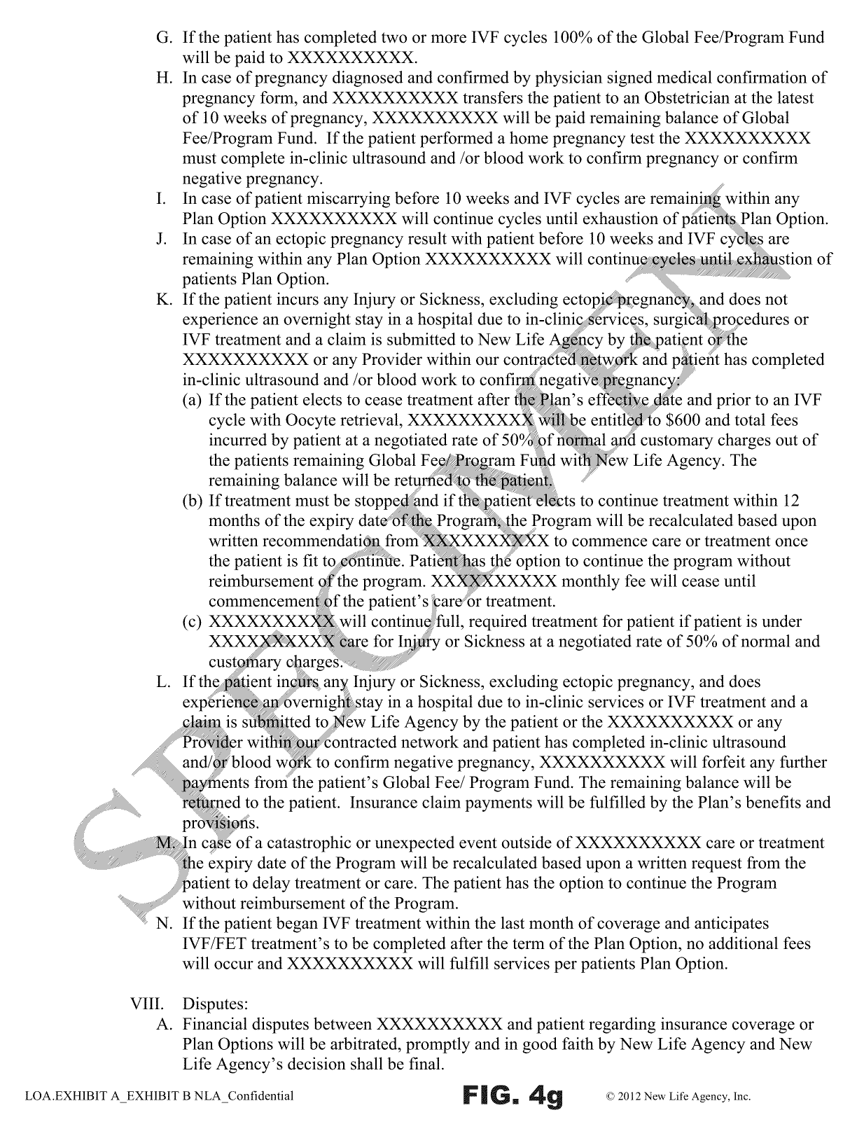

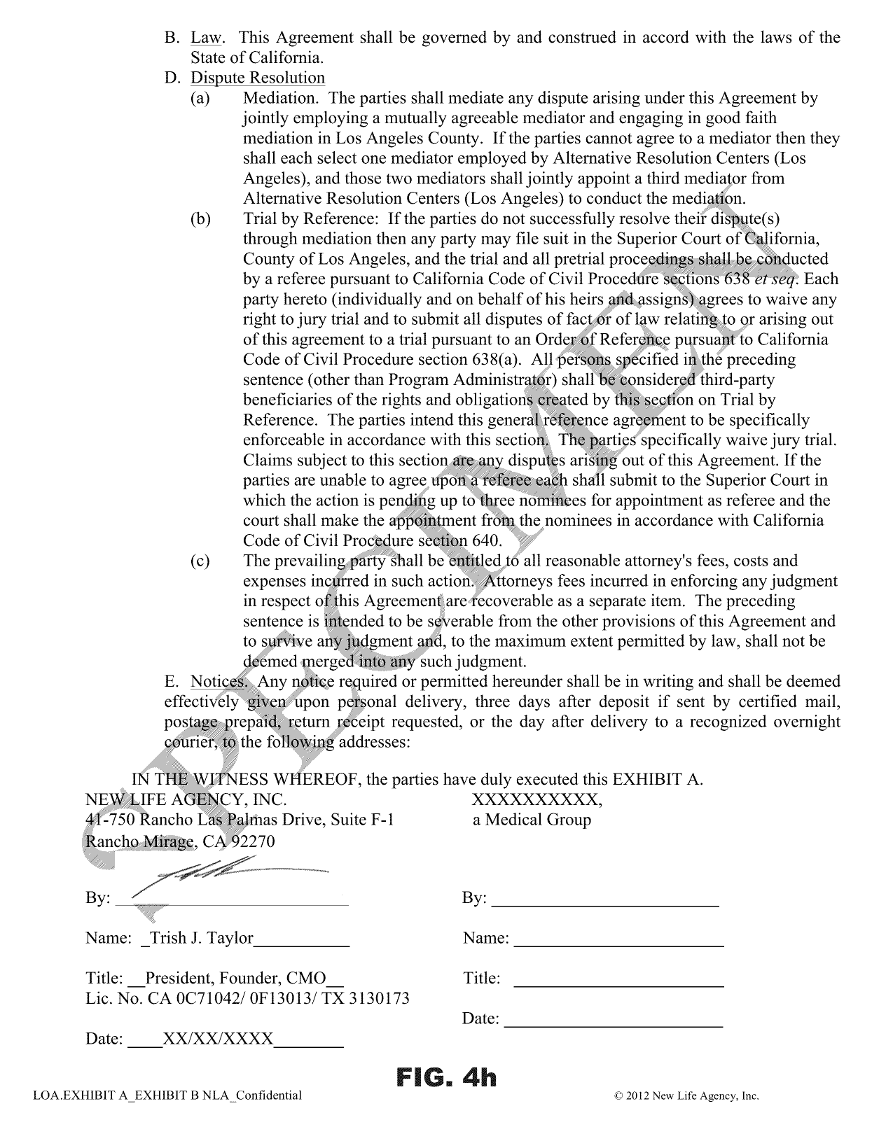

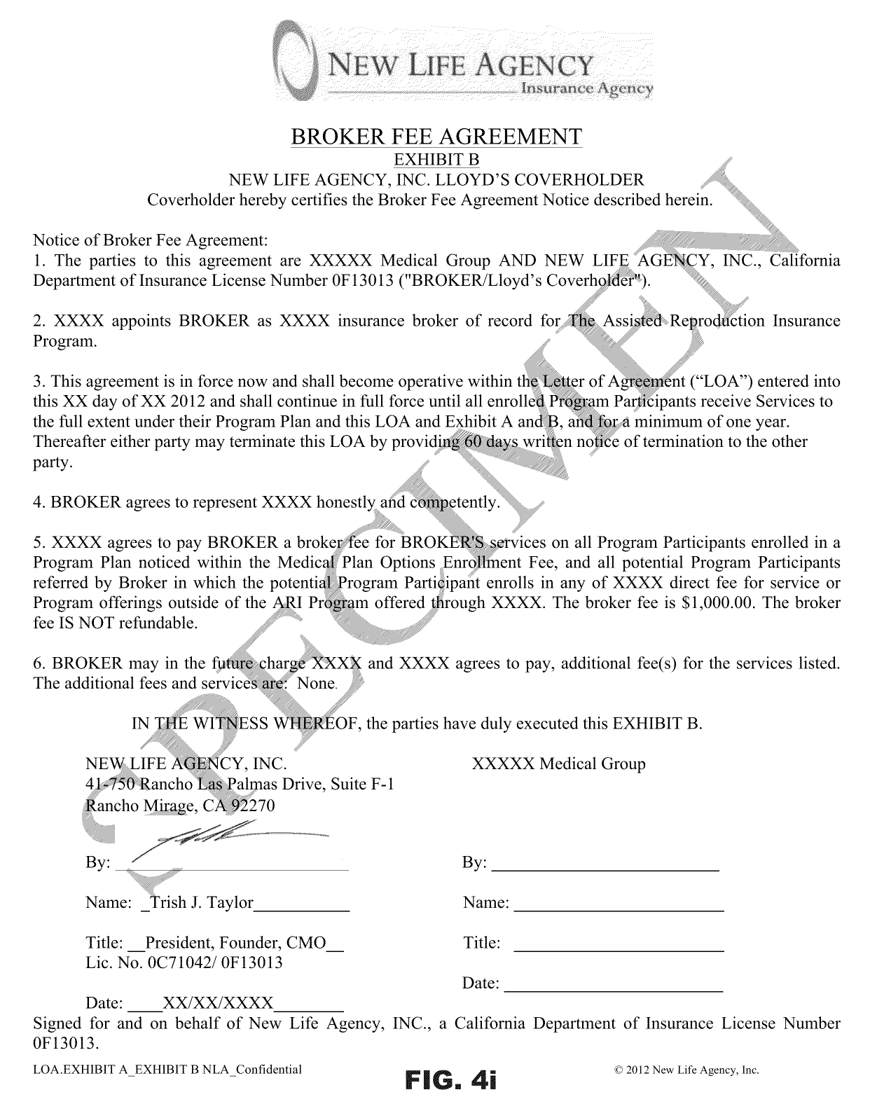

FIGS. 4 a-i are an illustration of one embodiment of a letter of agreement between an insurance agency and a specialty medical treatment provider. FIGS. 4 a-i shows one example of an operating agreement that binds the specialty medical treatment provider and insurance agency to providing the complication insurance and discounted specialty medical treatment to eligible patients.

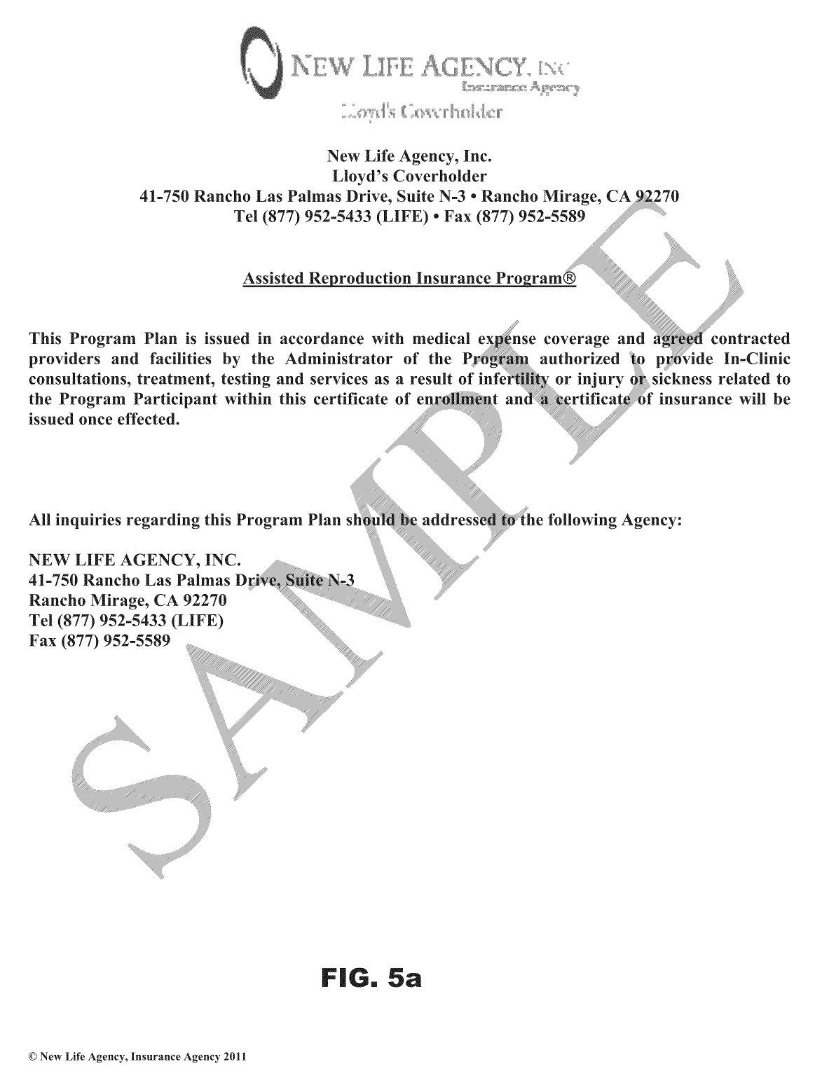

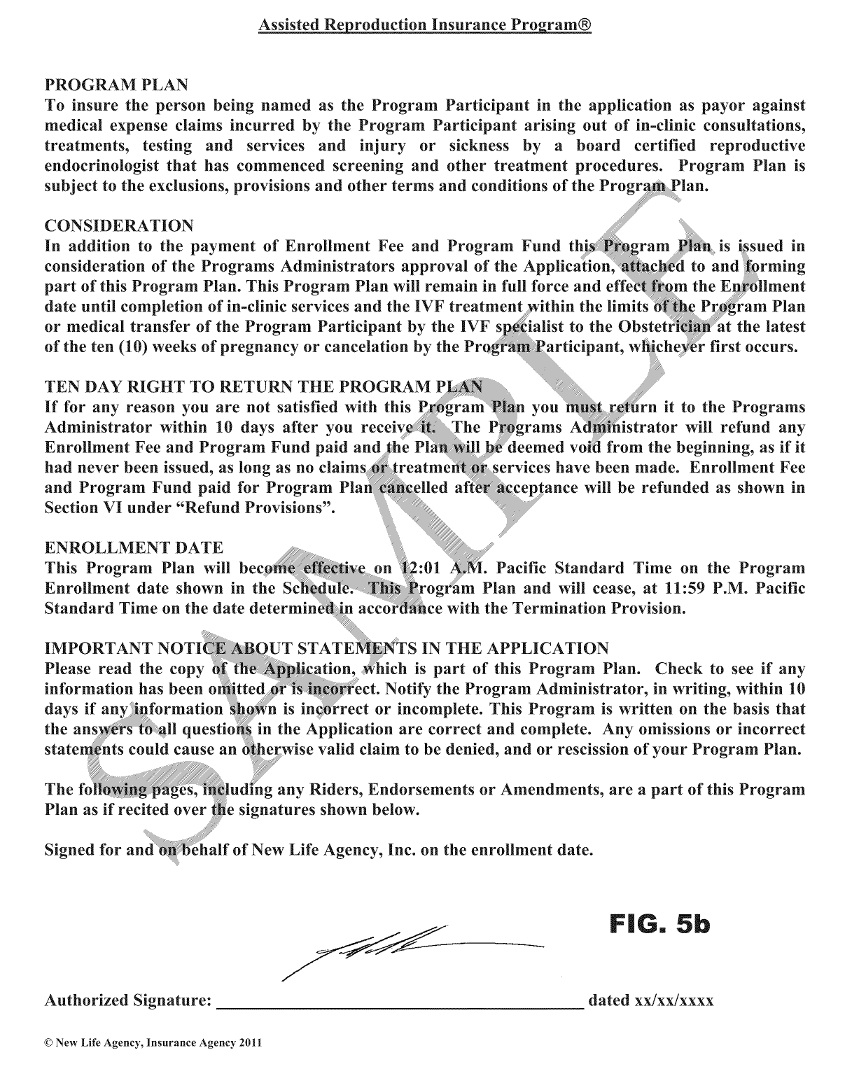

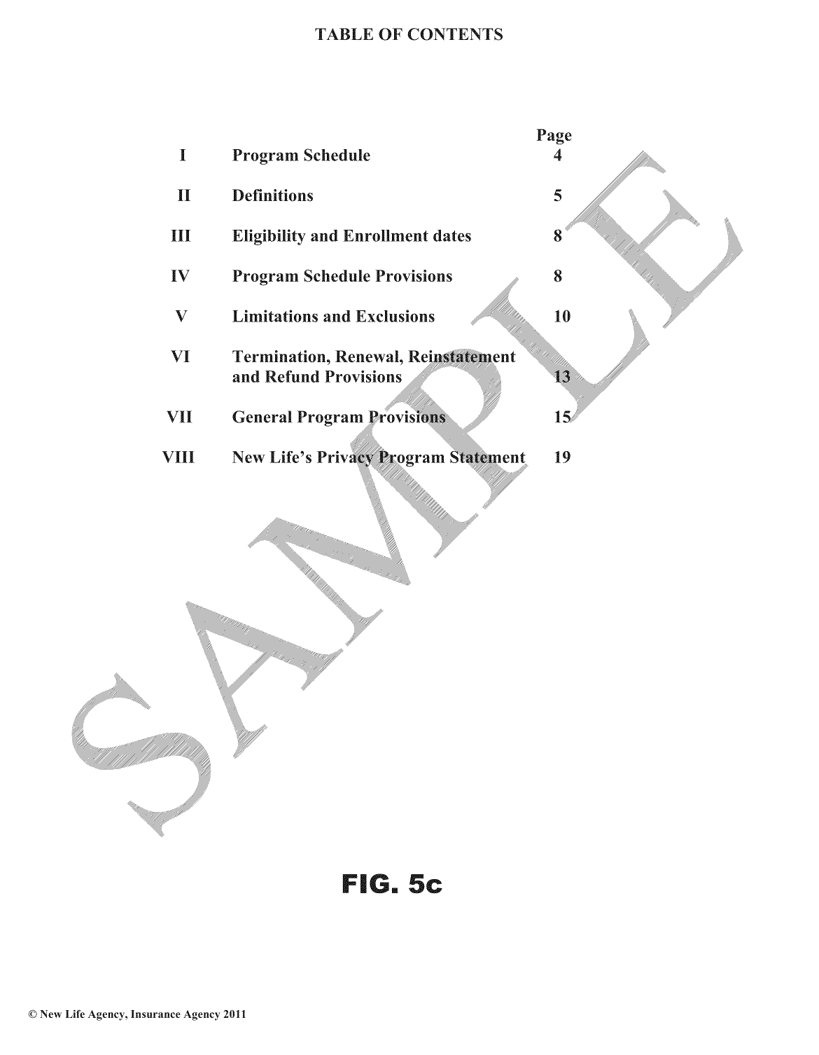

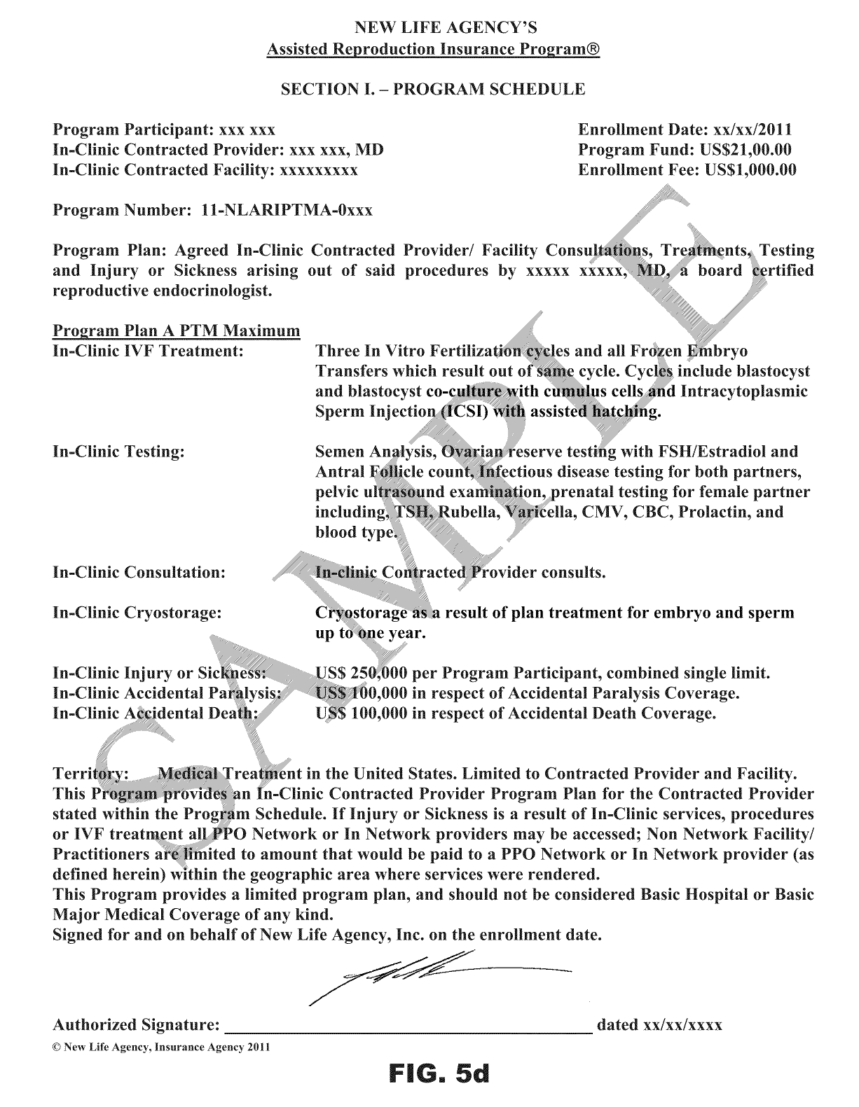

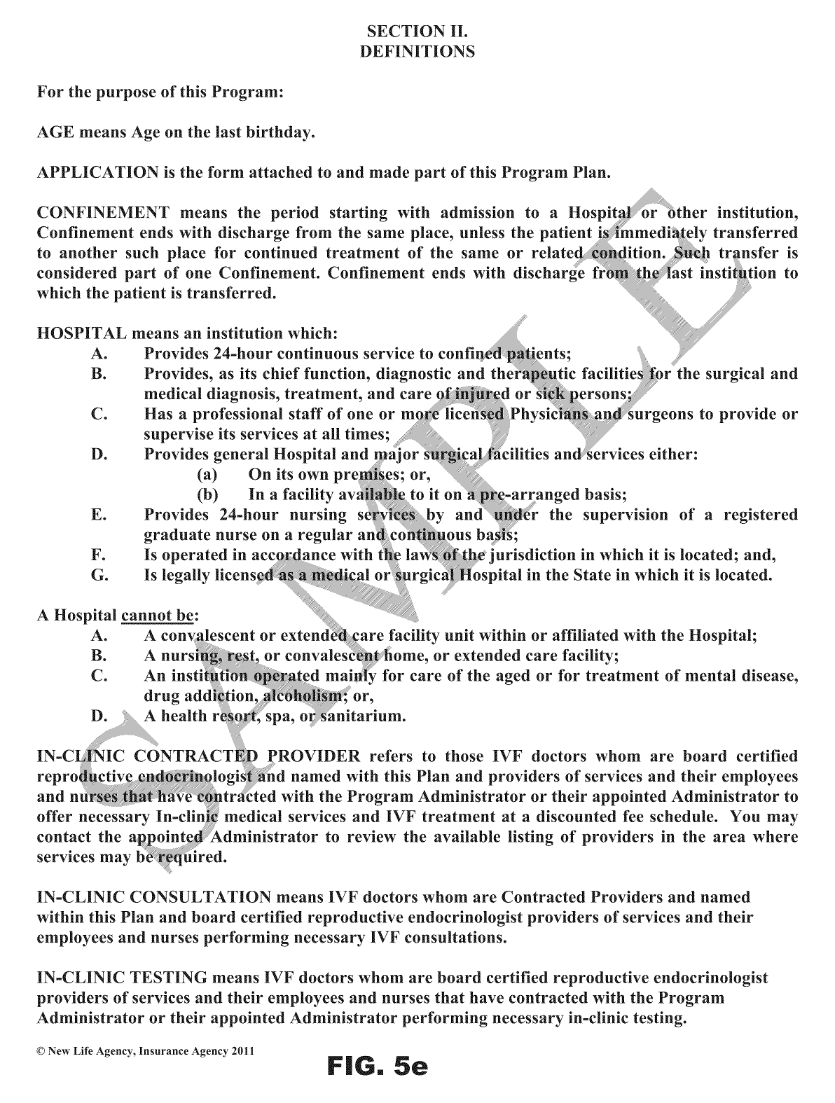

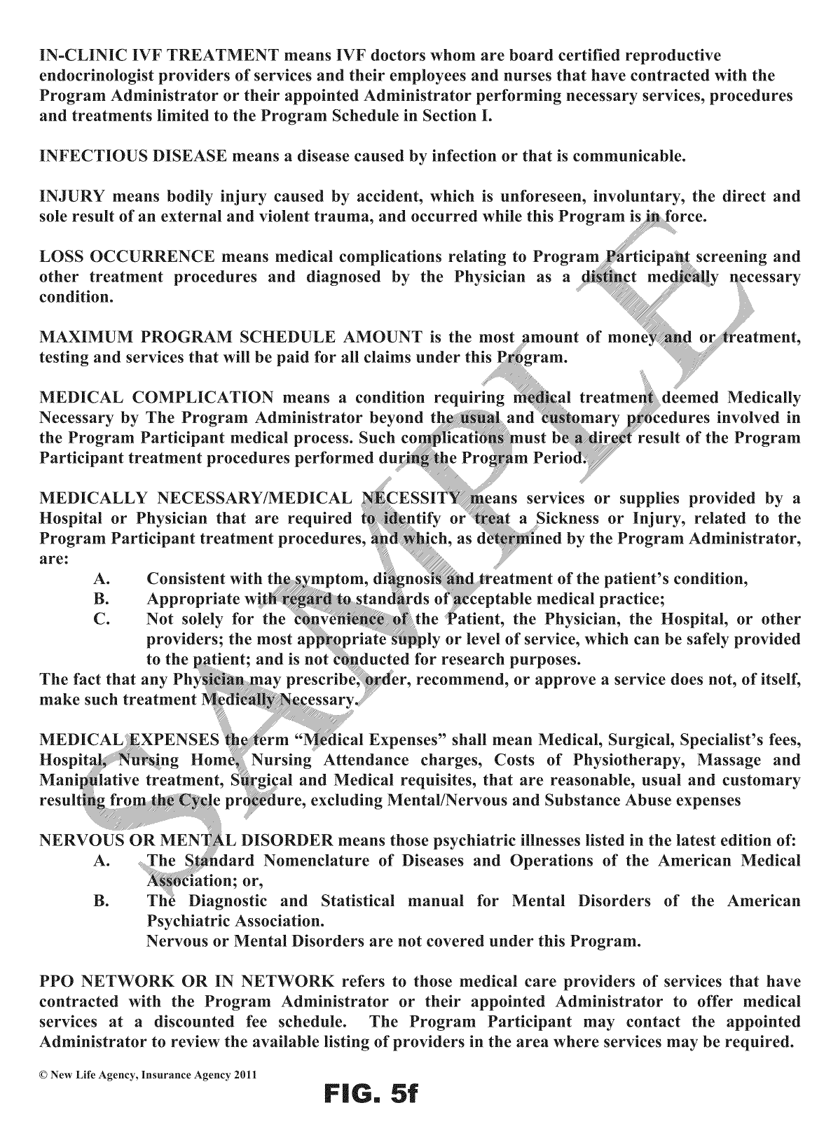

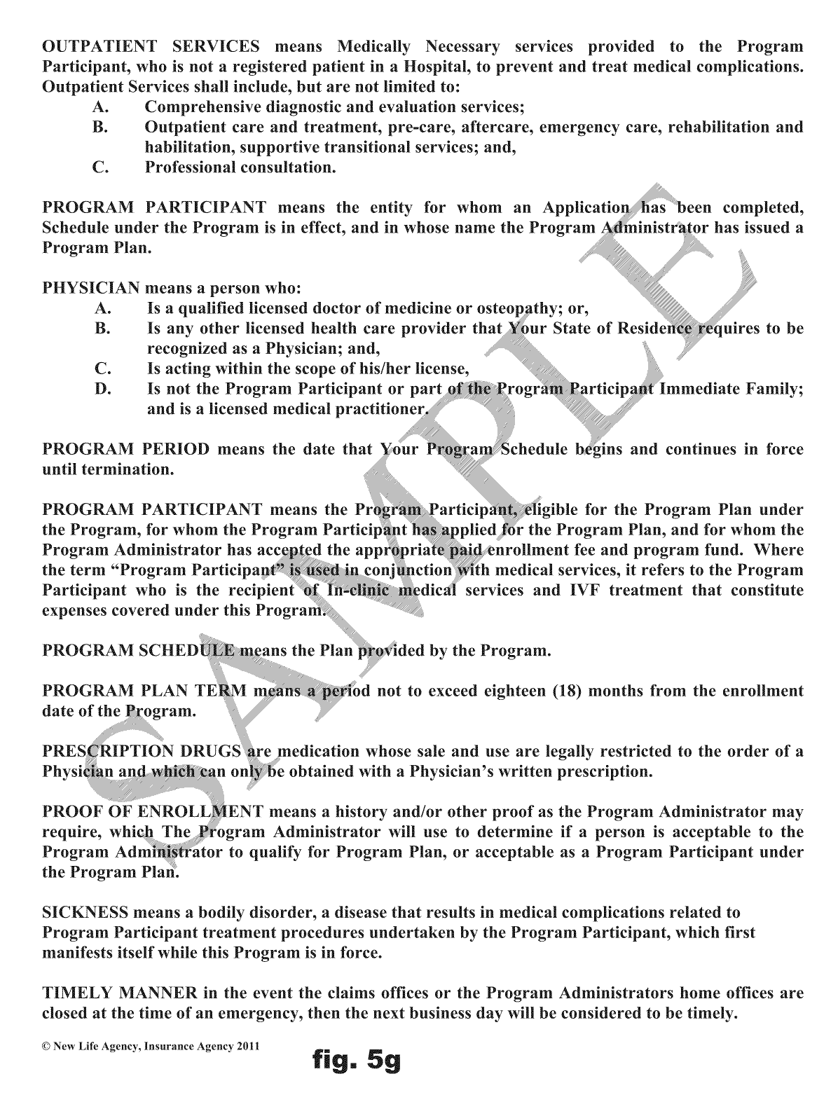

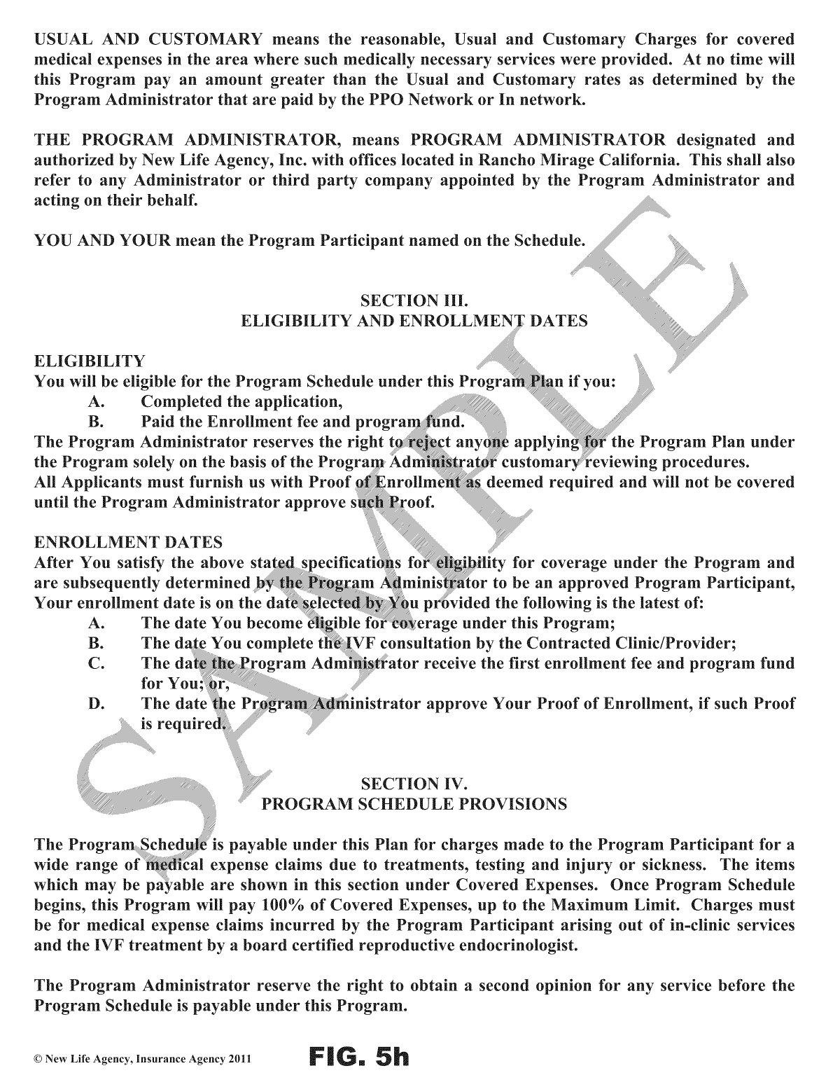

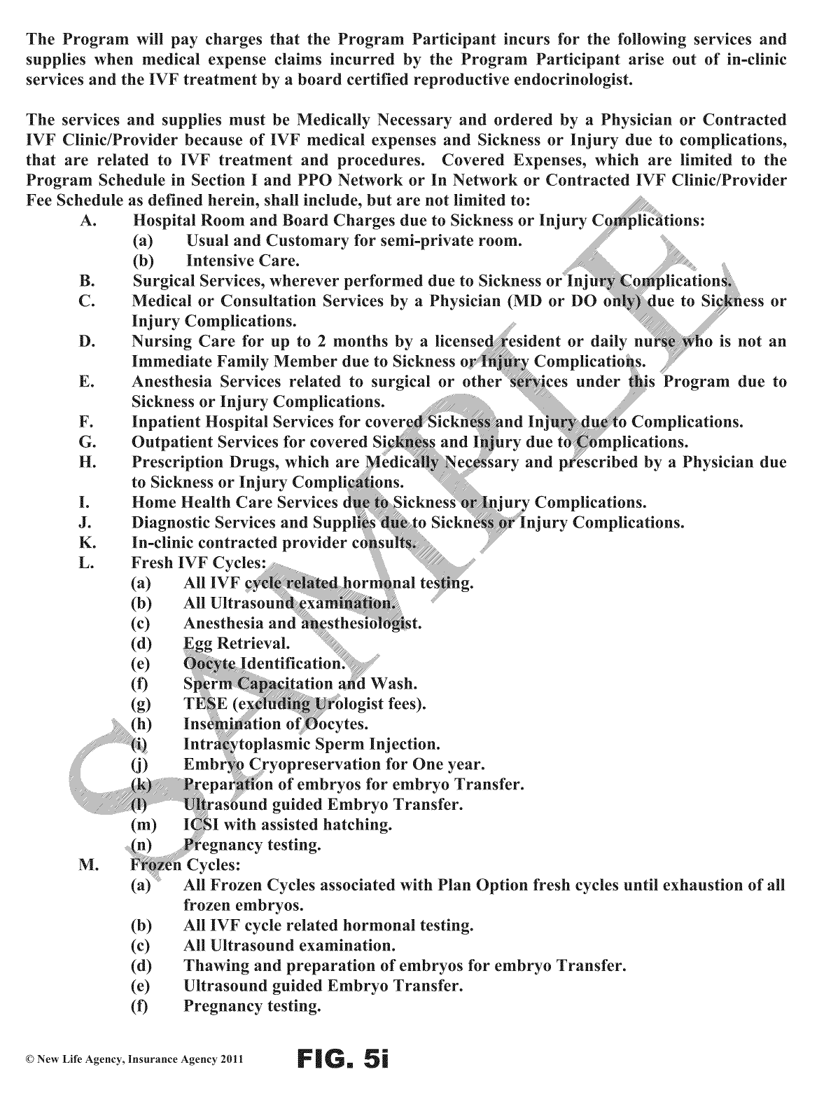

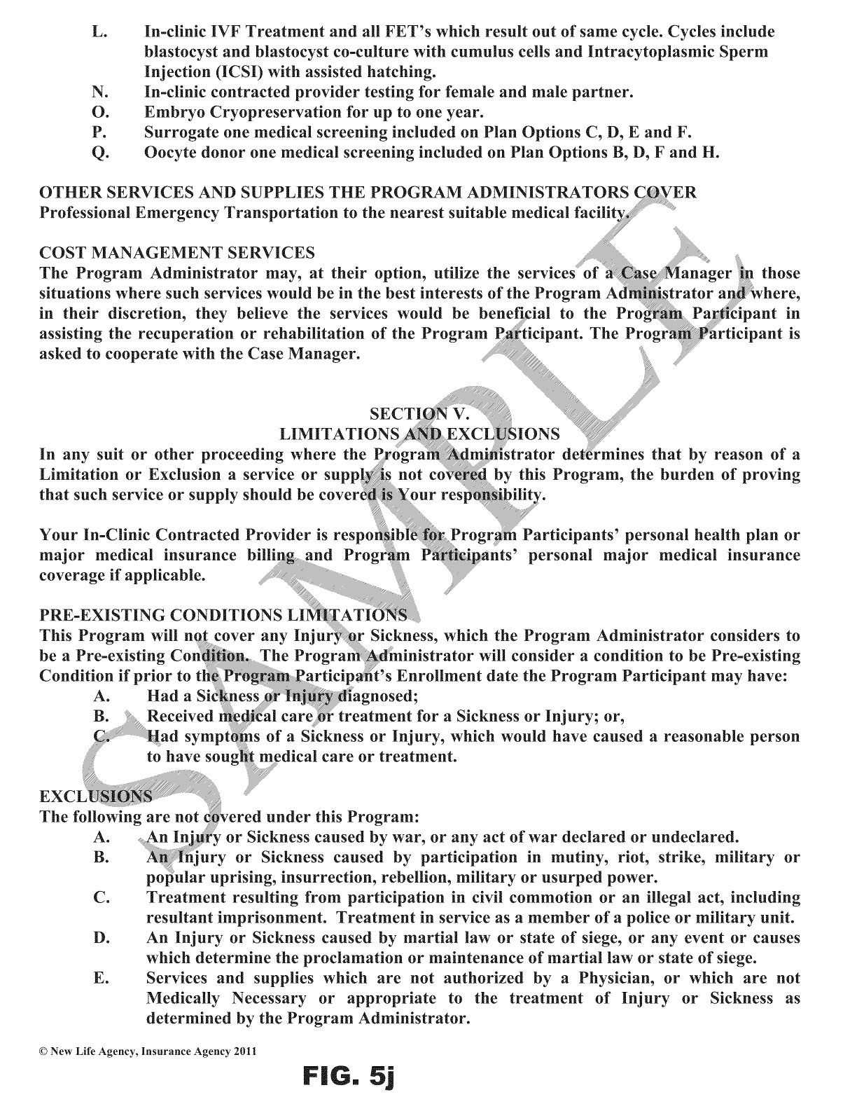

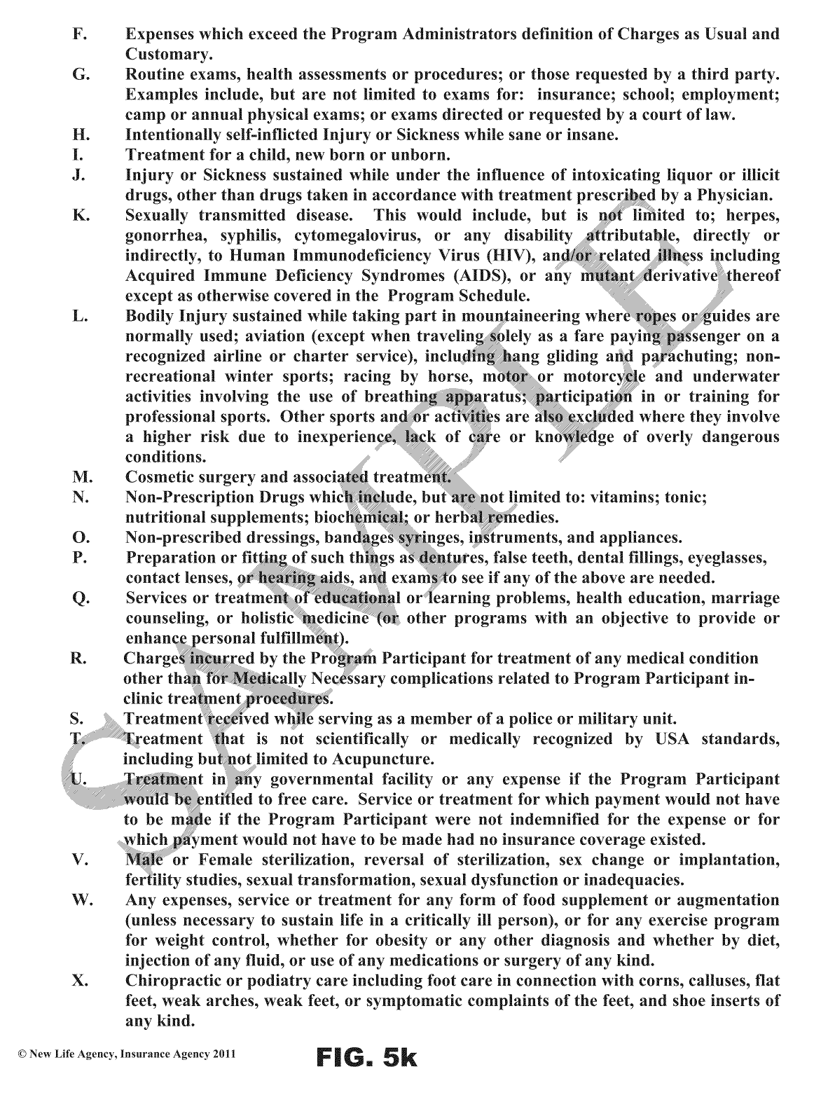

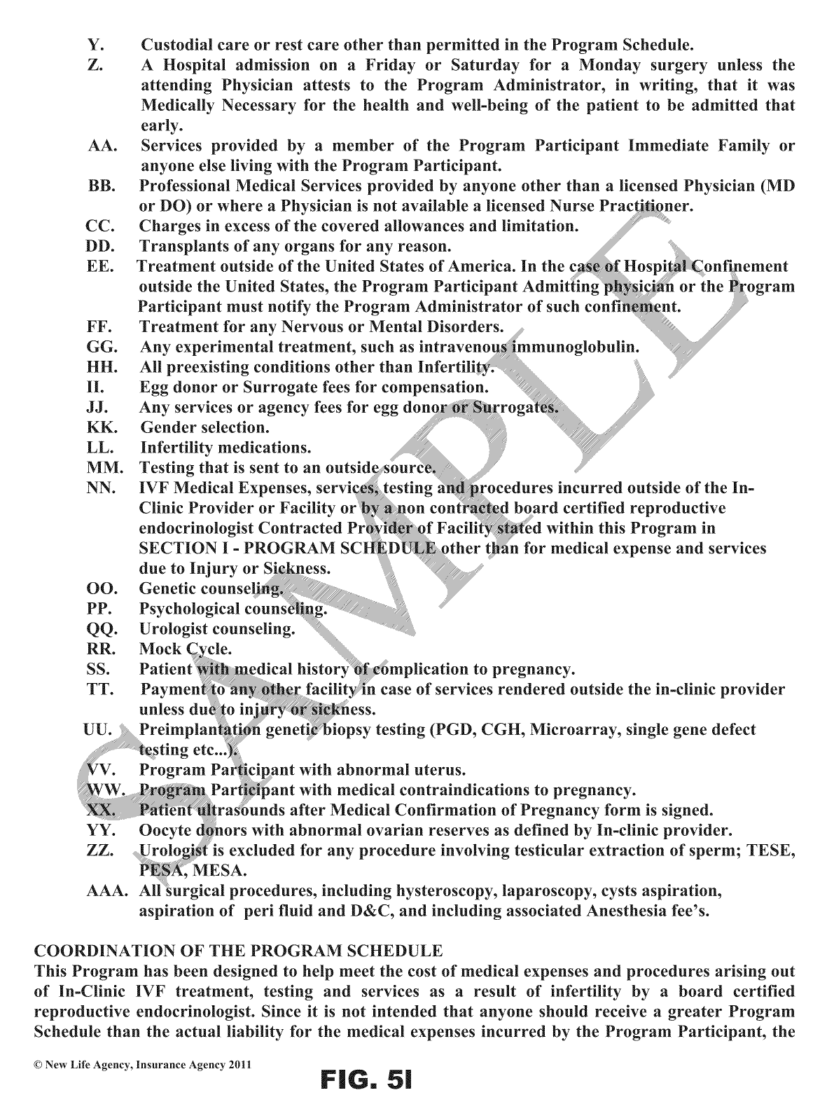

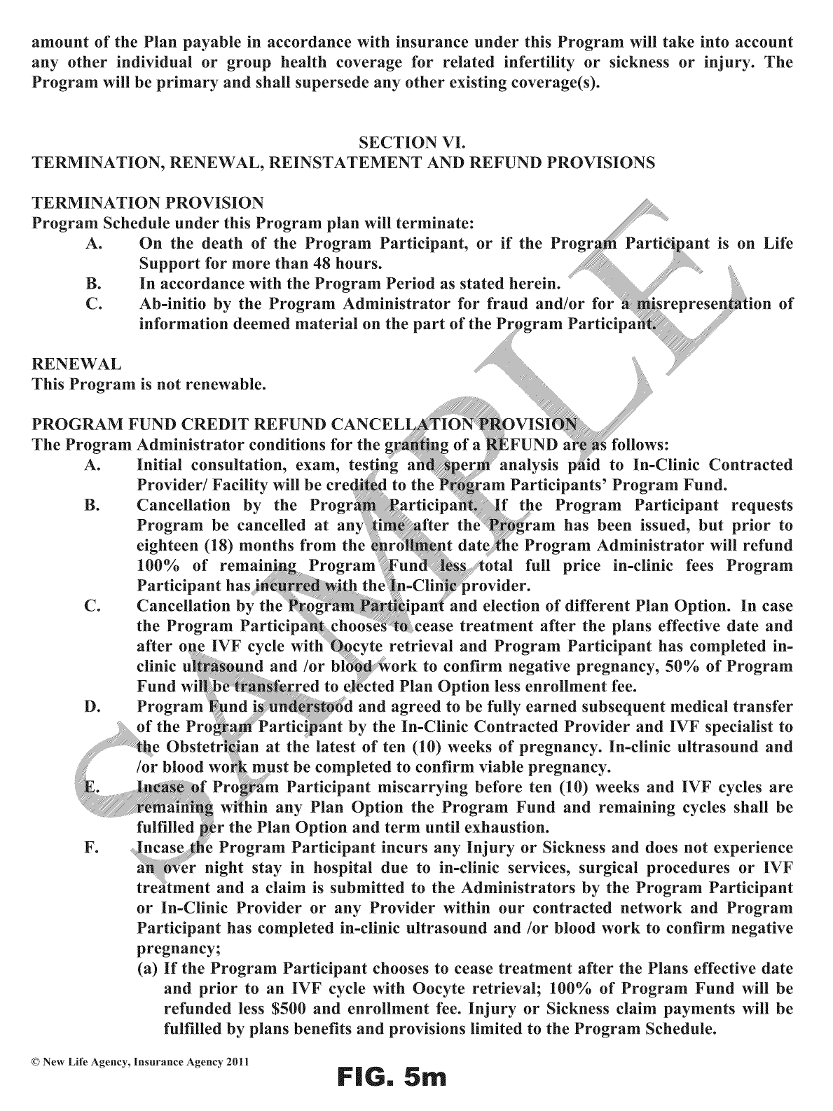

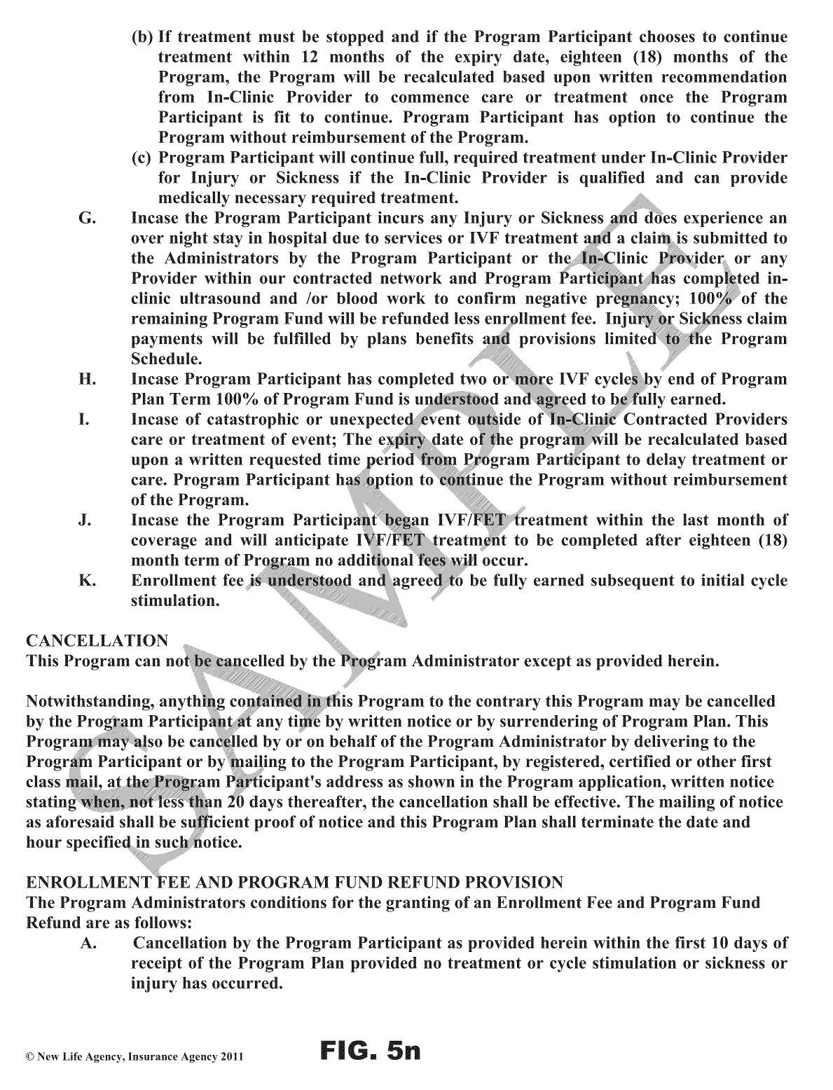

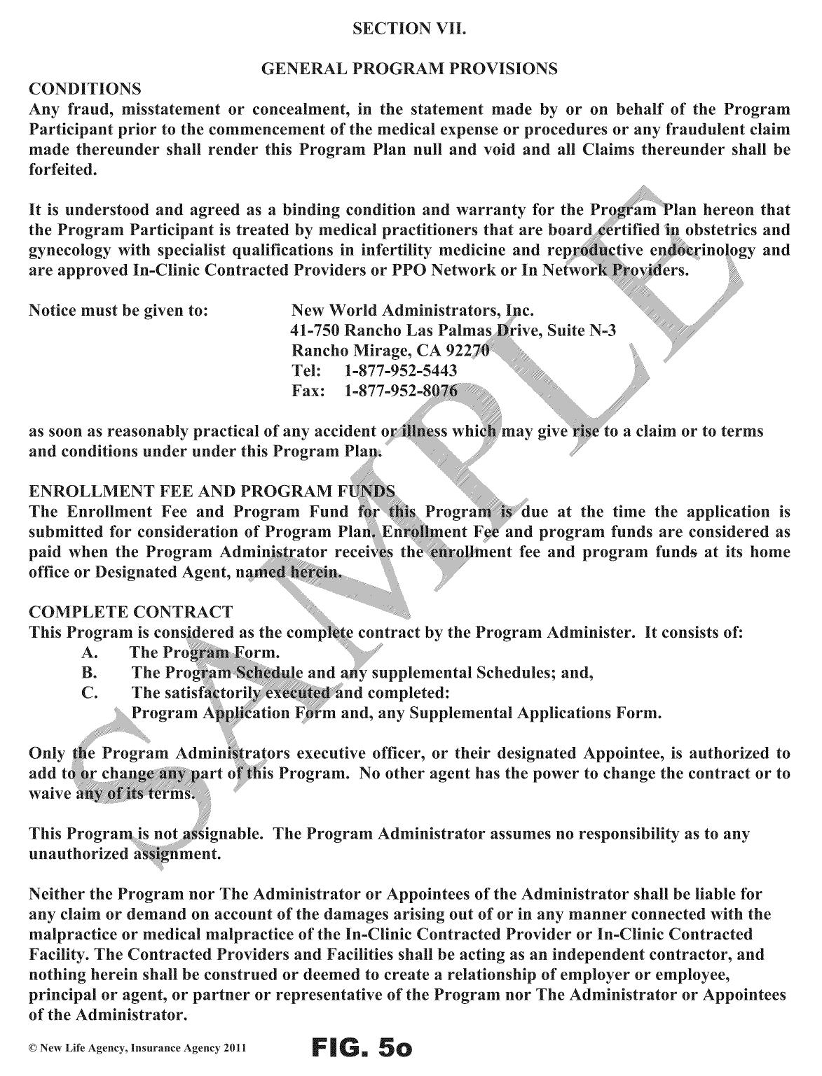

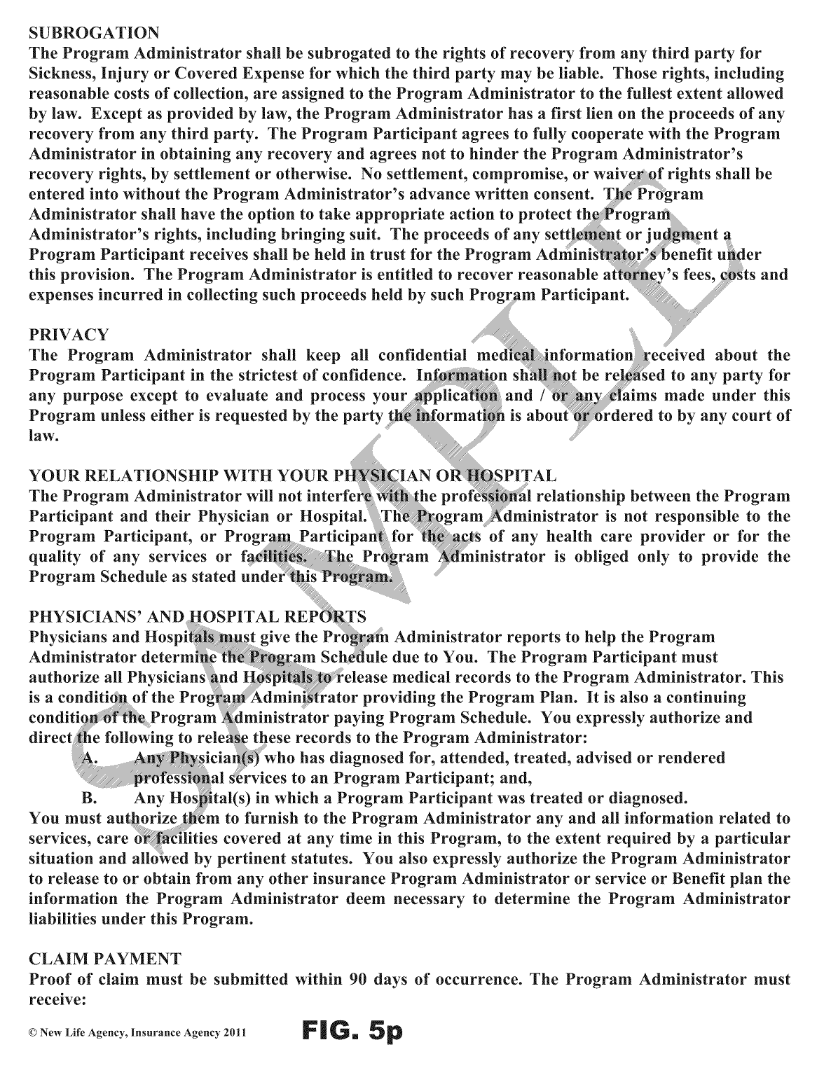

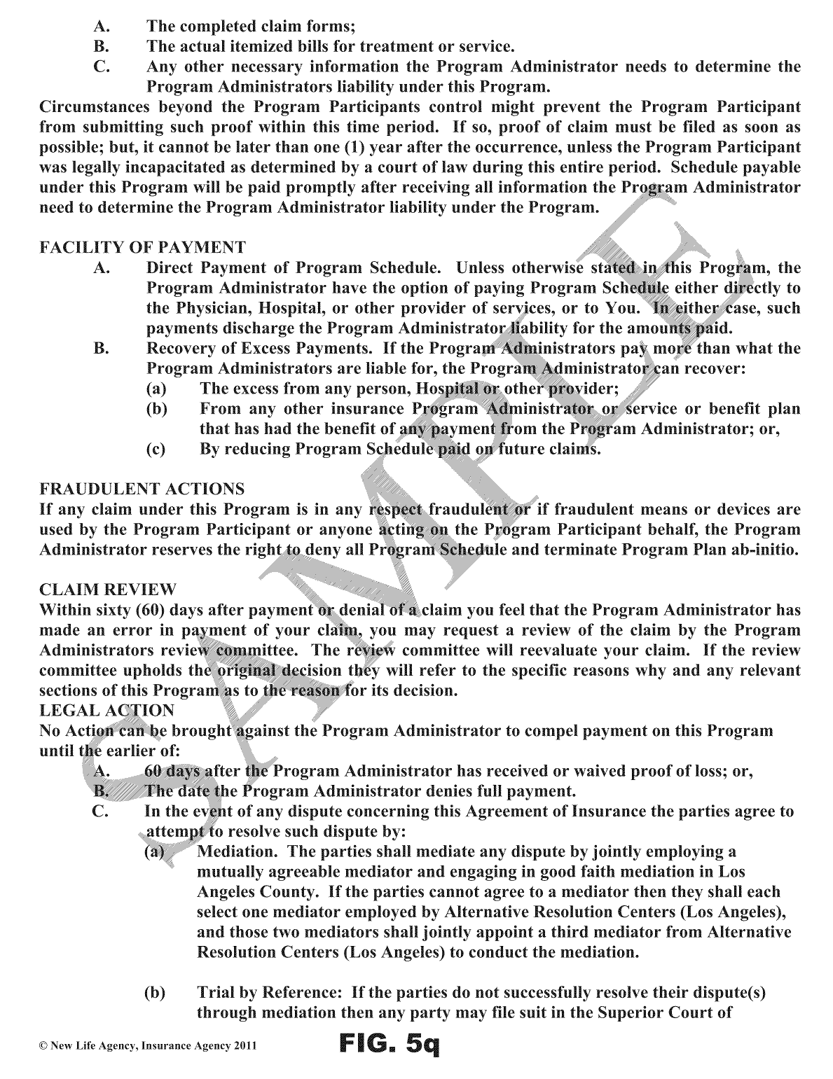

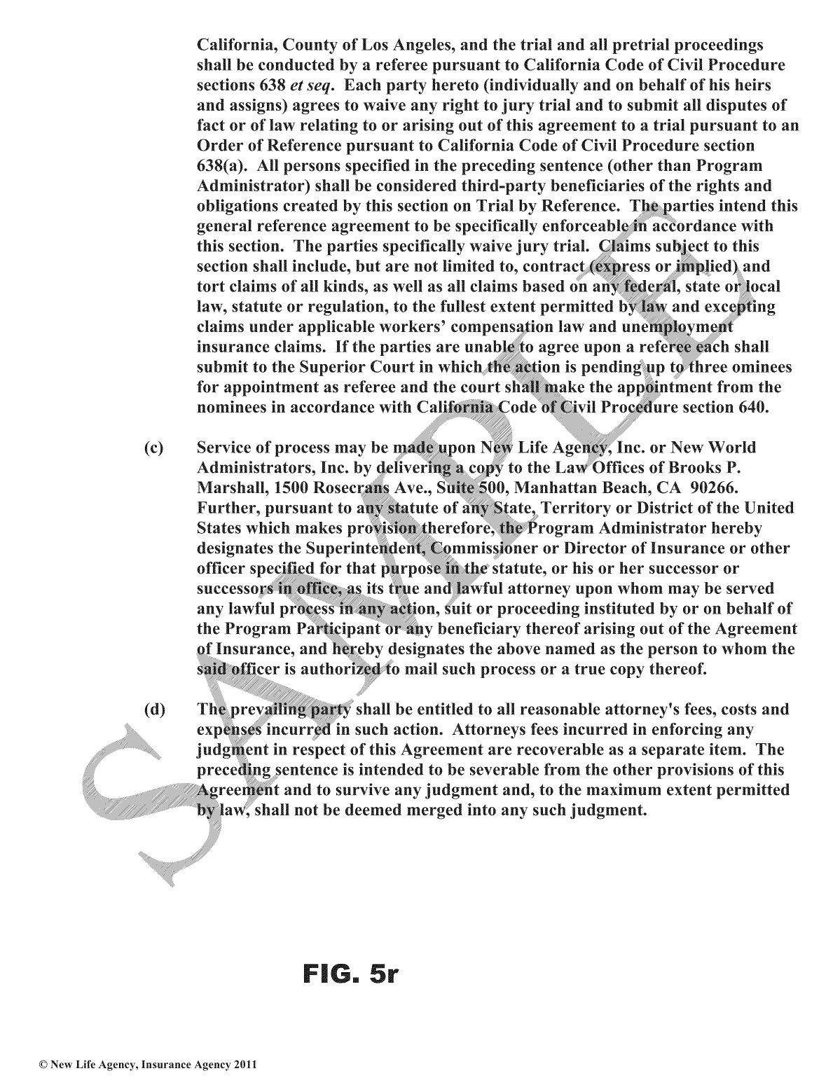

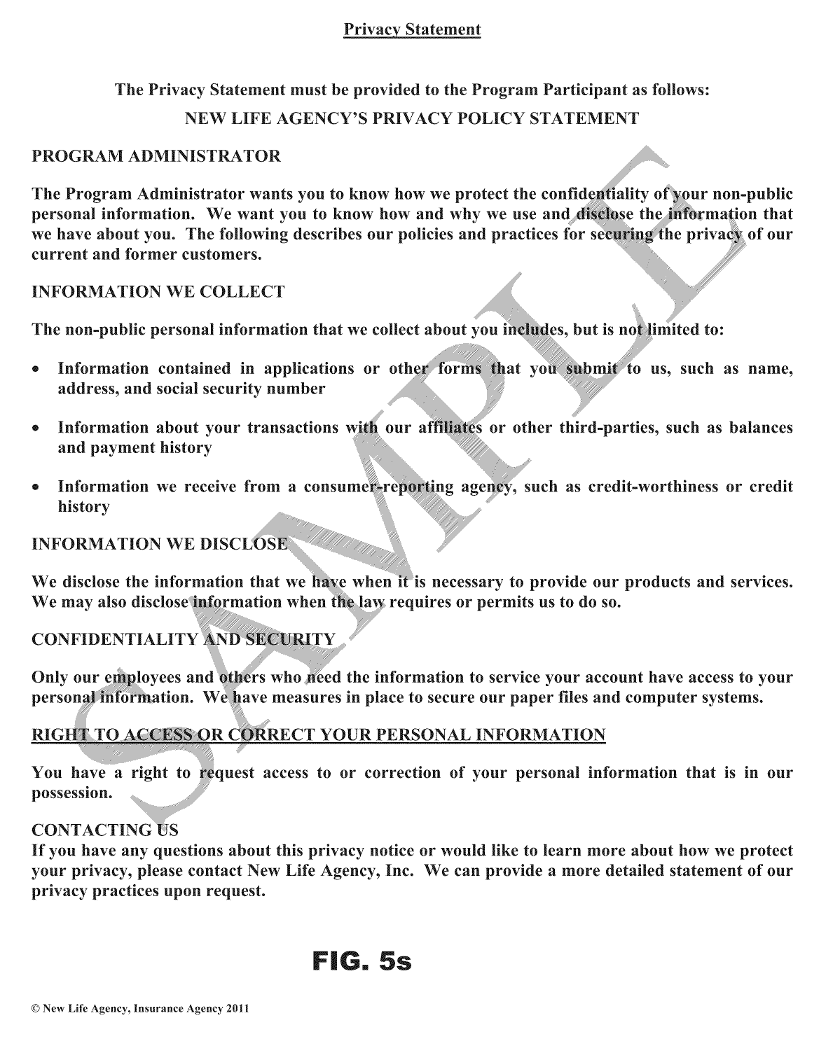

FIGS. 5 a-s are an illustration of one embodiment of an enrollment certificate for complication insurance of the present invention without surrogacy coverage. FIGS. 5 a-s is an example of one of an unlimited number of types of enrollment certificates that could be issued by an insurance agency. Although FIGS. 5 a-s shows a specific insurance agency and underwriter, it should be understood that the present invention may involve any insurance agency and/or underwriter. Preferably, at a minimum each of the twenty-four (24) insurance options listed in Table 1 would have their own enrollment certificates and insurance certificates. The patient is first issued an enrollment certificate with the enrollment date. Then, once treatment begins an insurance certificate is issued with the effective date reflecting the start of treatment or the six-week ultra sound if it is the maternity plan. The enrollment certificate is a receipt for the users purchase of the insurance and it acknowledges what they purchased. The insurance certificate is issued once the online report is completed and effective date is announced by the treatment and/or the six-week ultra sound is completed for pregnancy.

FIG. 5d shows how the present invention preferably covers: In-Clinic Injury or Sickness at $250,000 per Program Participant, combined single limit; In-Clinic Accidental Paralysis at $100,000 in respect of Accidental Paralysis Coverage; and In-Clinic Accidental Death at $100,000 in respect of Accidental Death Coverage.

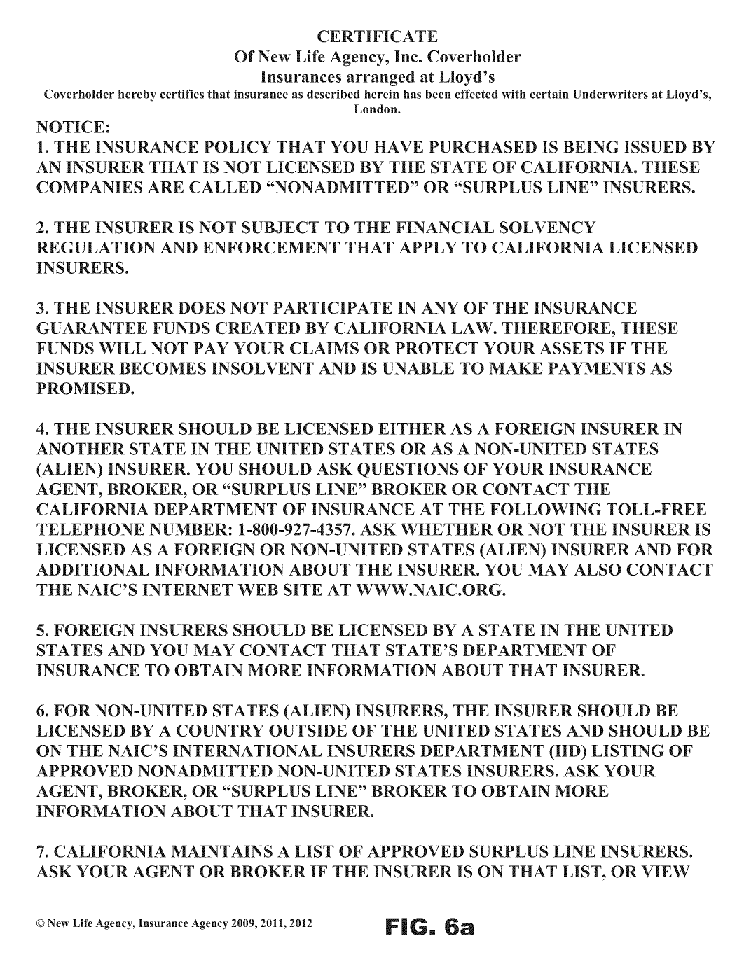

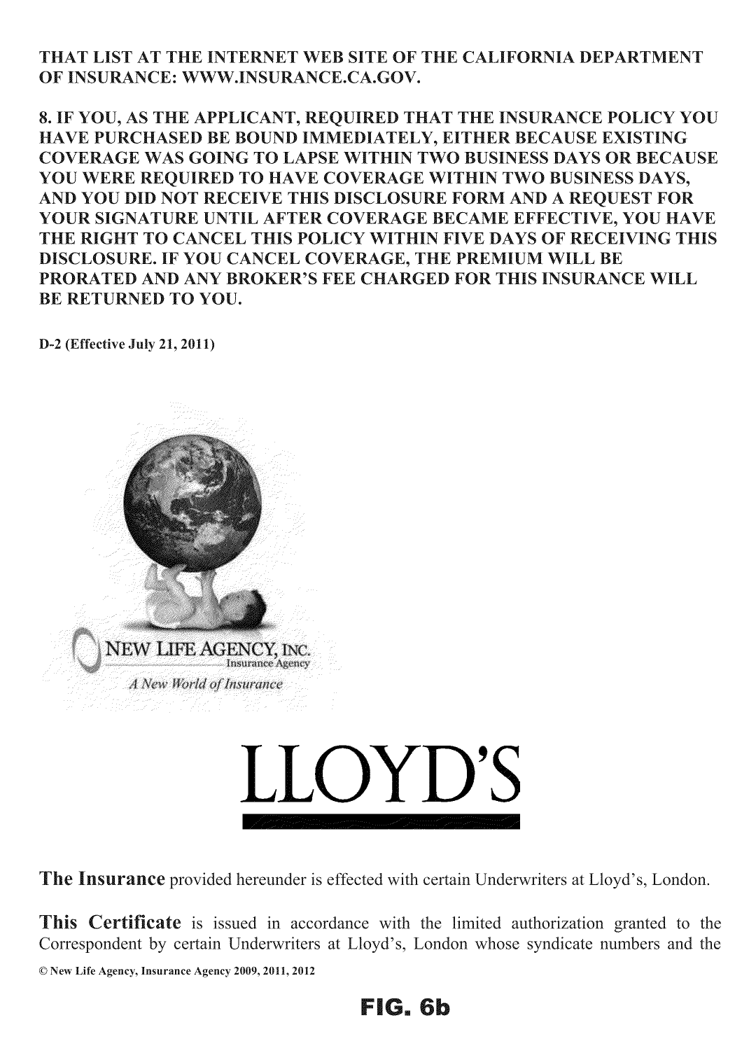

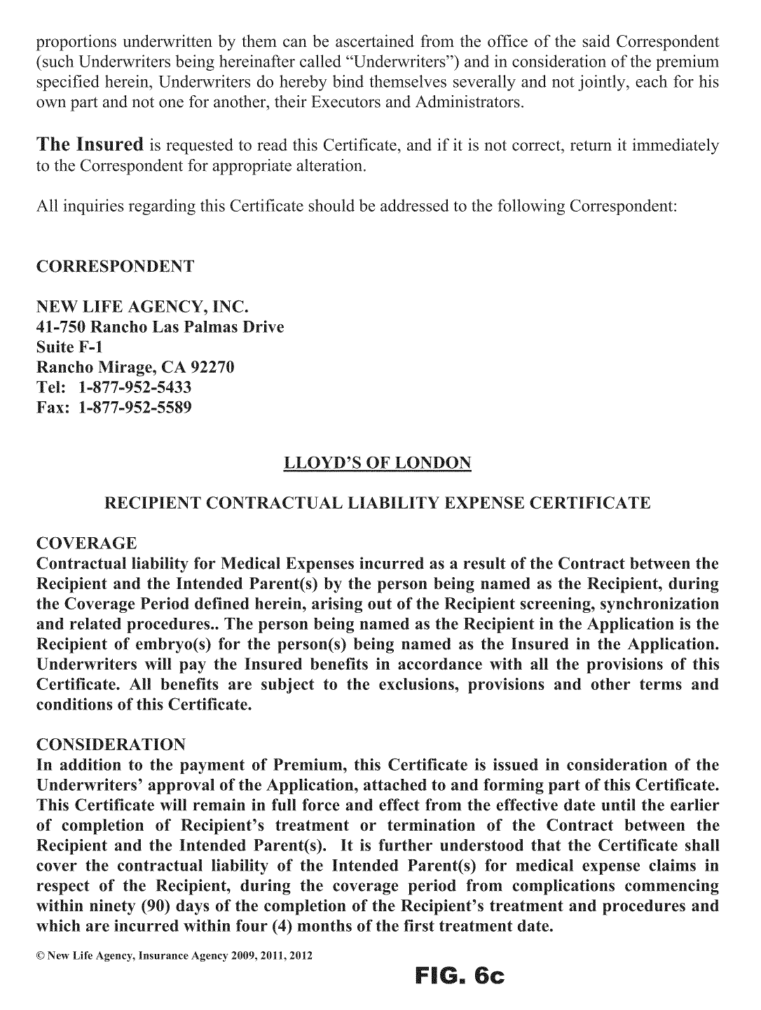

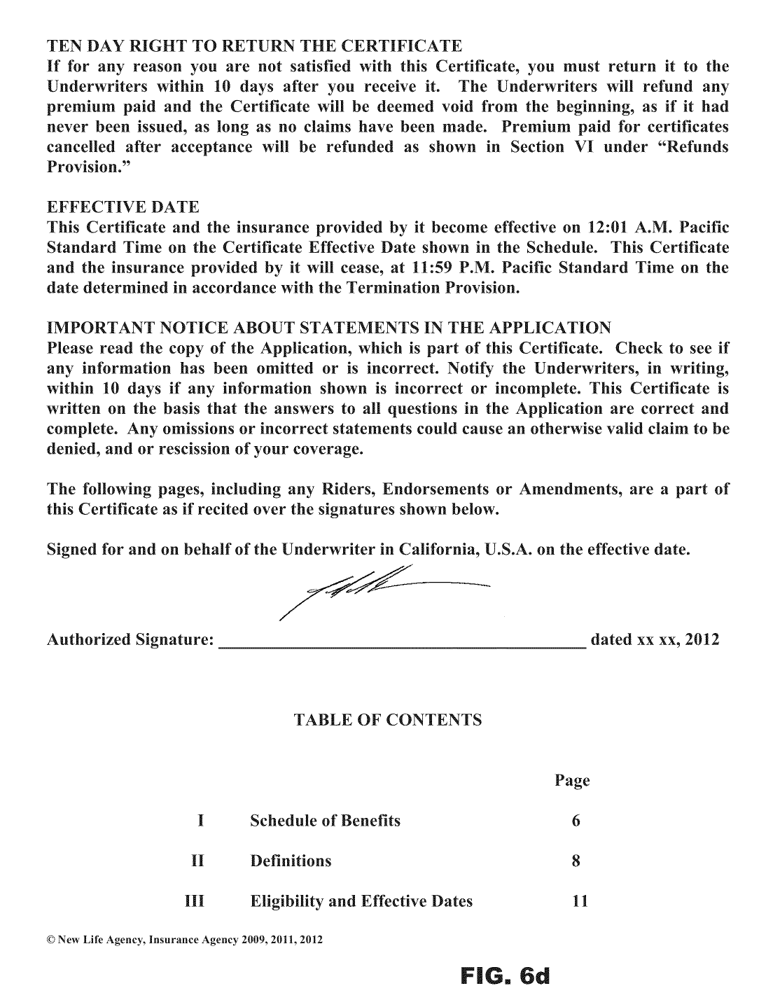

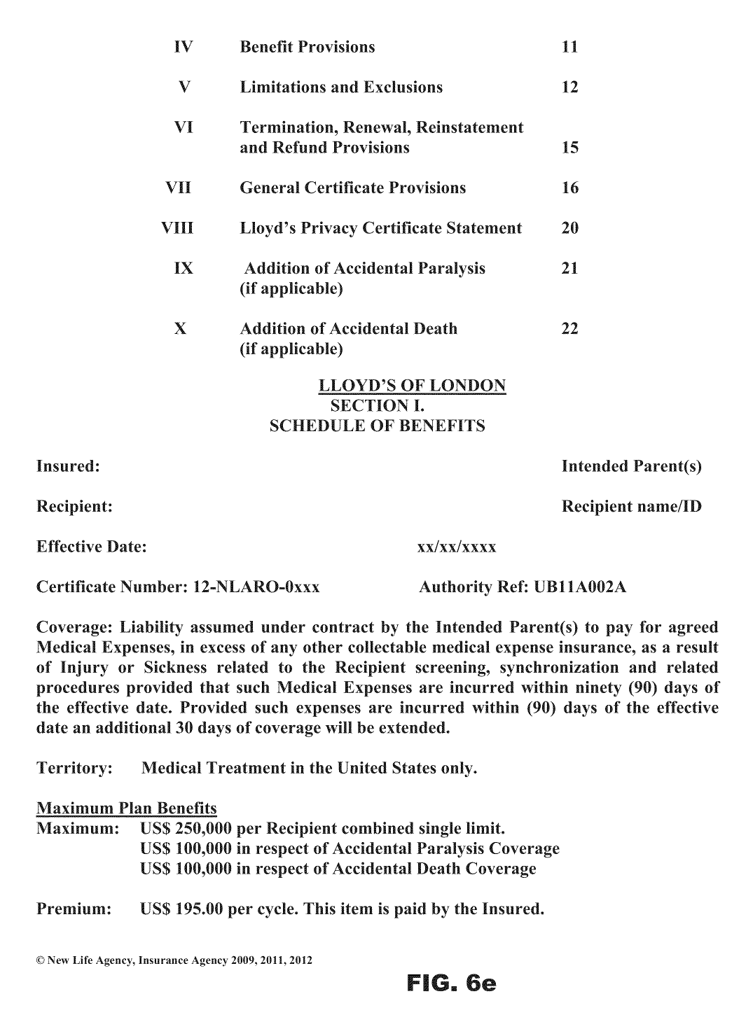

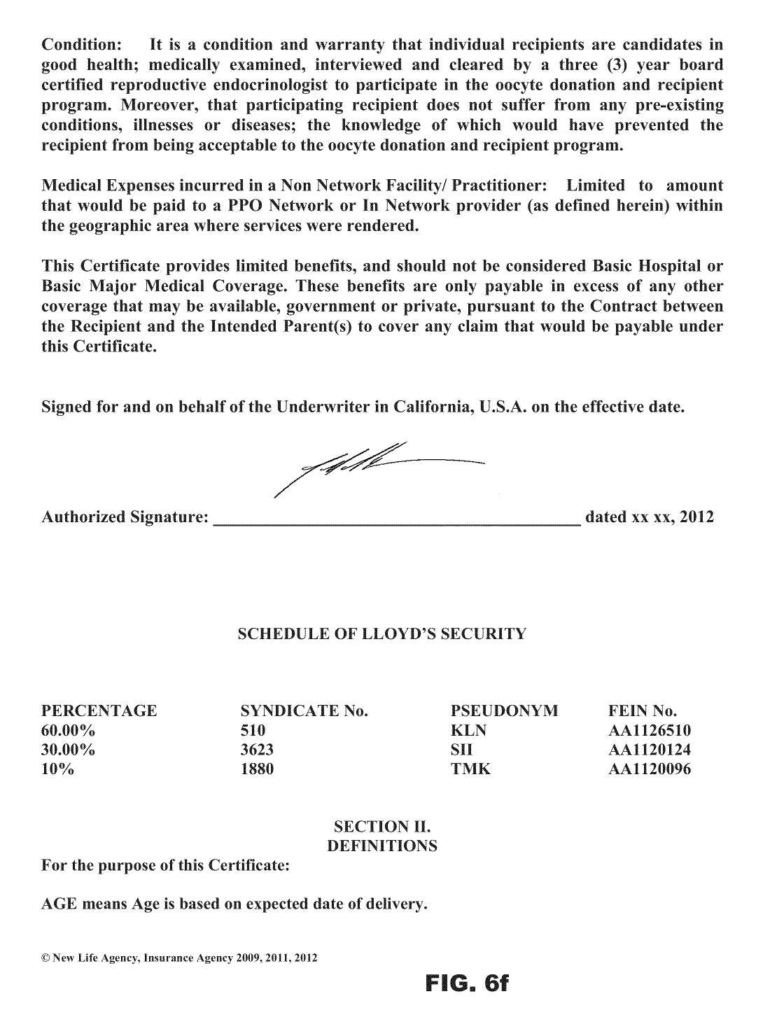

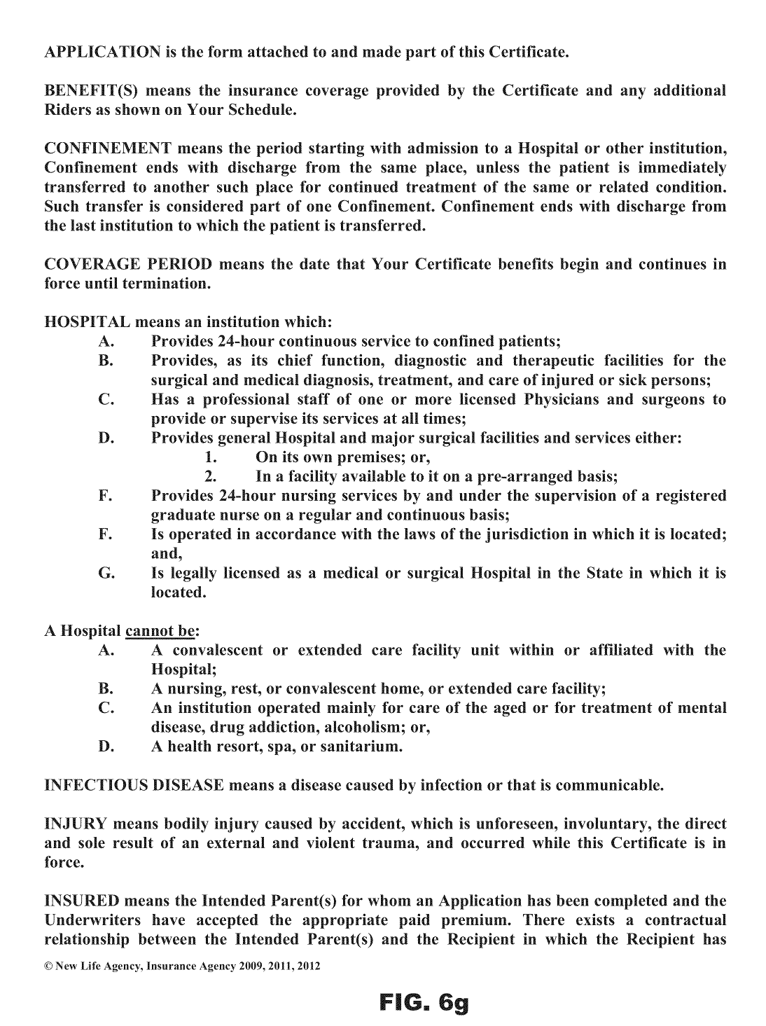

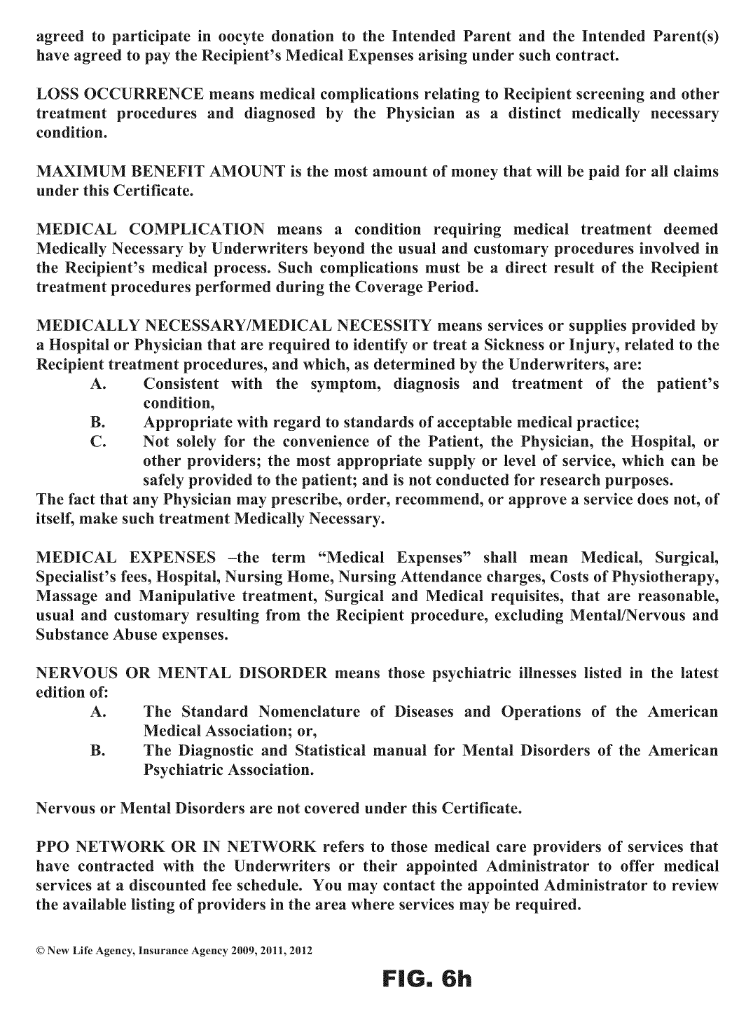

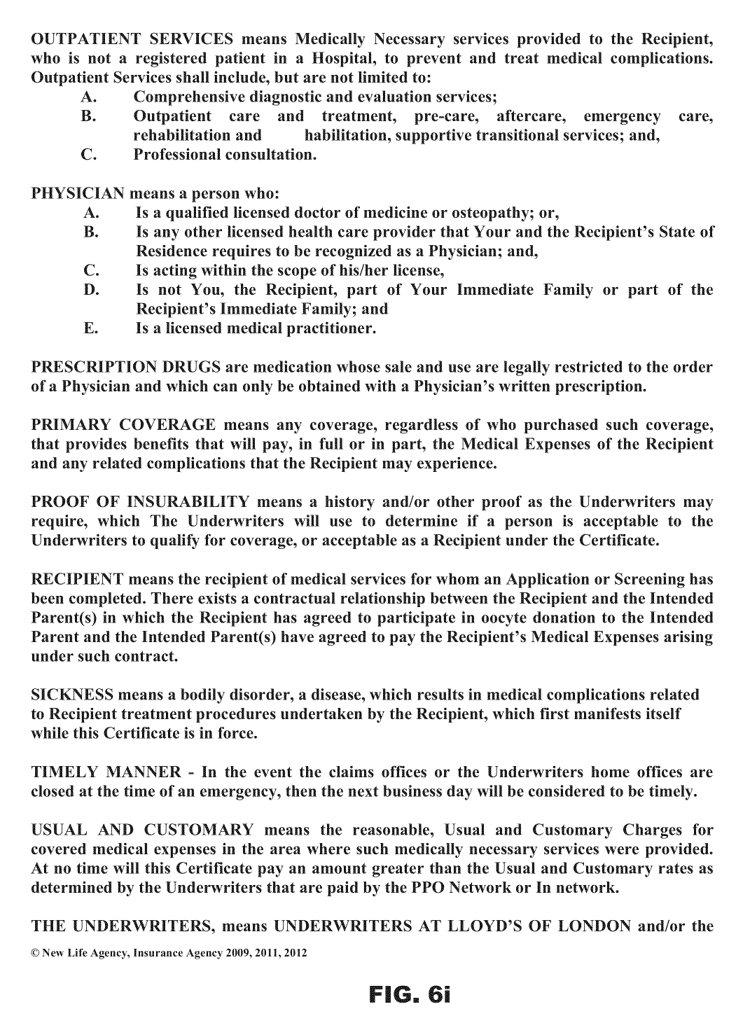

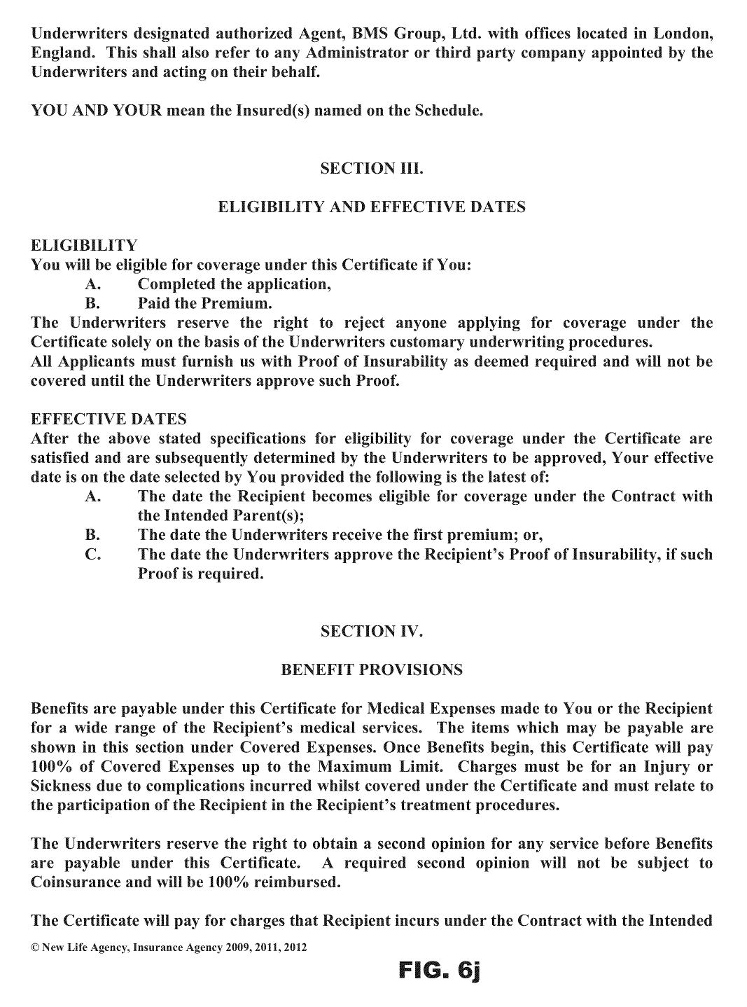

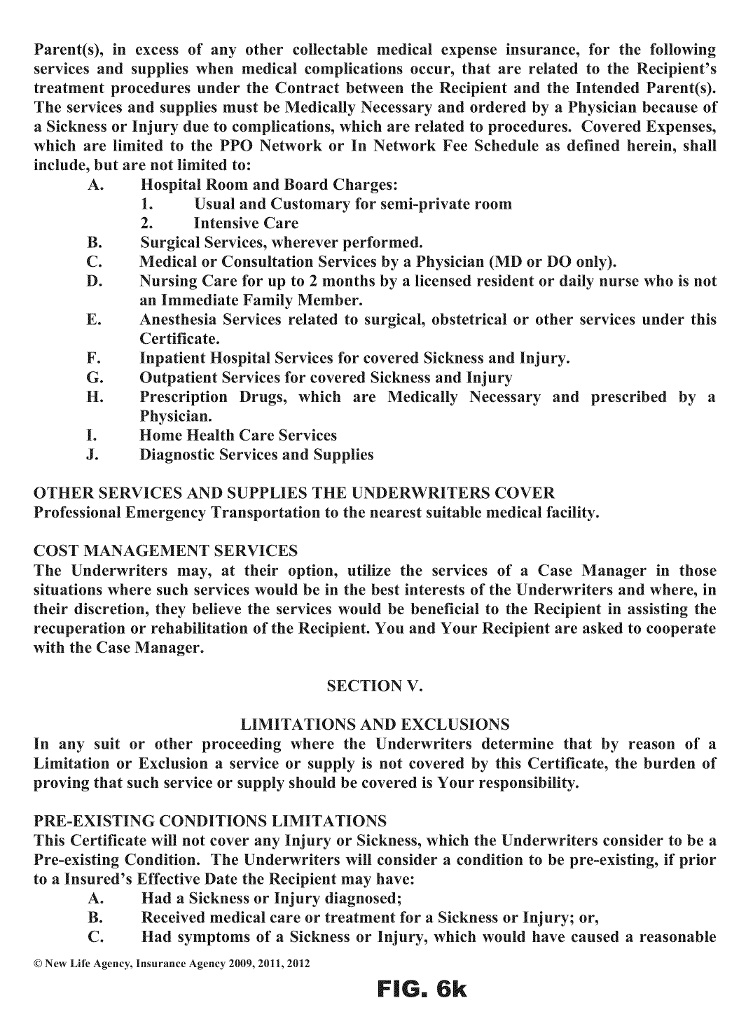

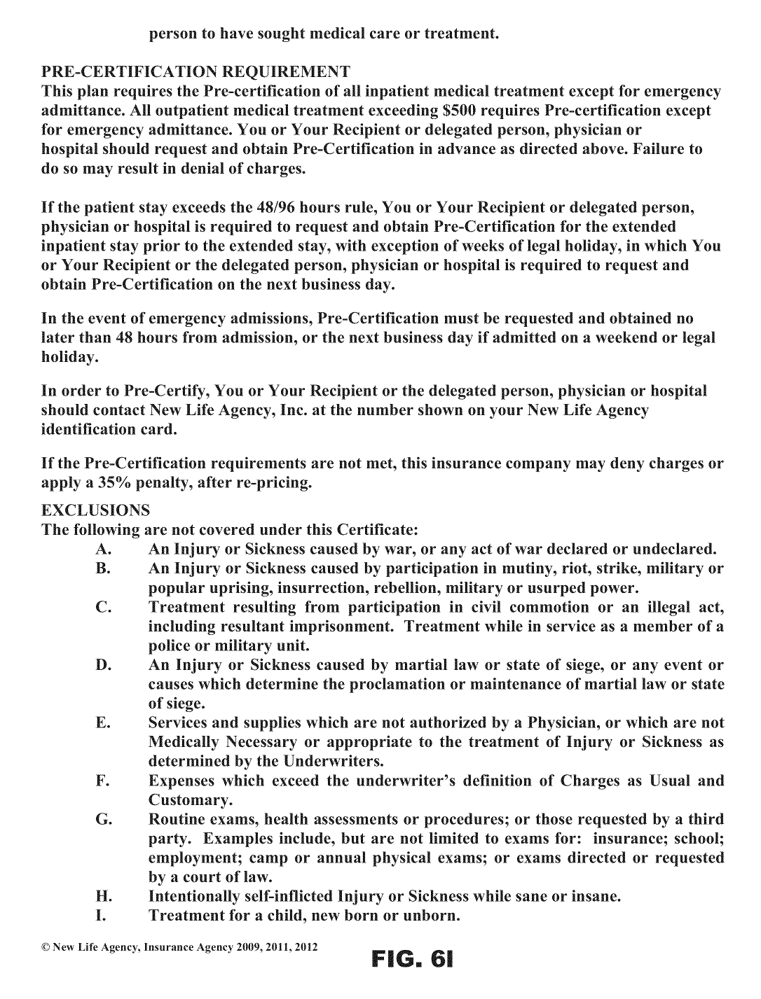

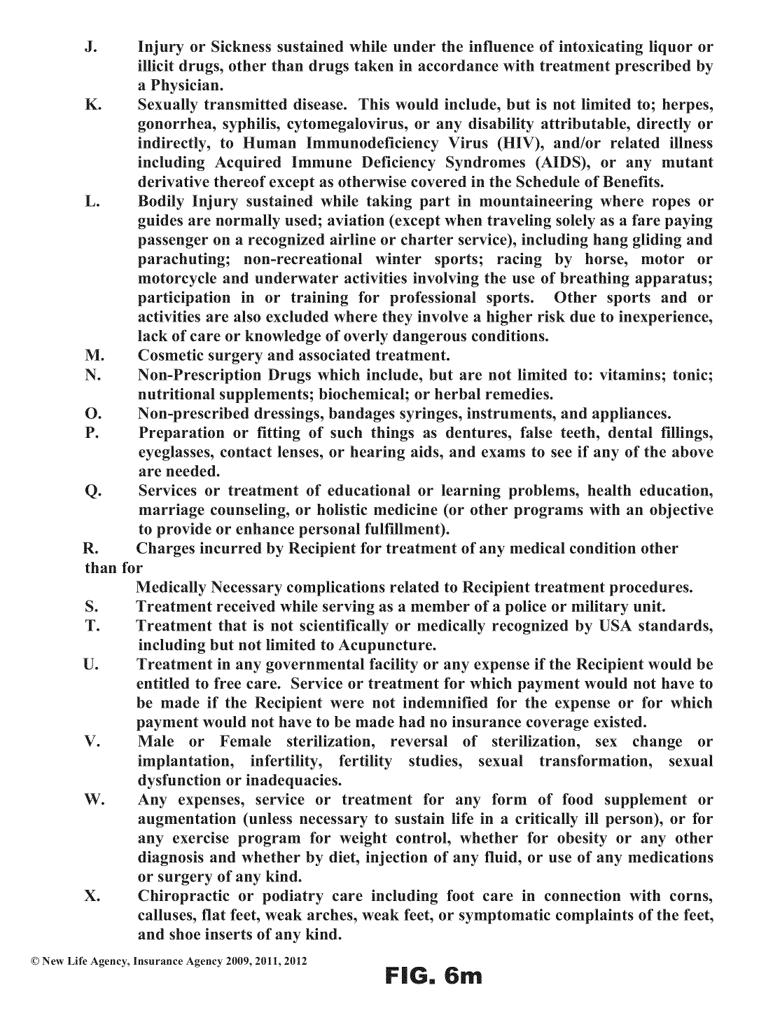

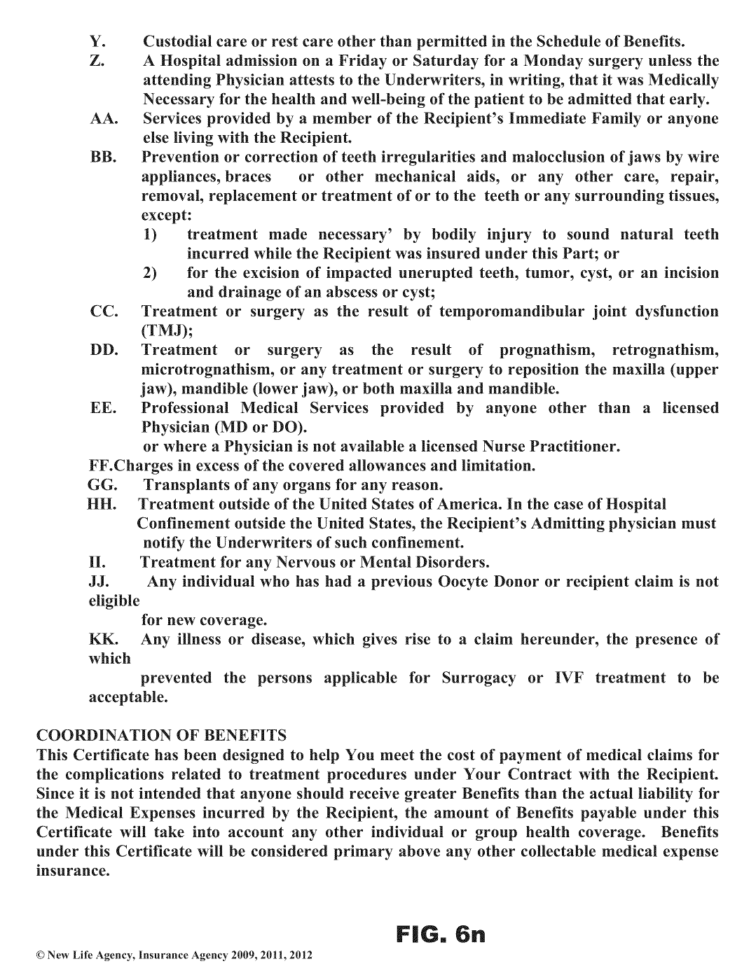

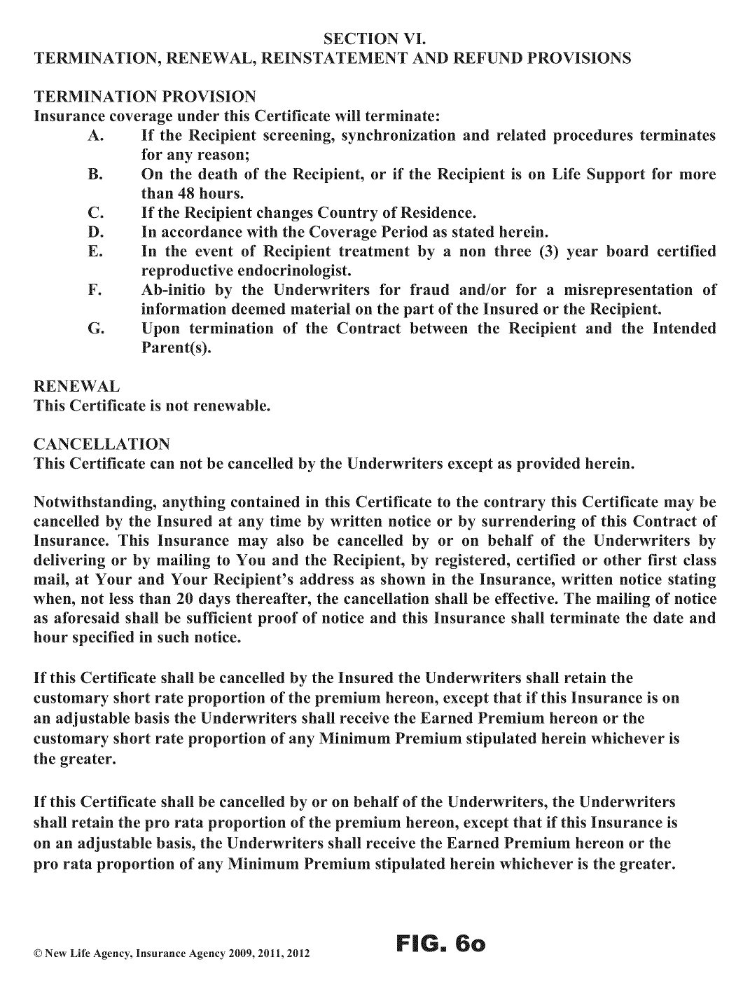

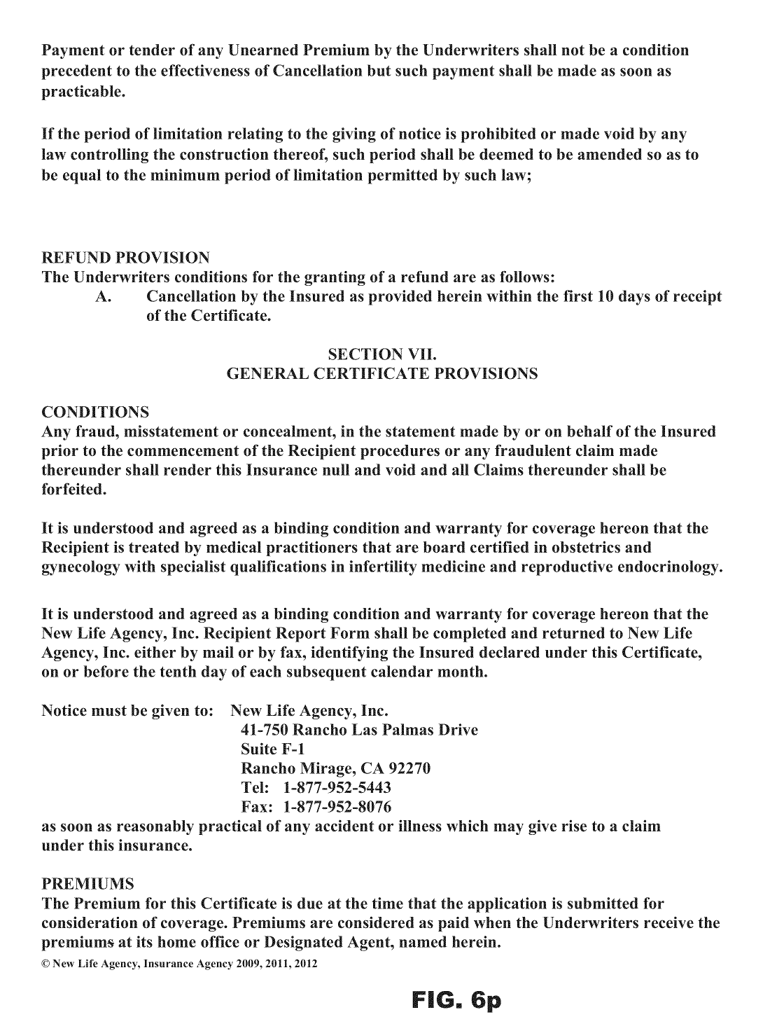

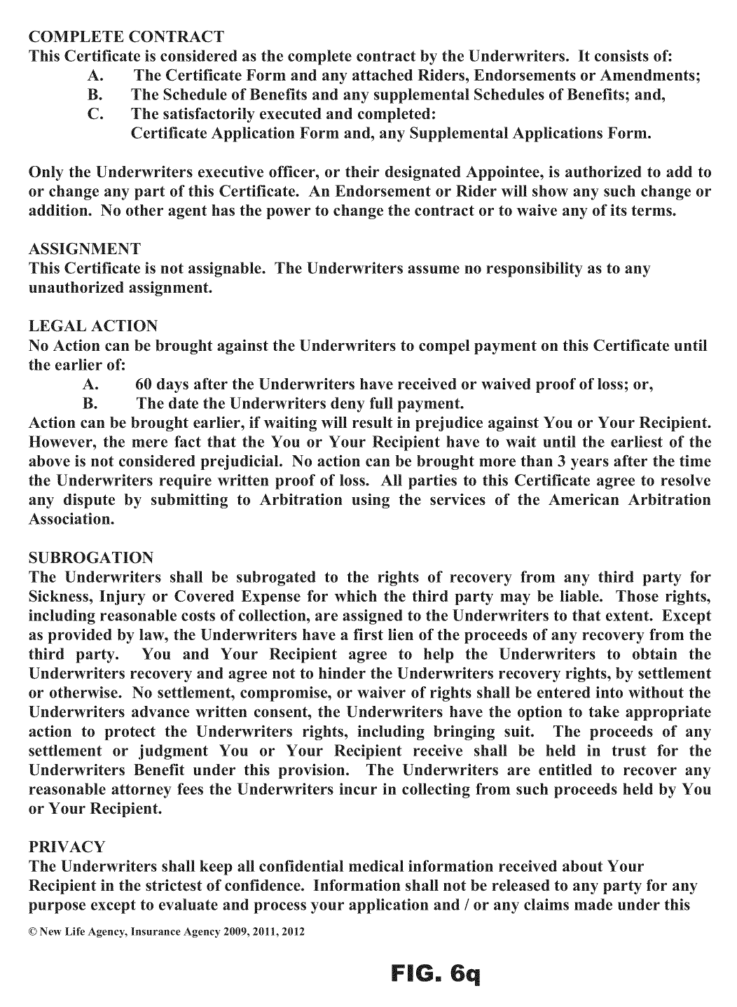

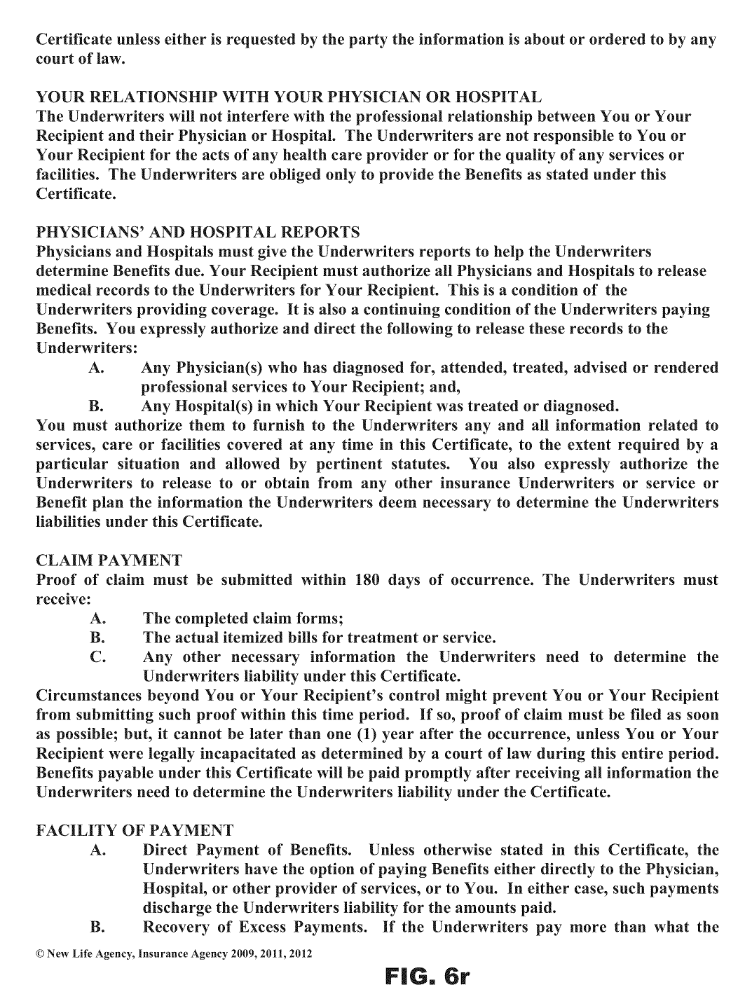

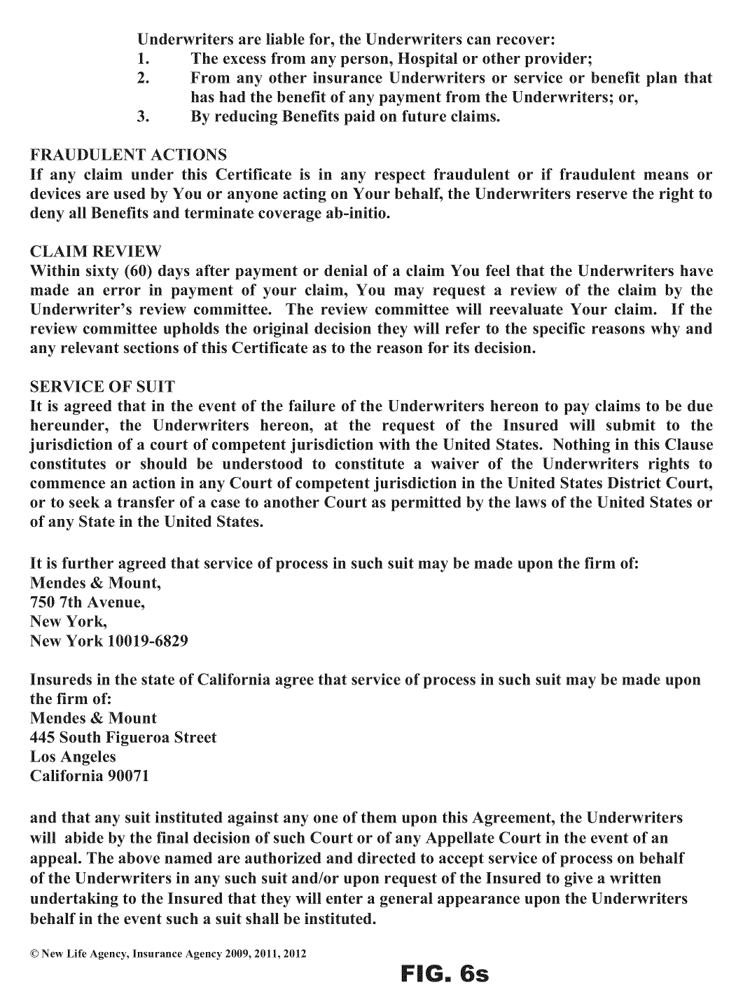

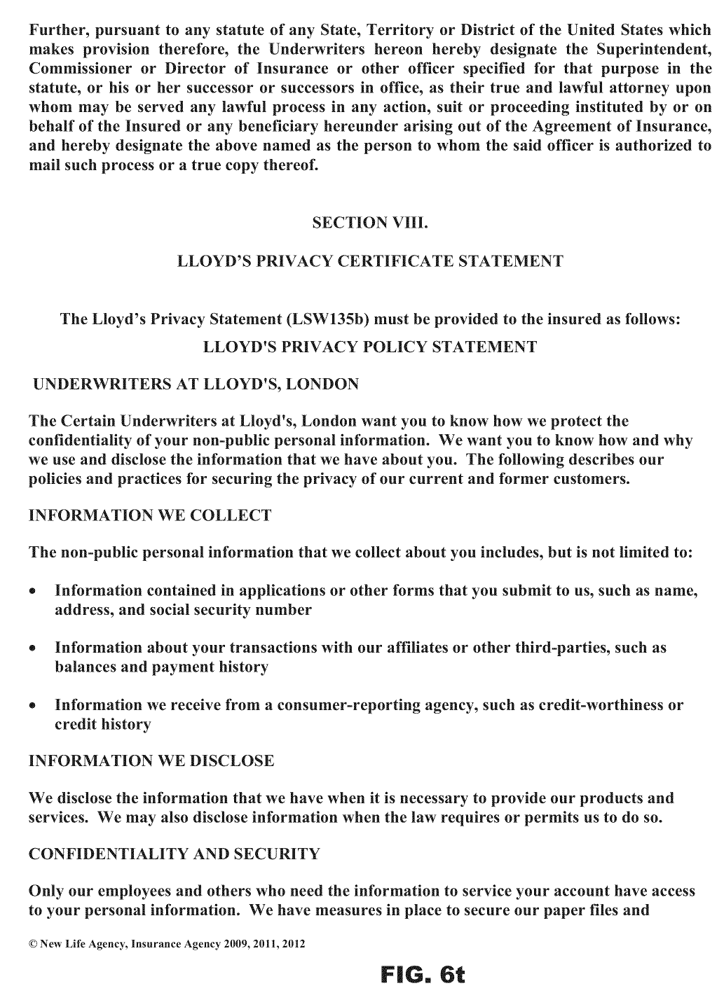

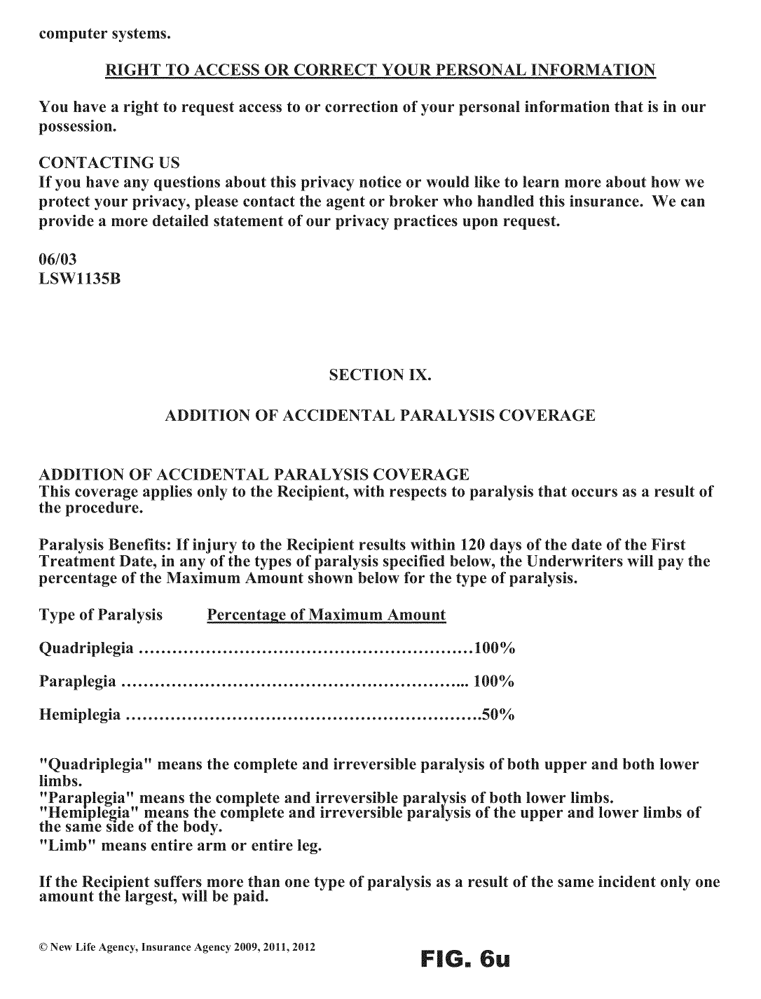

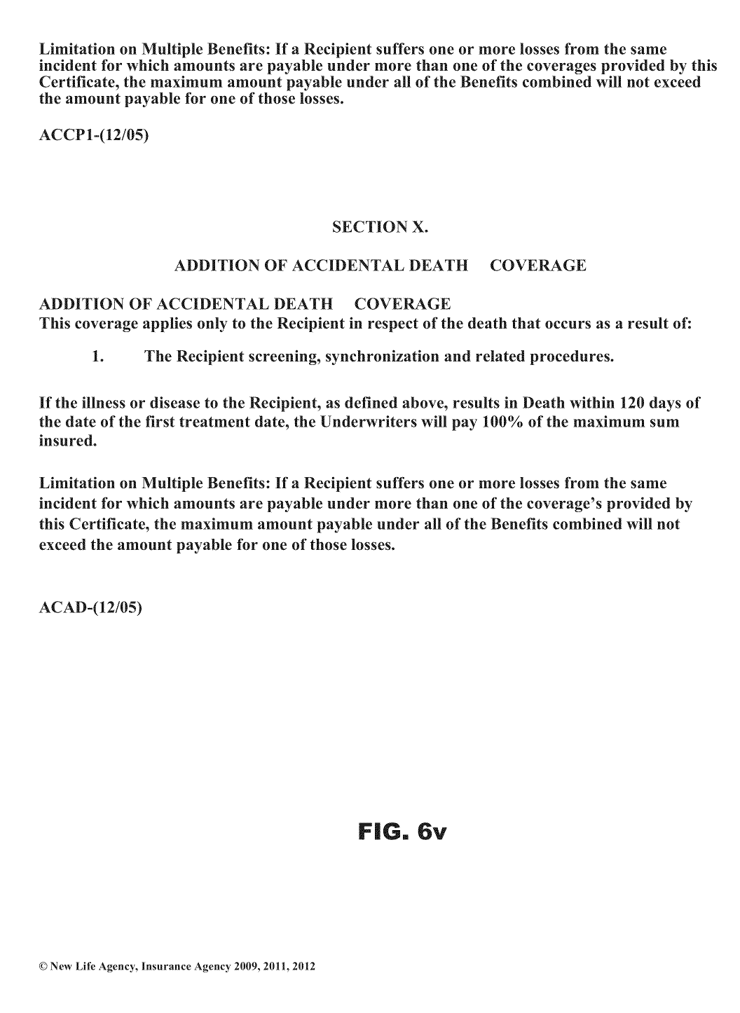

FIGS. 6 a-v are an illustration of one embodiment of an insurance certificate for complication insurance of the present invention without surrogacy pregnancy coverage. FIGS. 6 a-v is an example of one of an unlimited number of types of insurance certificates that could be issued by an insurance agency. Although FIGS. 6 a-v shows a specific insurance agency and underwriter, it should be understood that the present invention may involve any insurance agency and/or underwriter. Preferably, at a minimum each of the twenty-four (24) insurance options listed in Table 1 would have their own certificate.

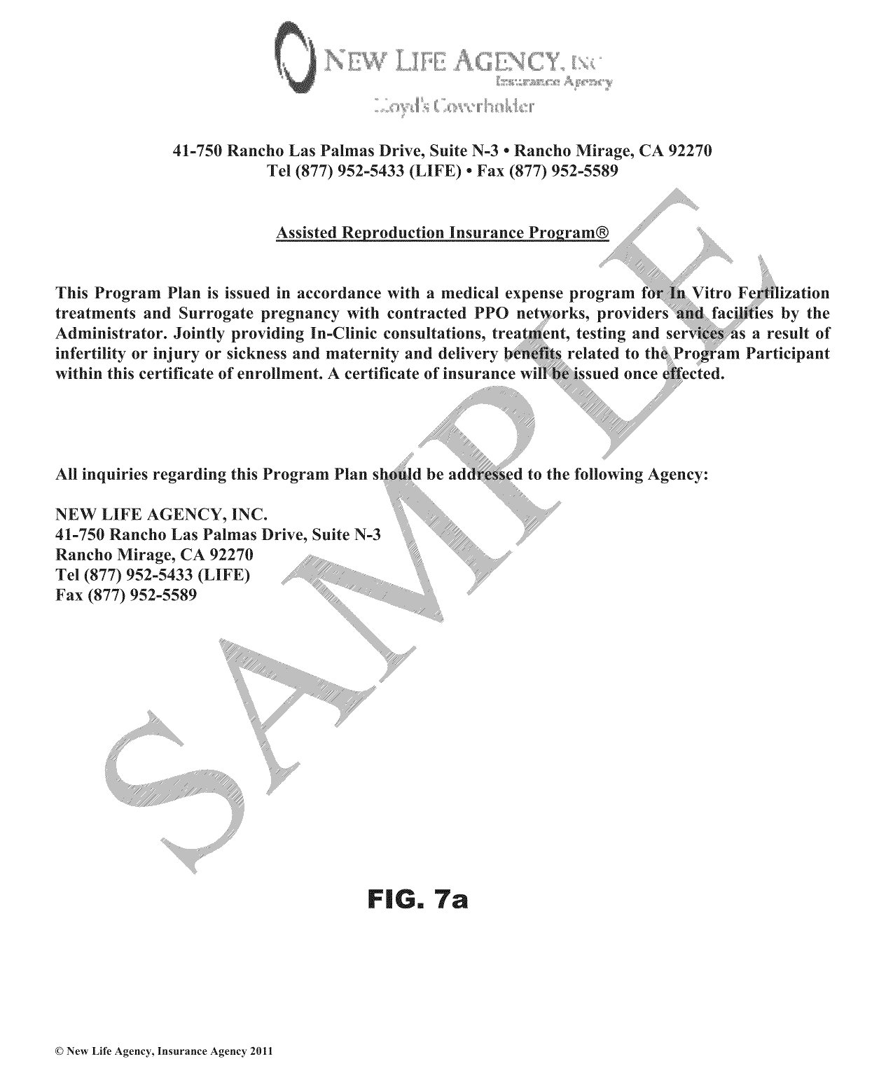

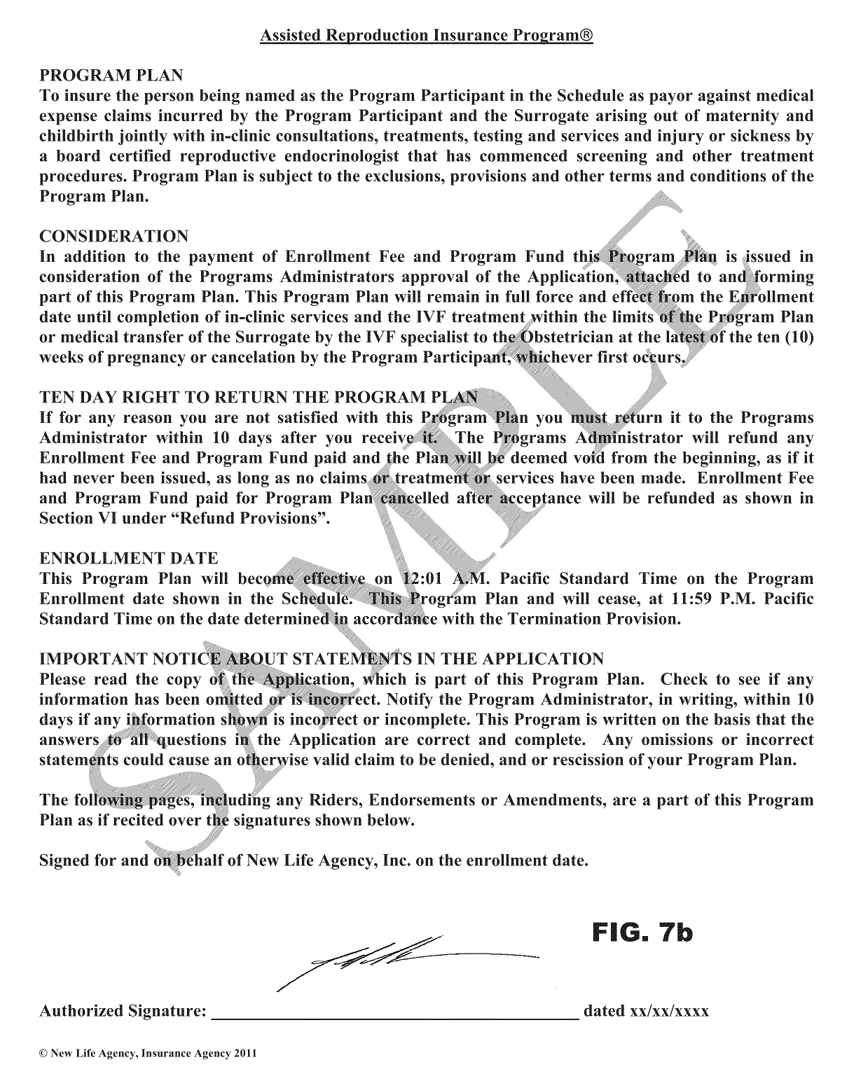

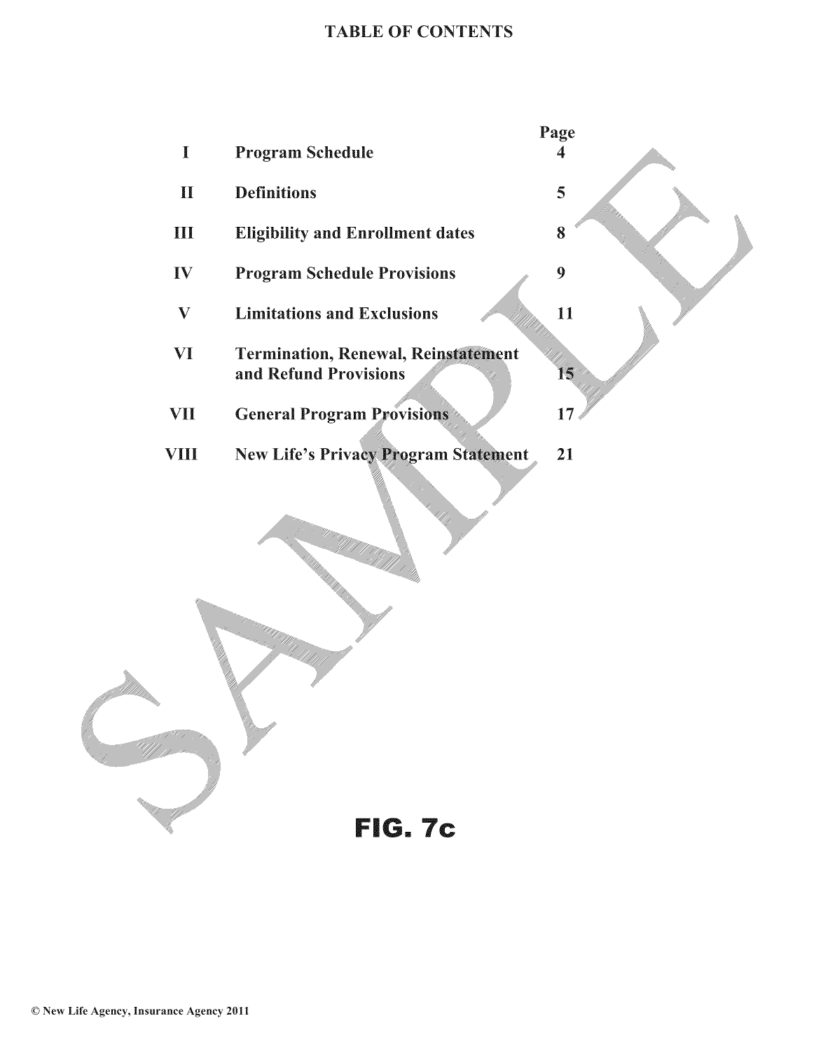

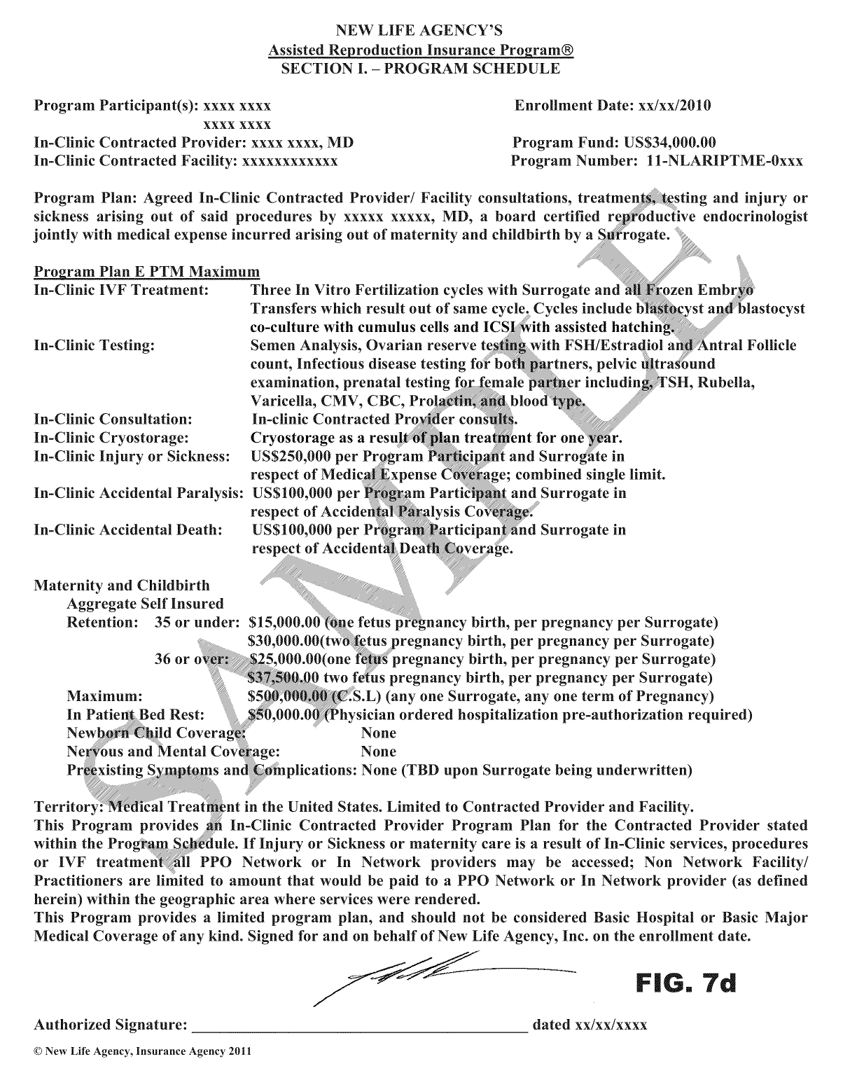

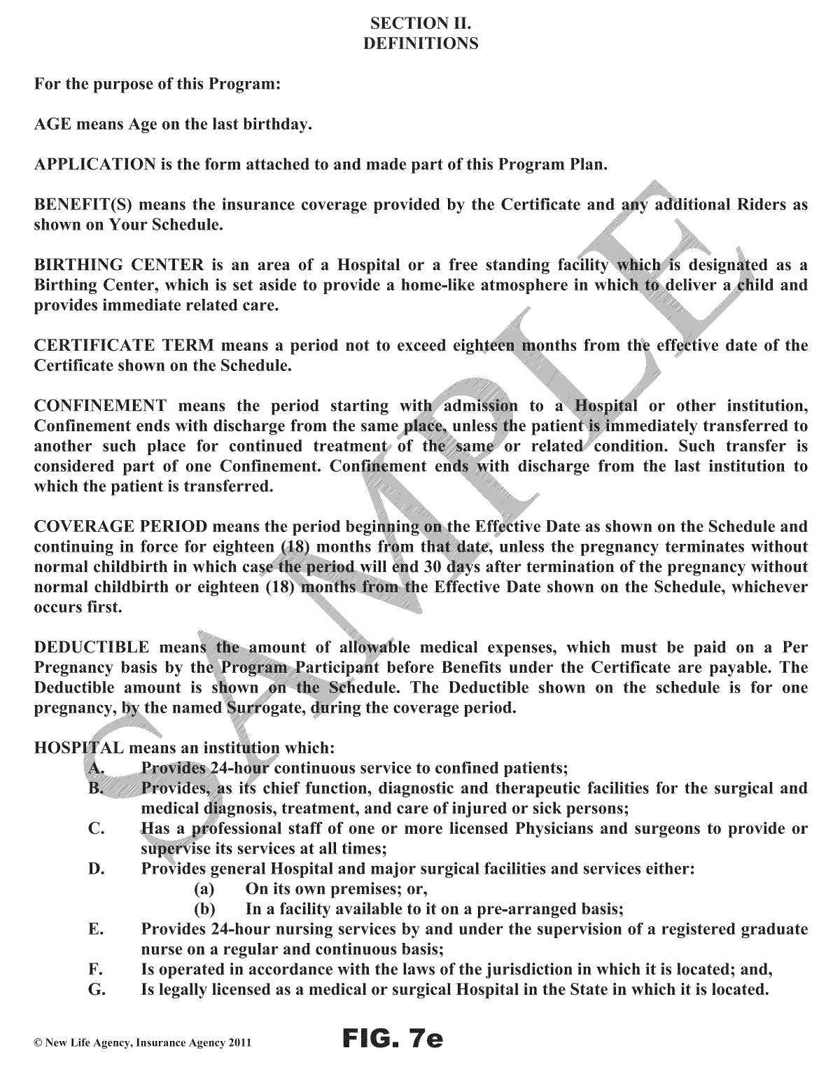

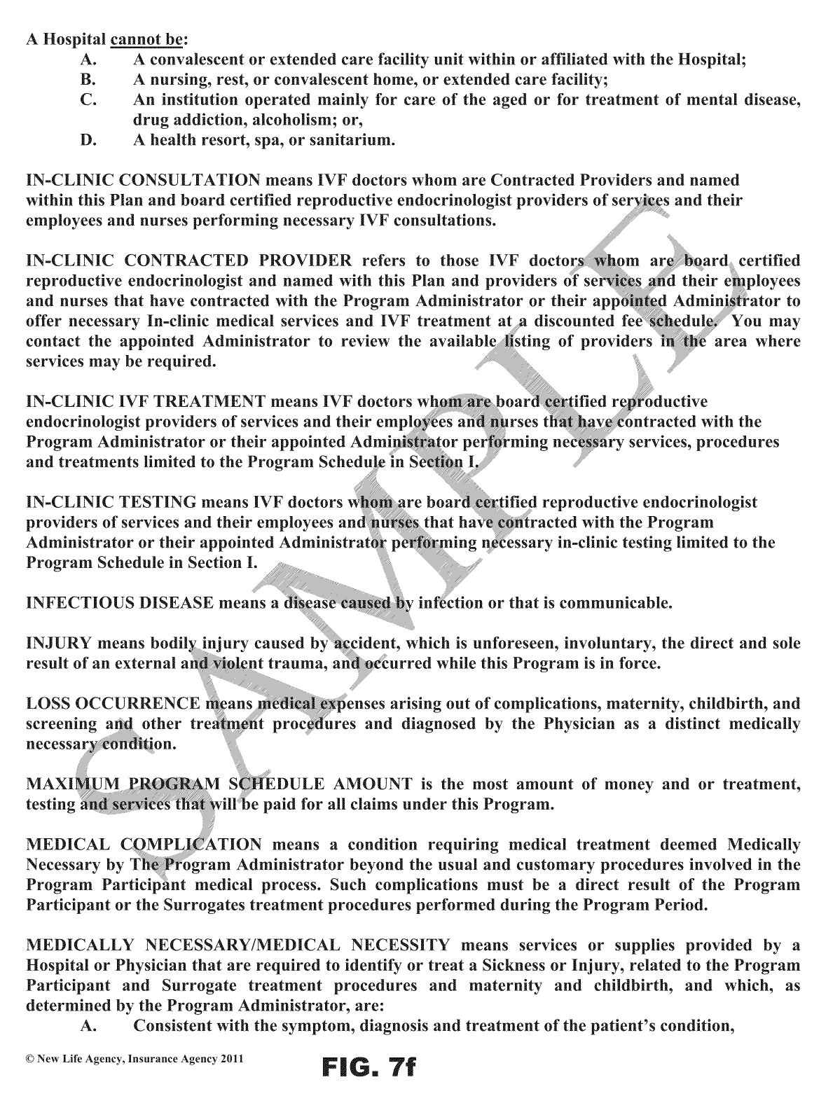

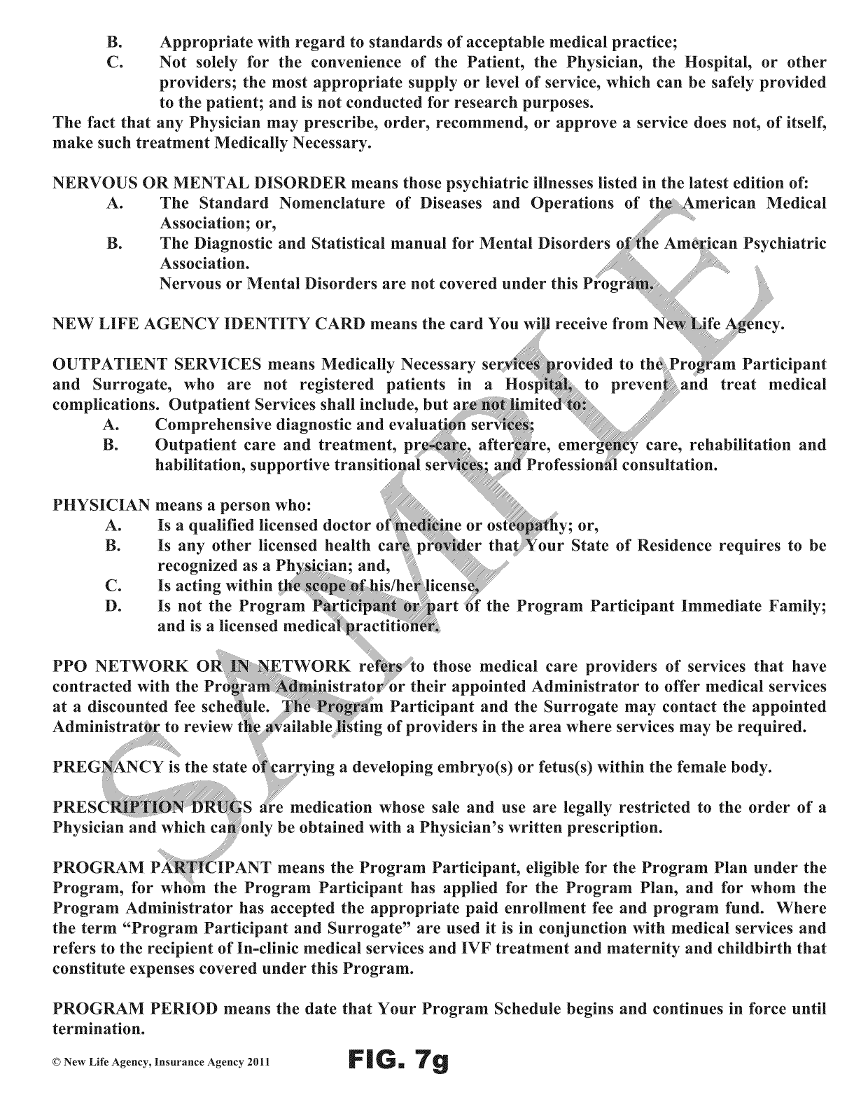

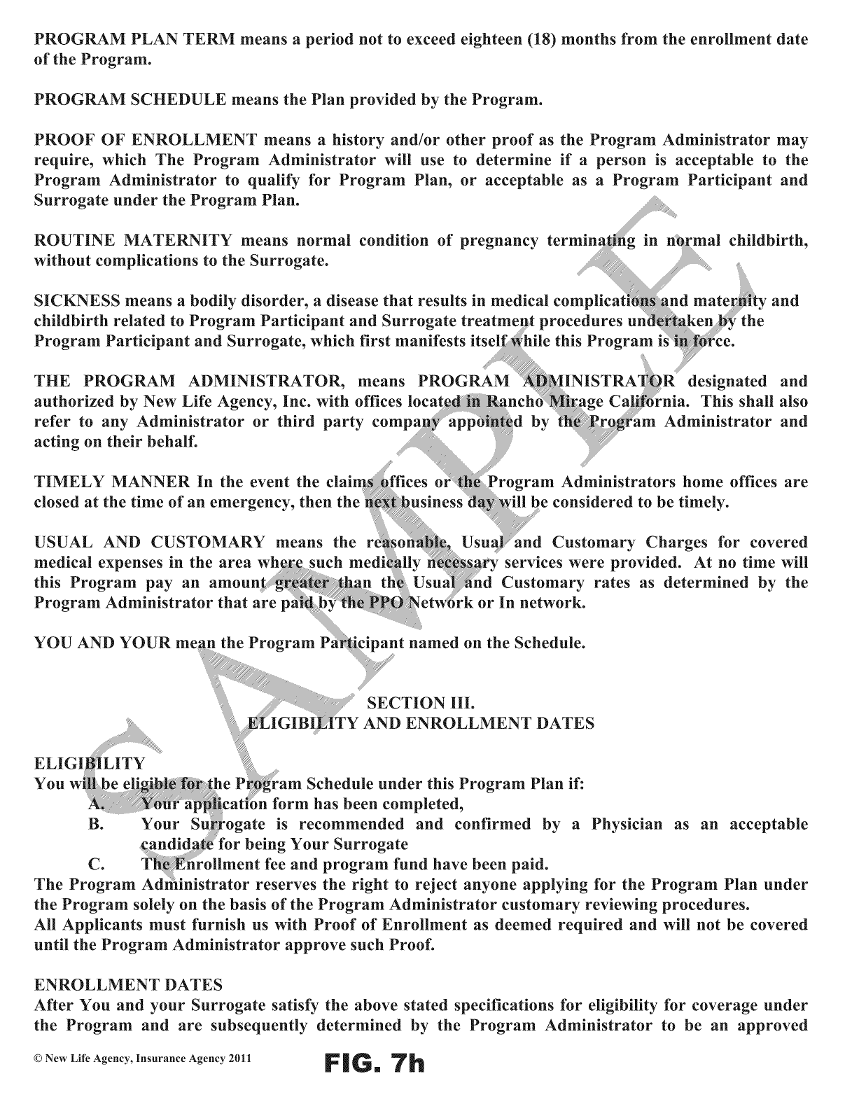

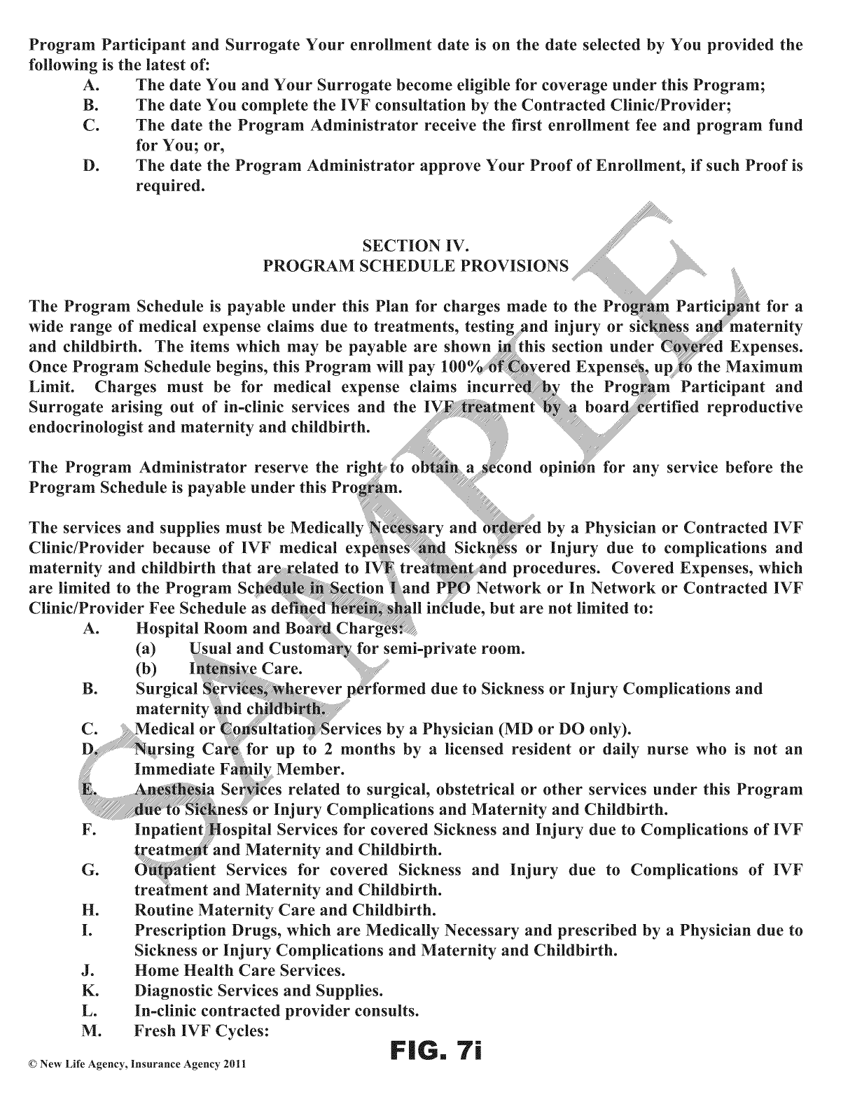

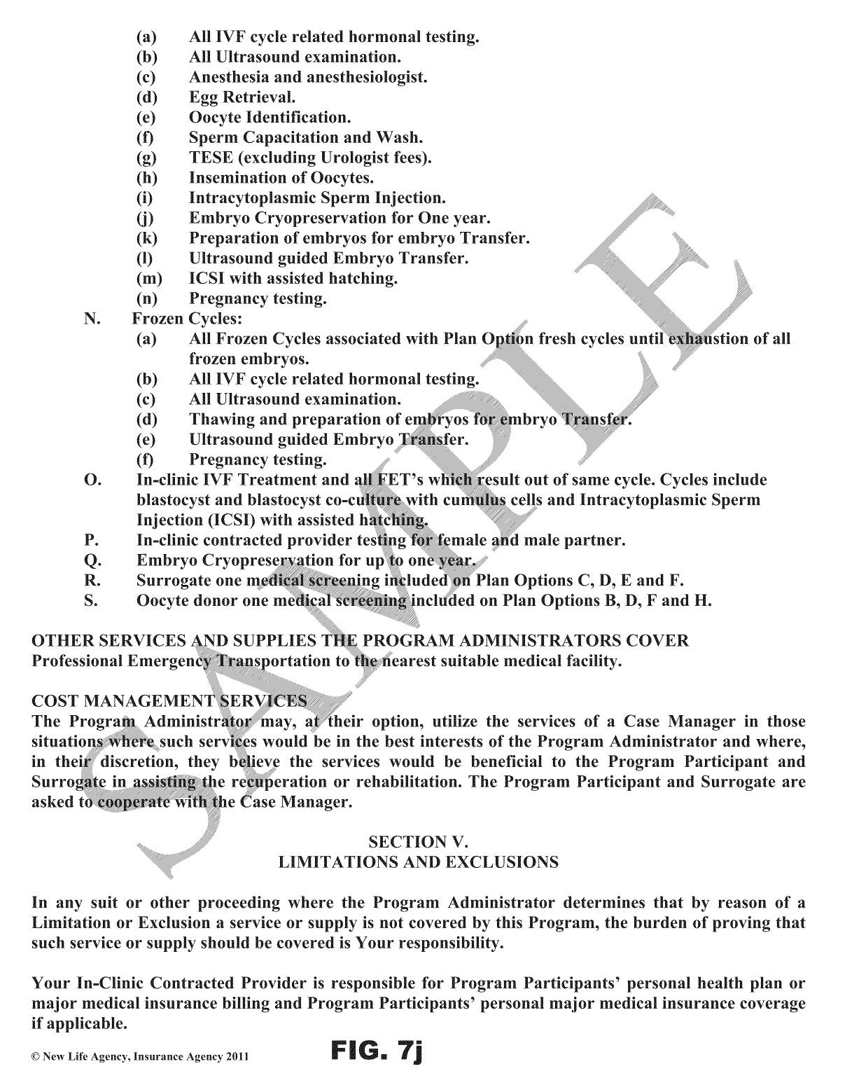

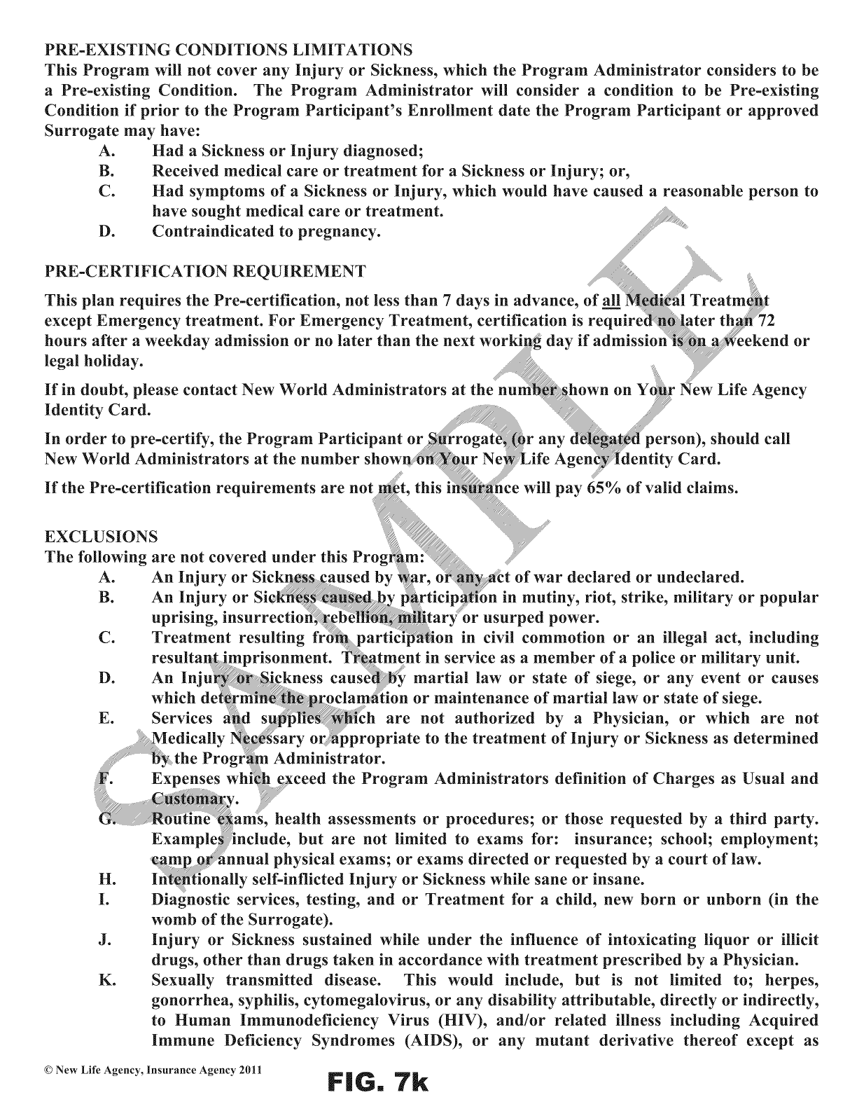

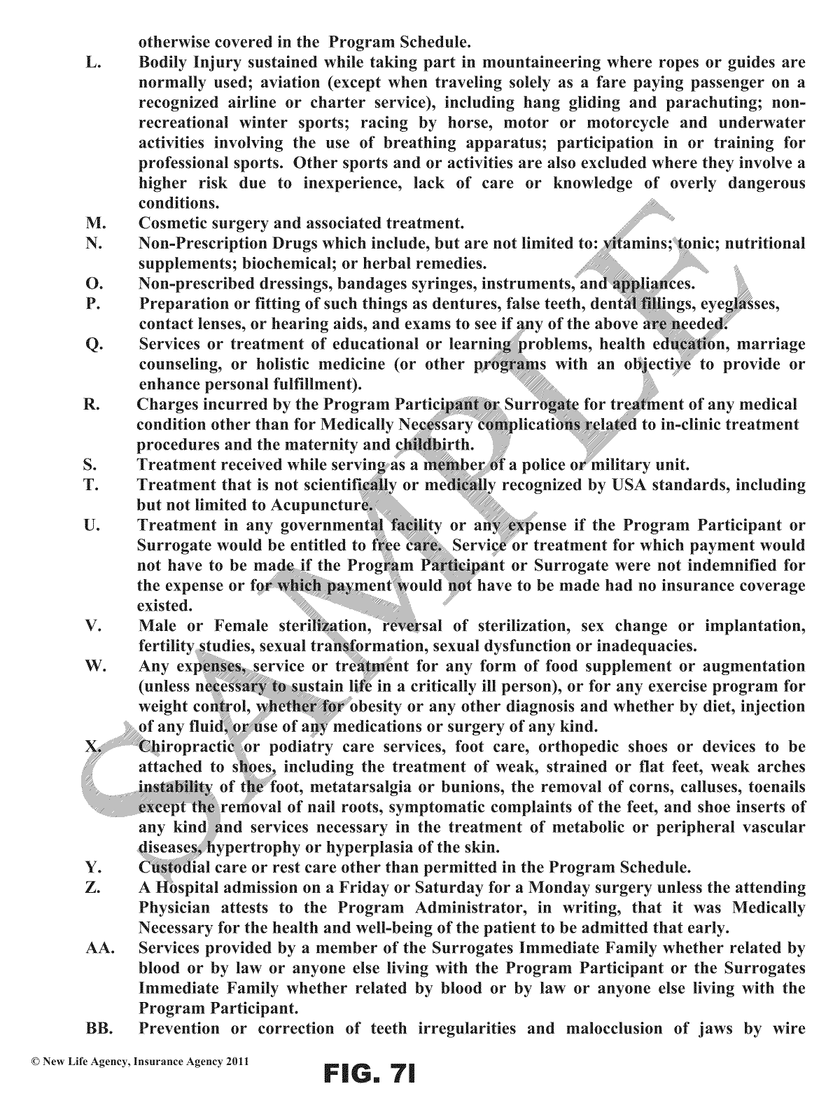

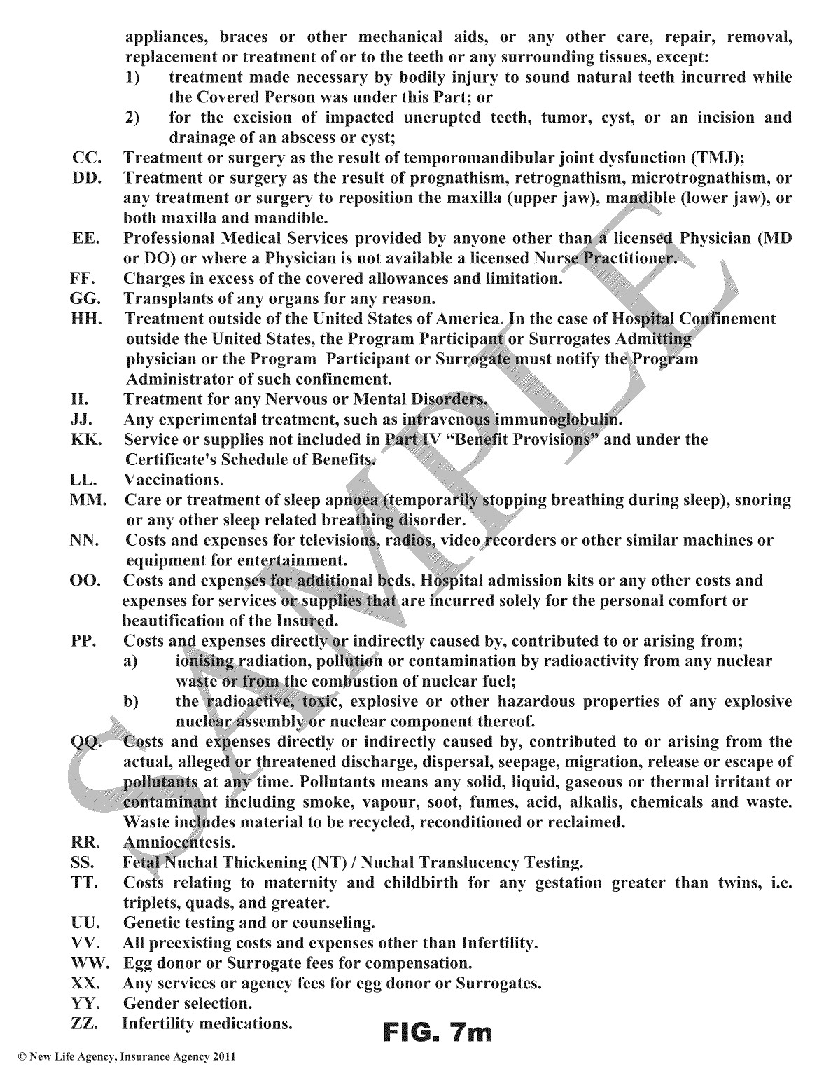

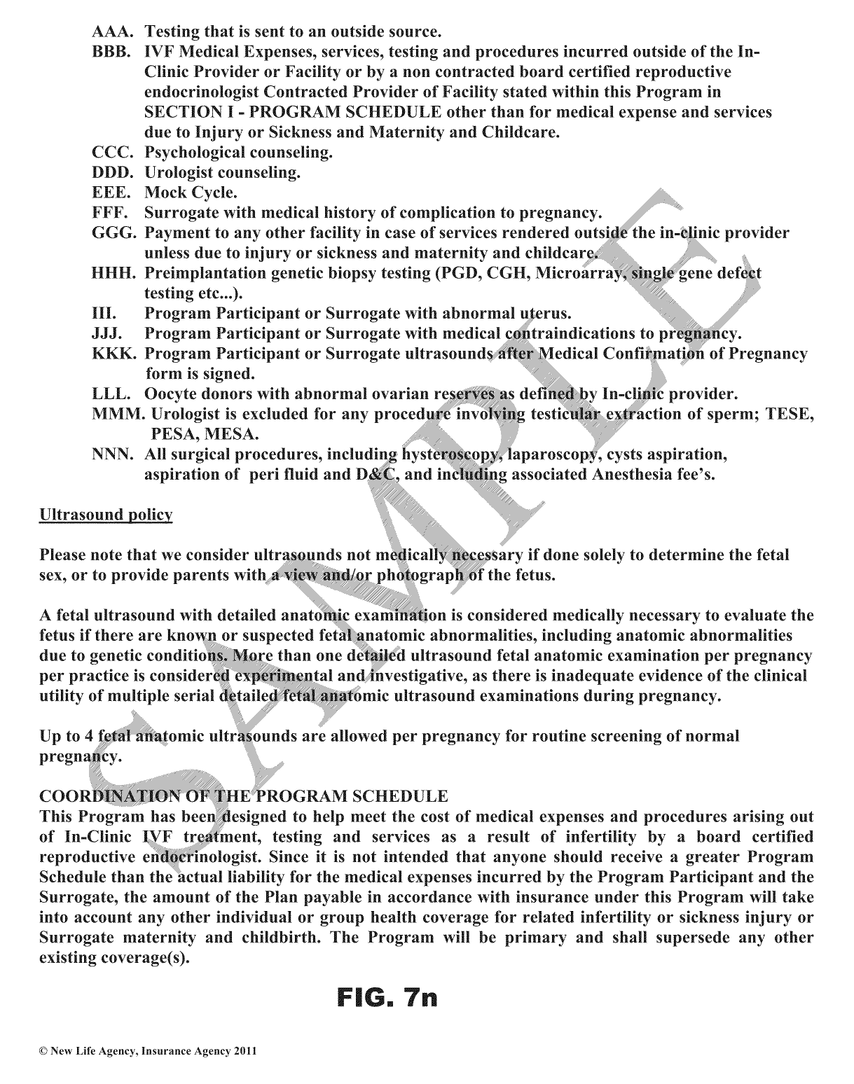

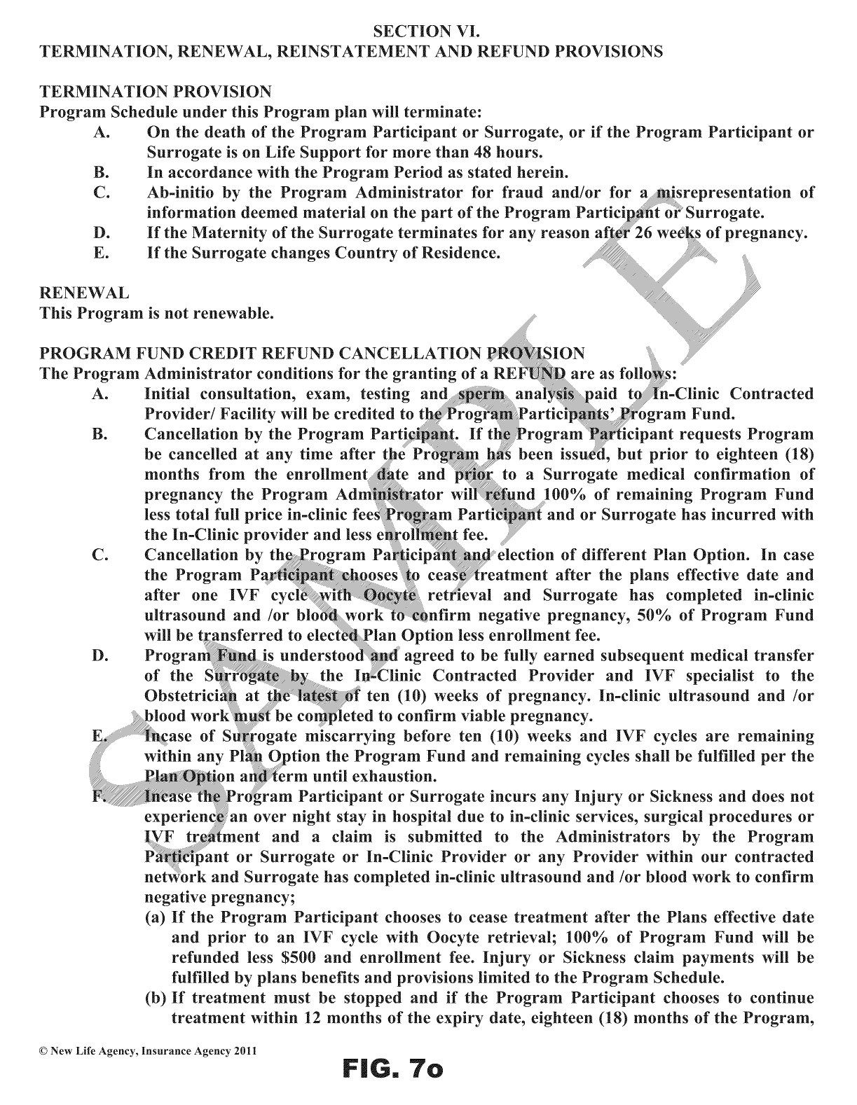

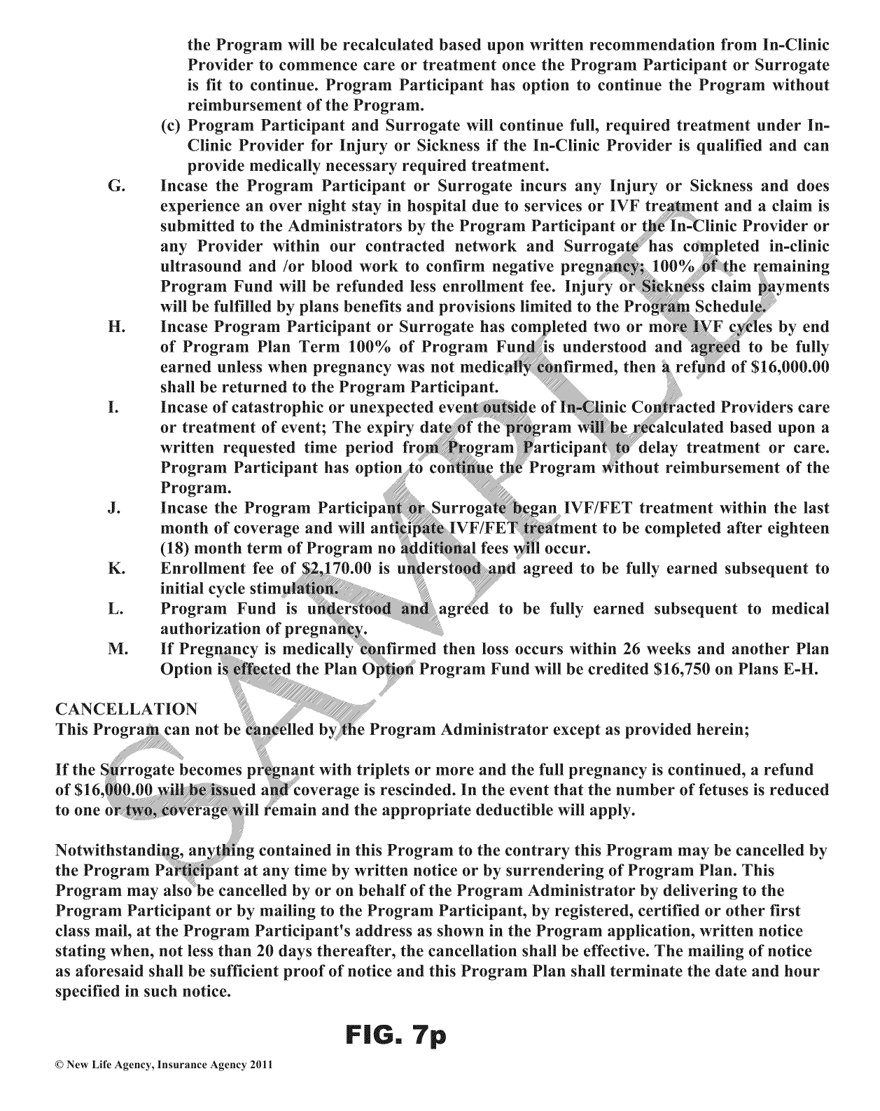

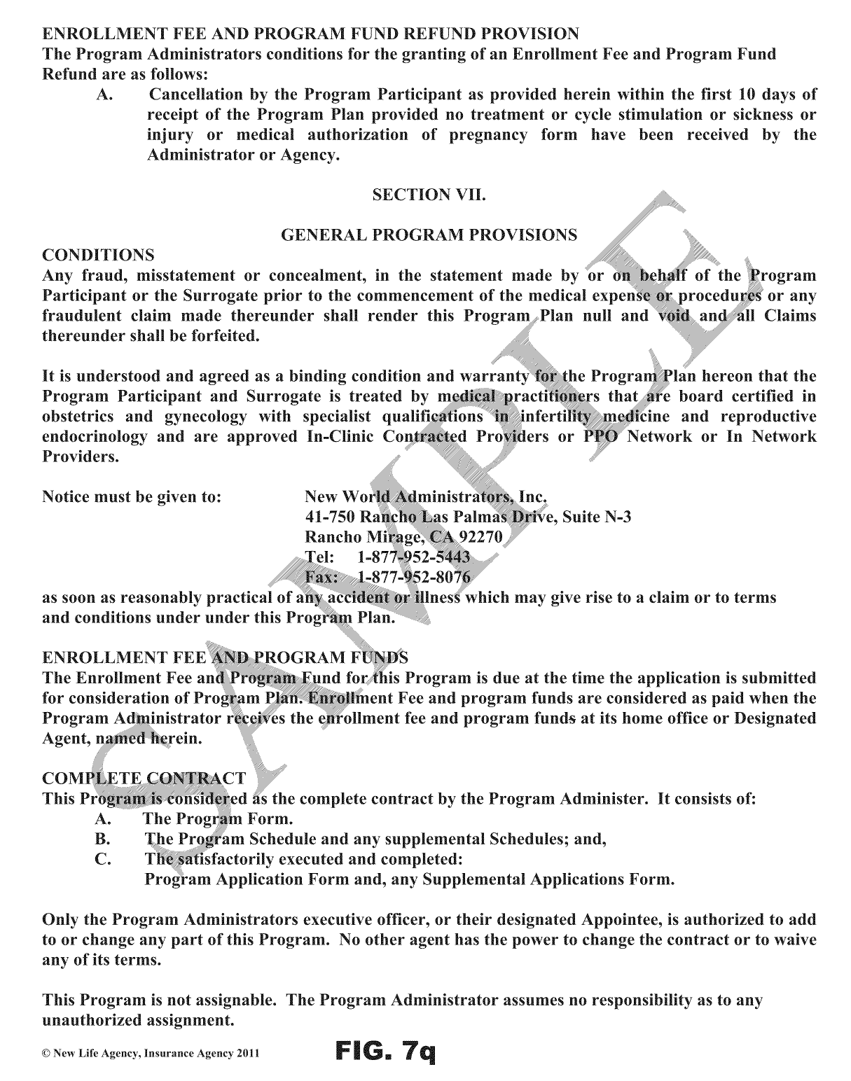

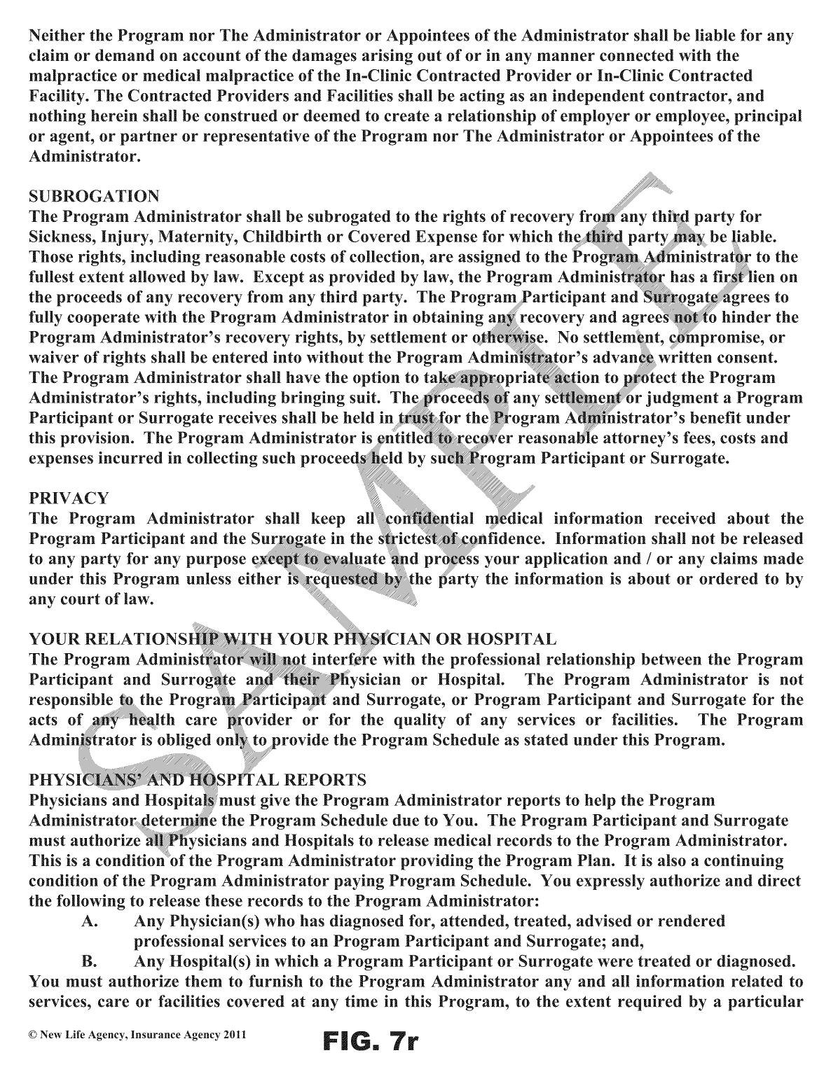

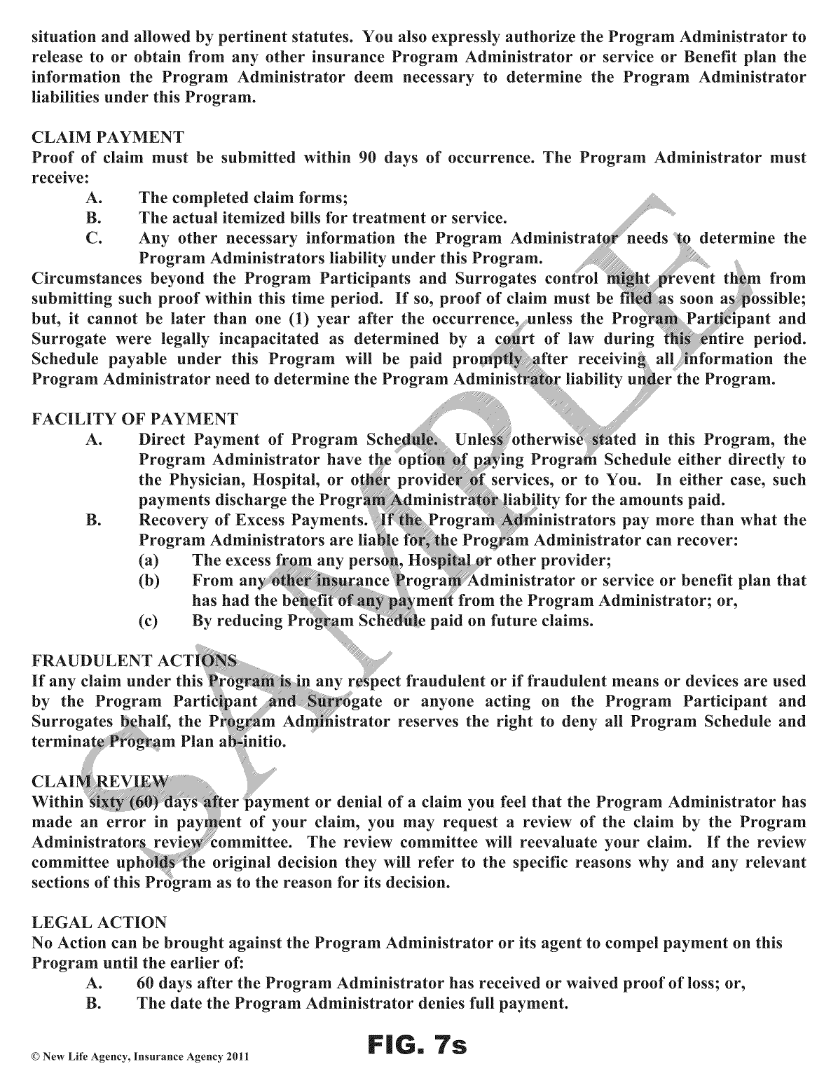

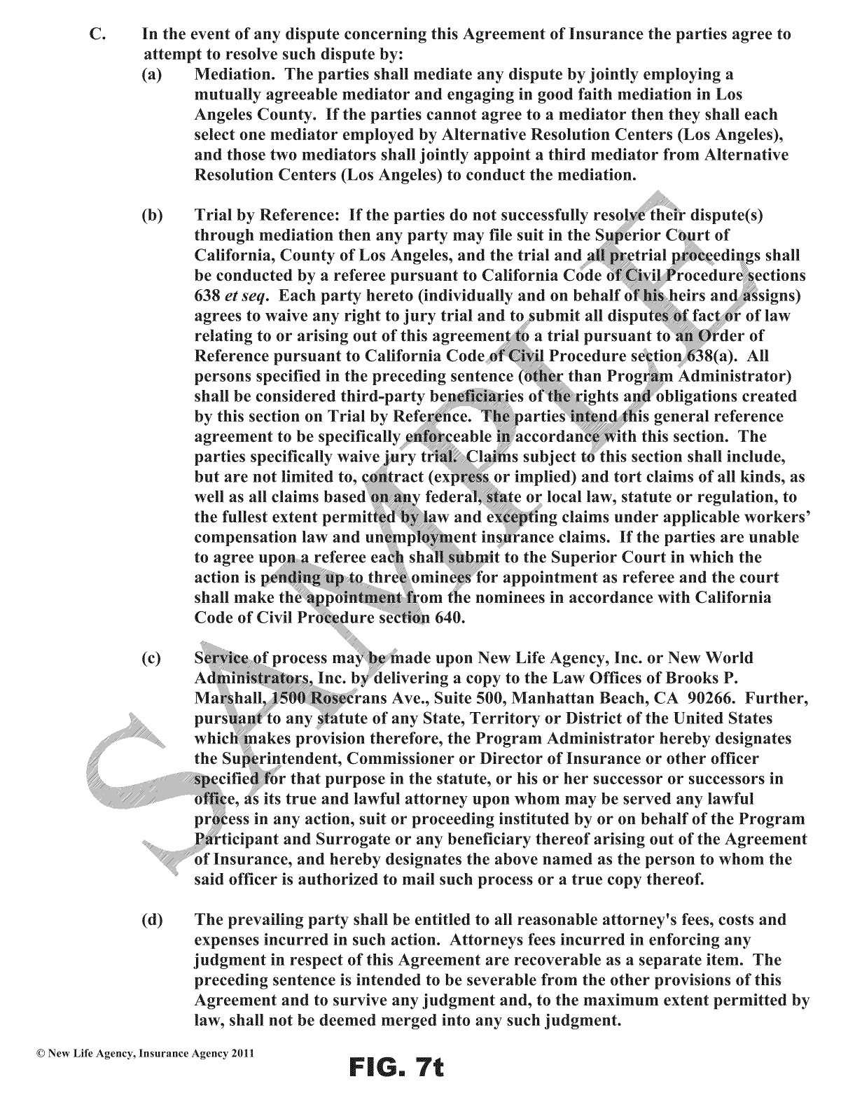

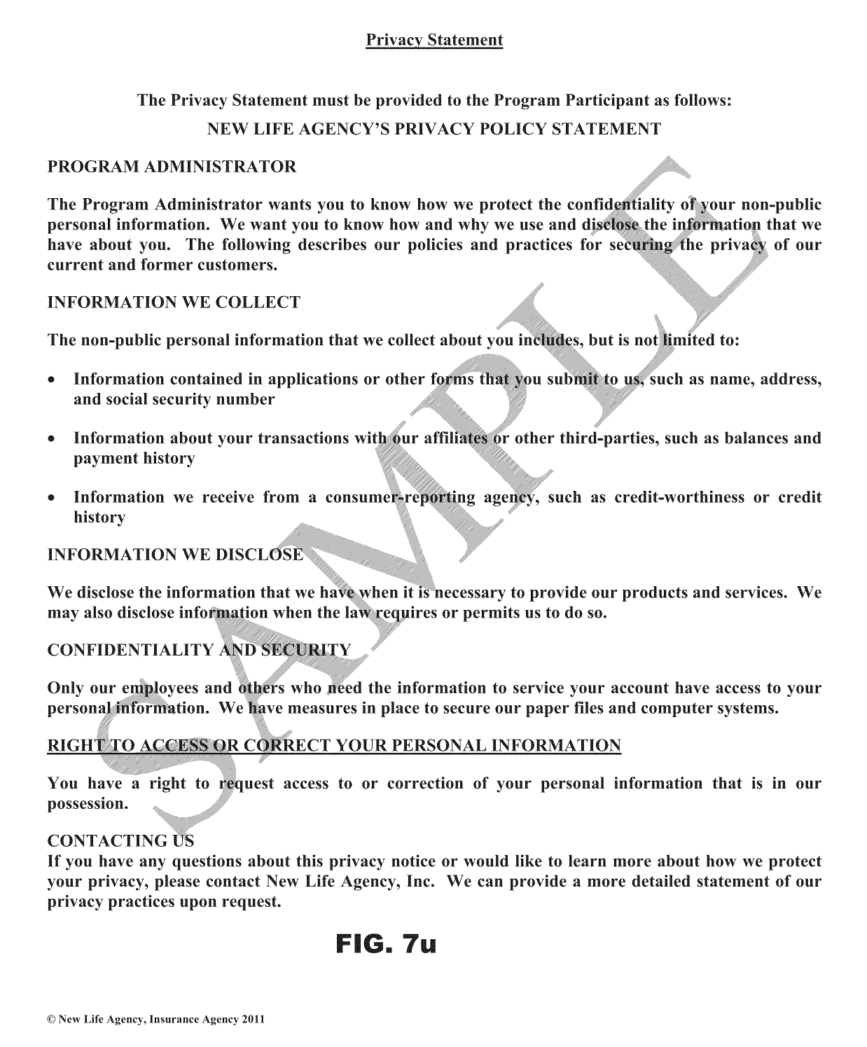

FIGS. 7 a-u are an illustration of one embodiment of an enrollment certificate for complication insurance of the present invention with surrogacy coverage.

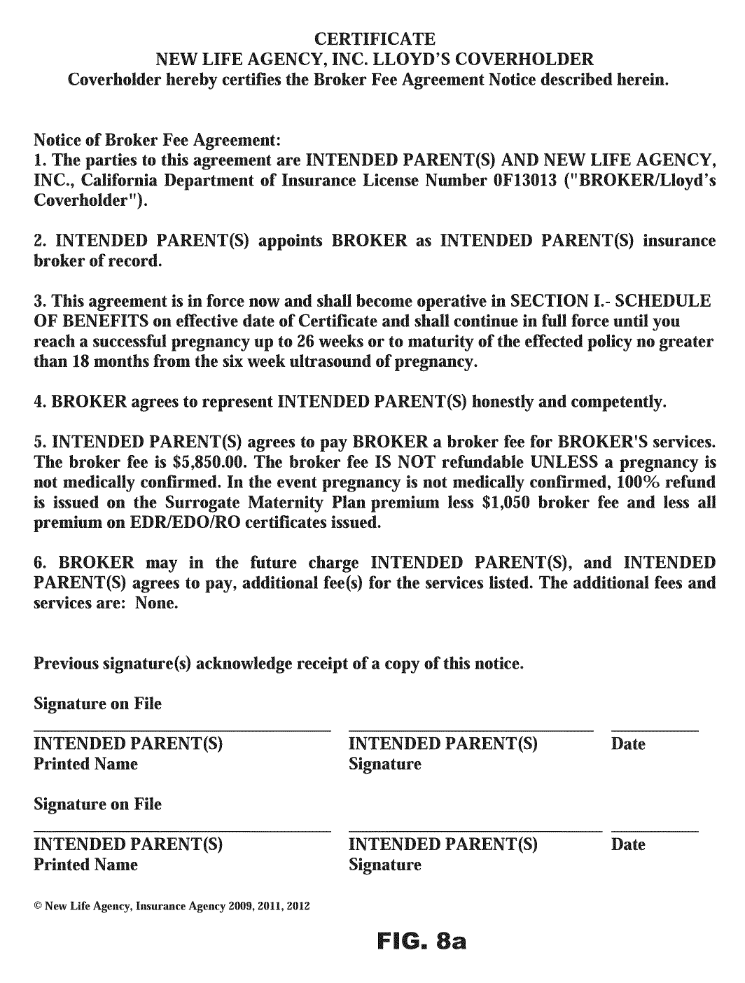

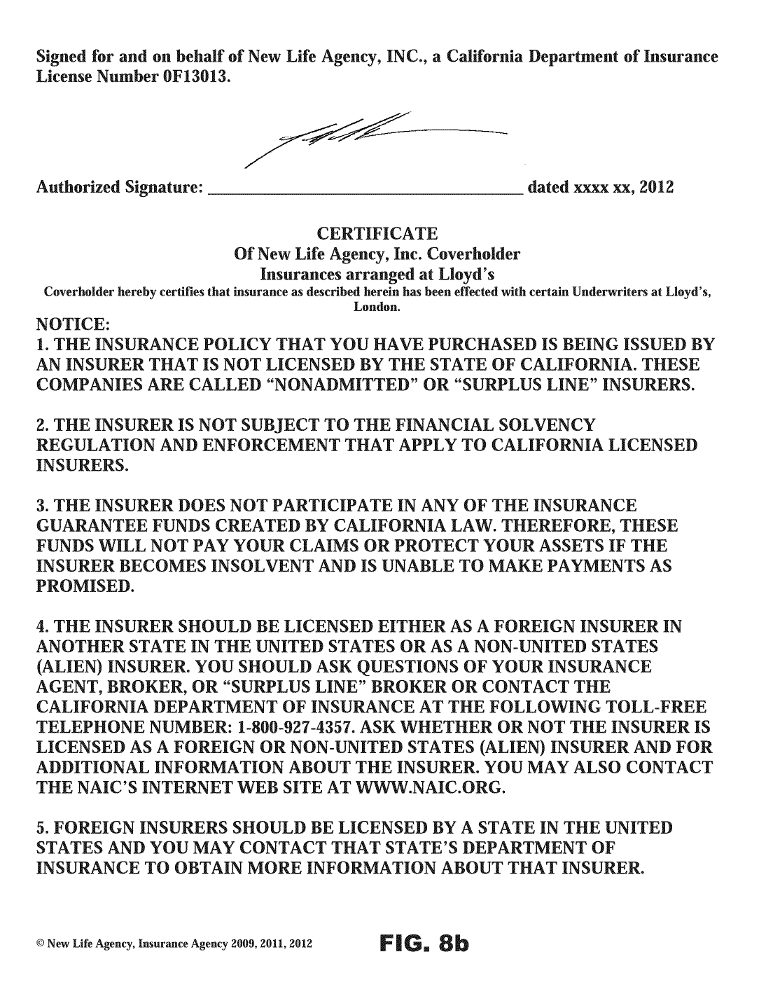

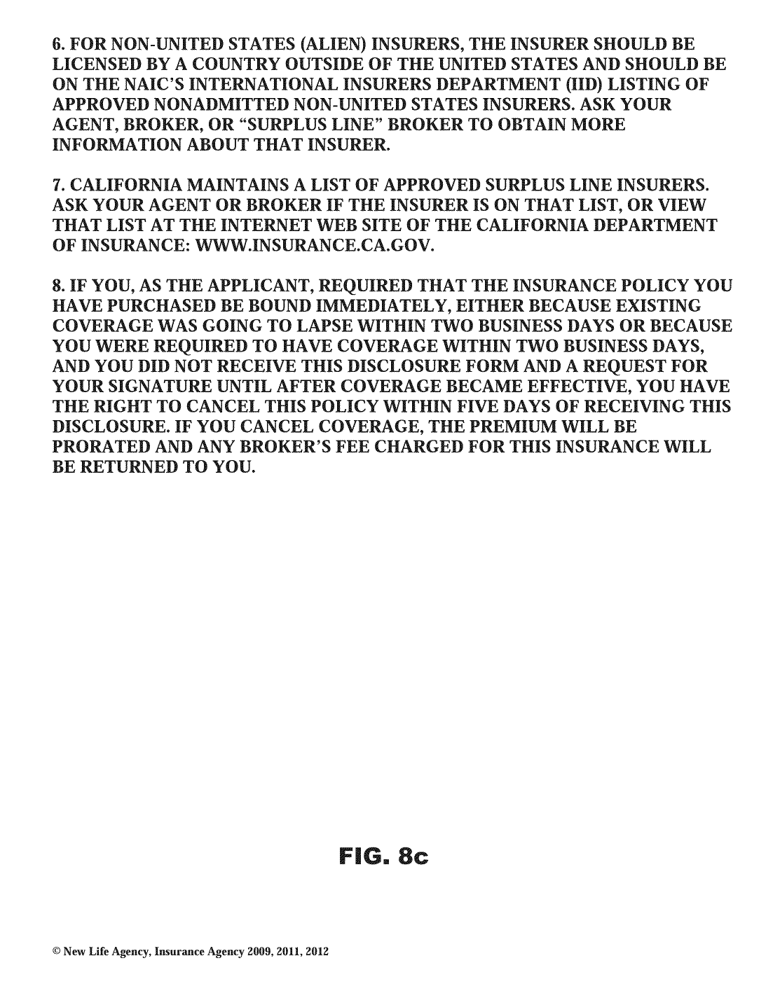

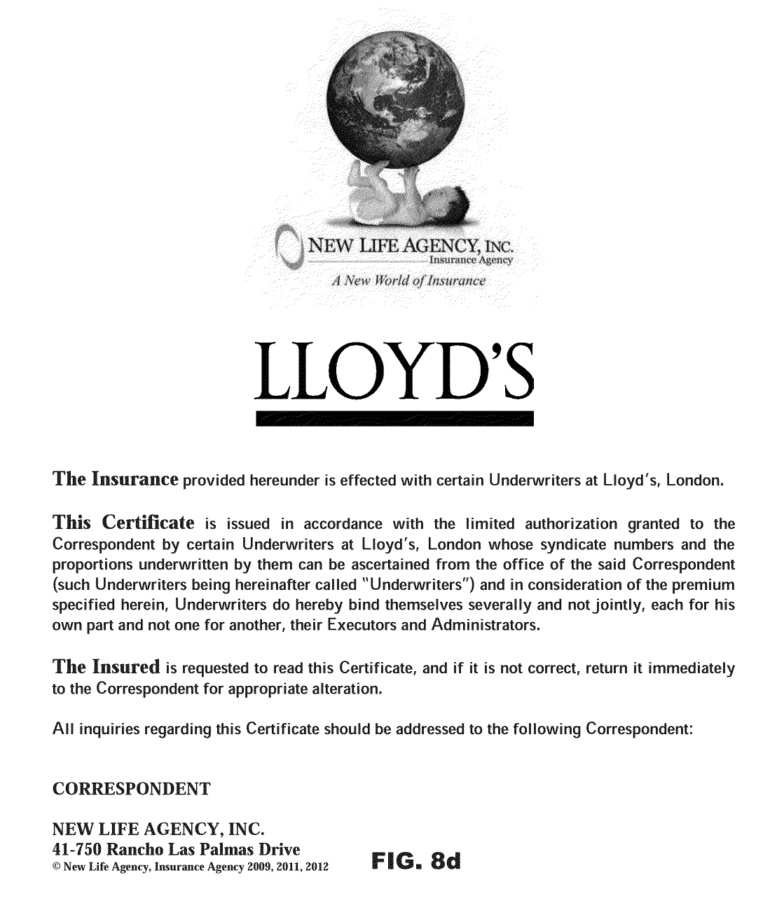

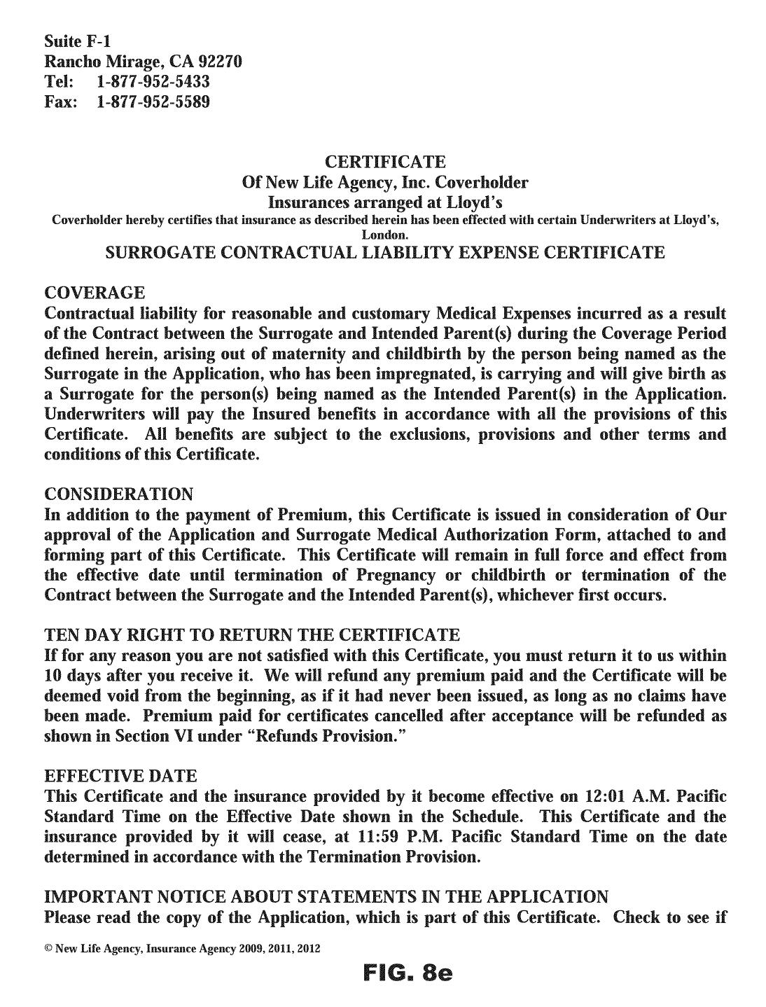

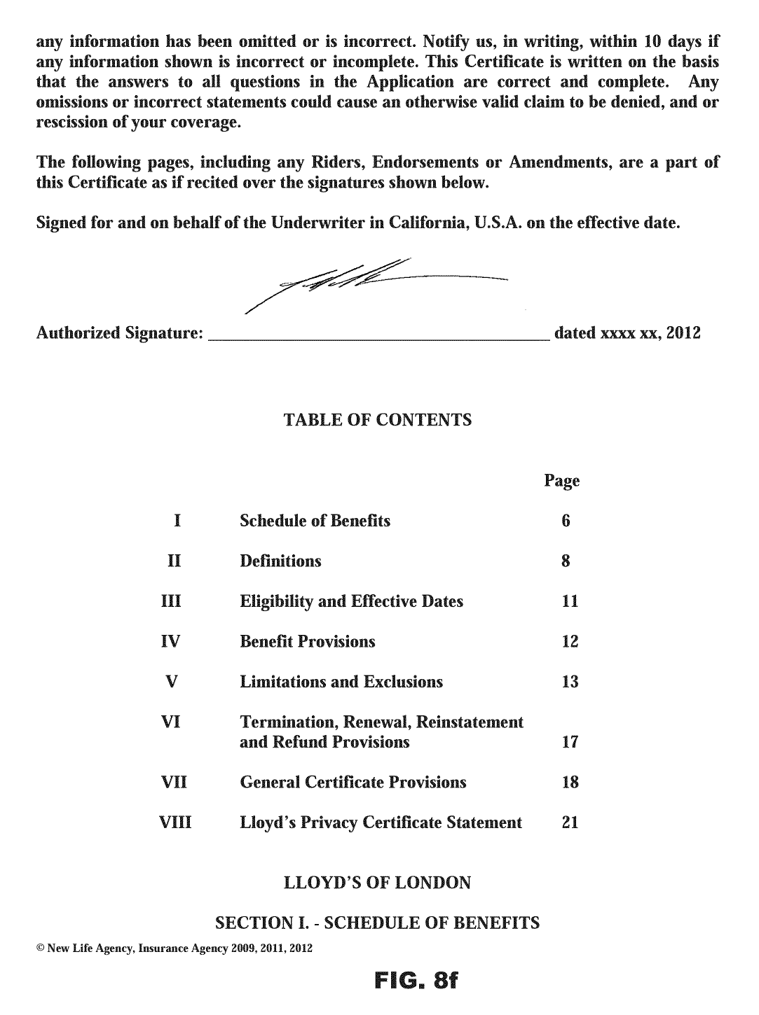

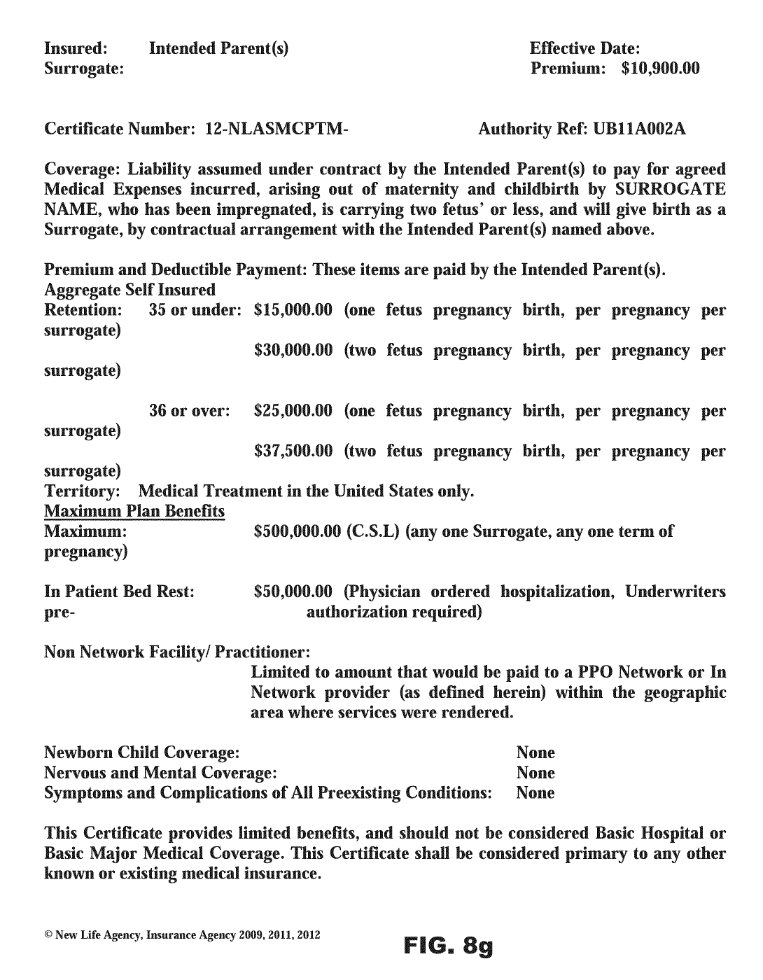

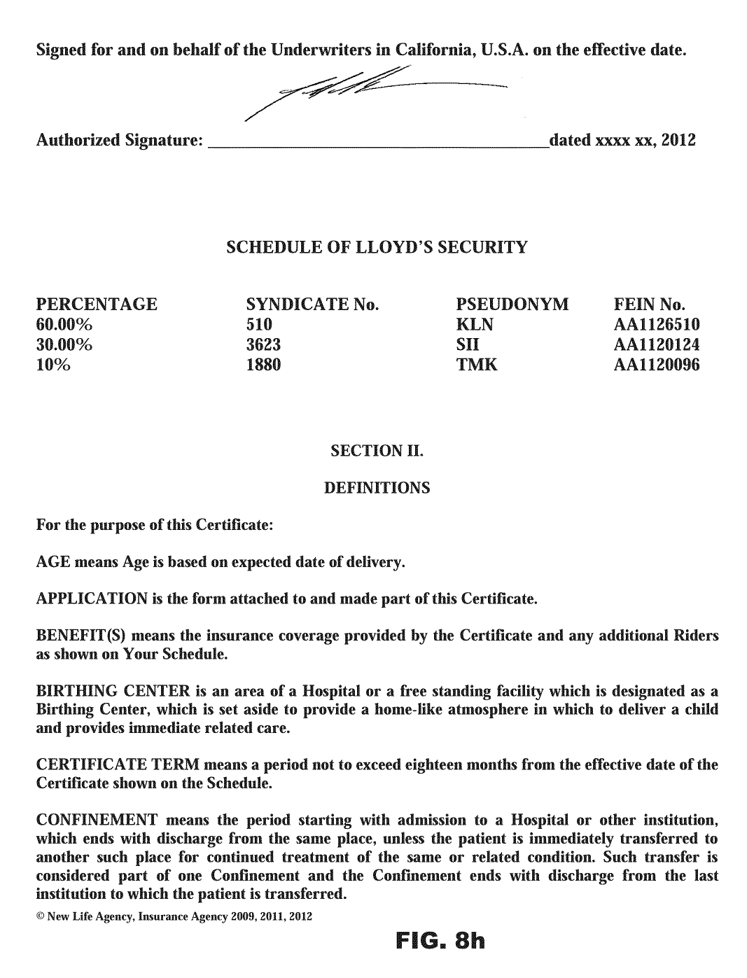

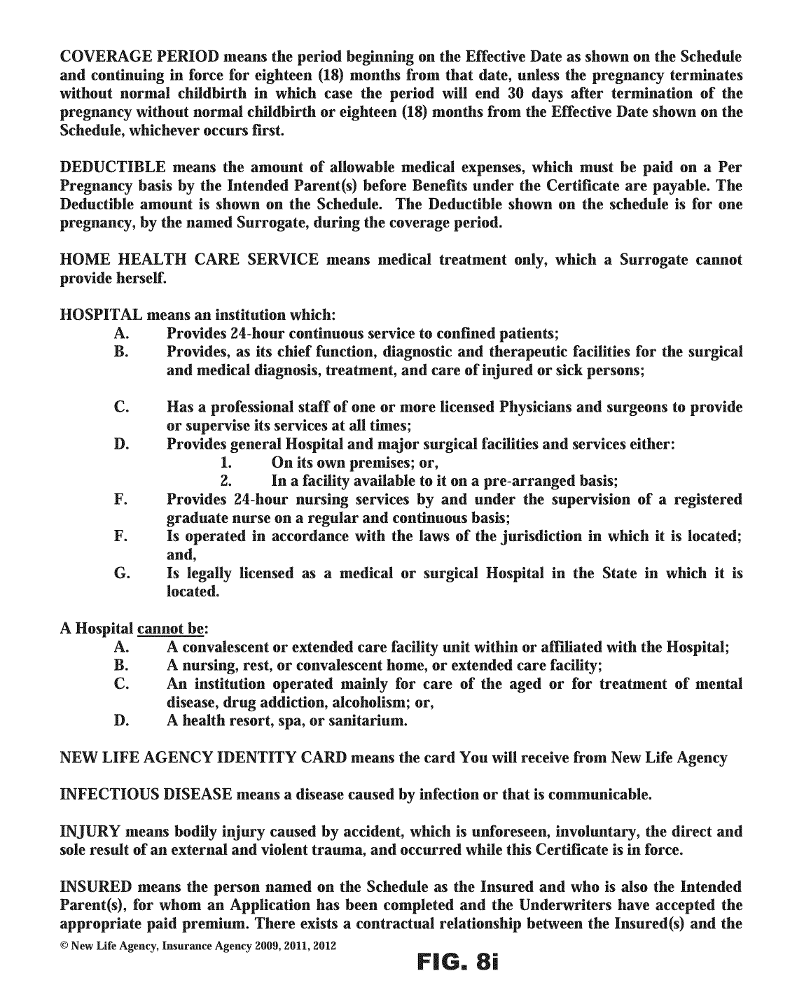

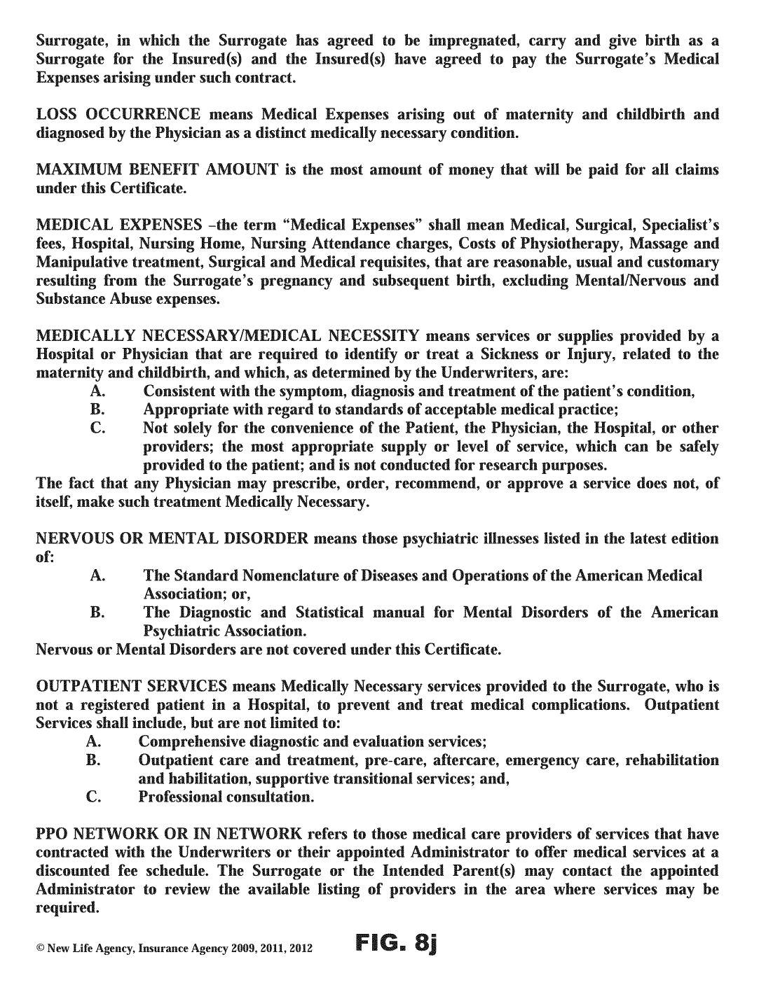

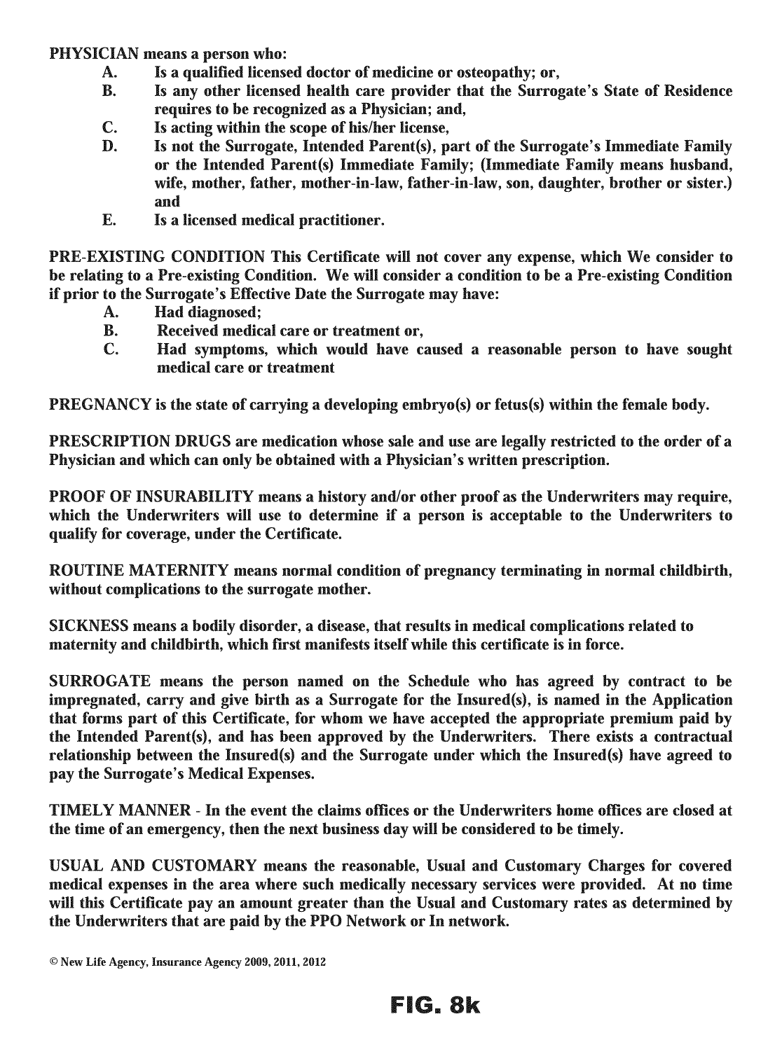

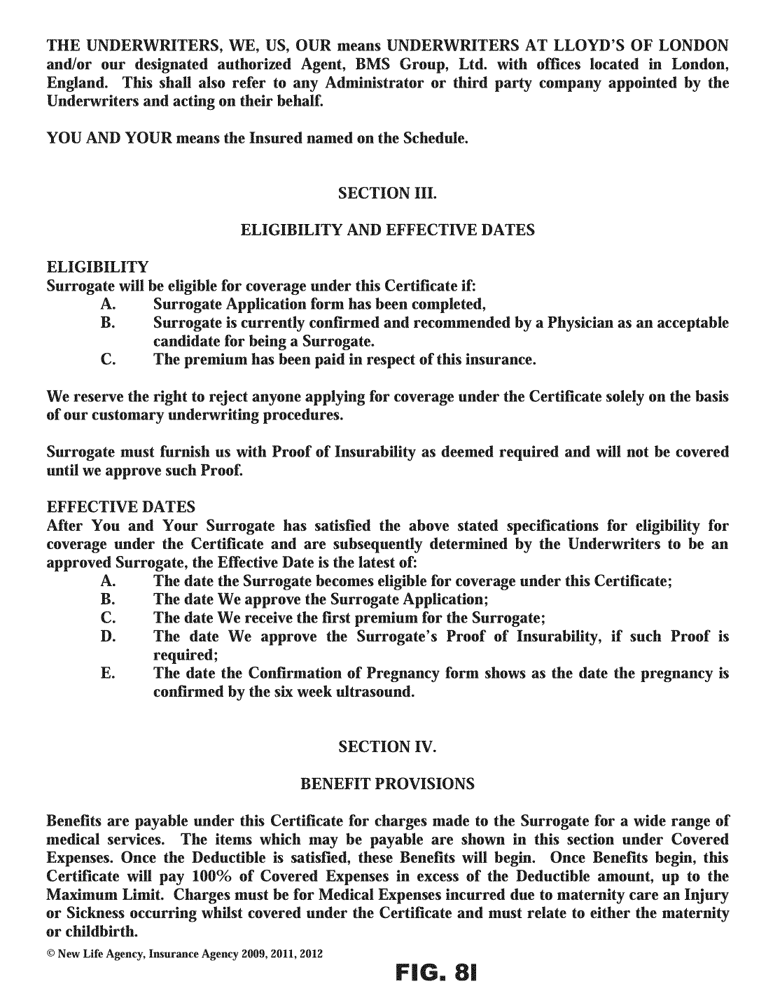

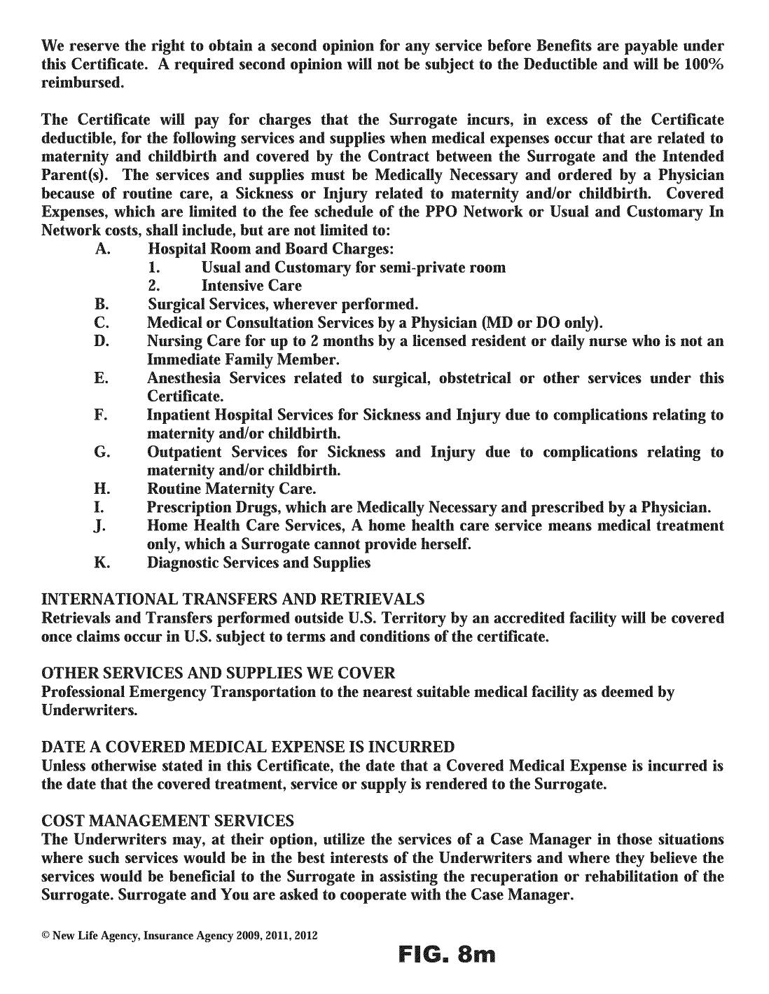

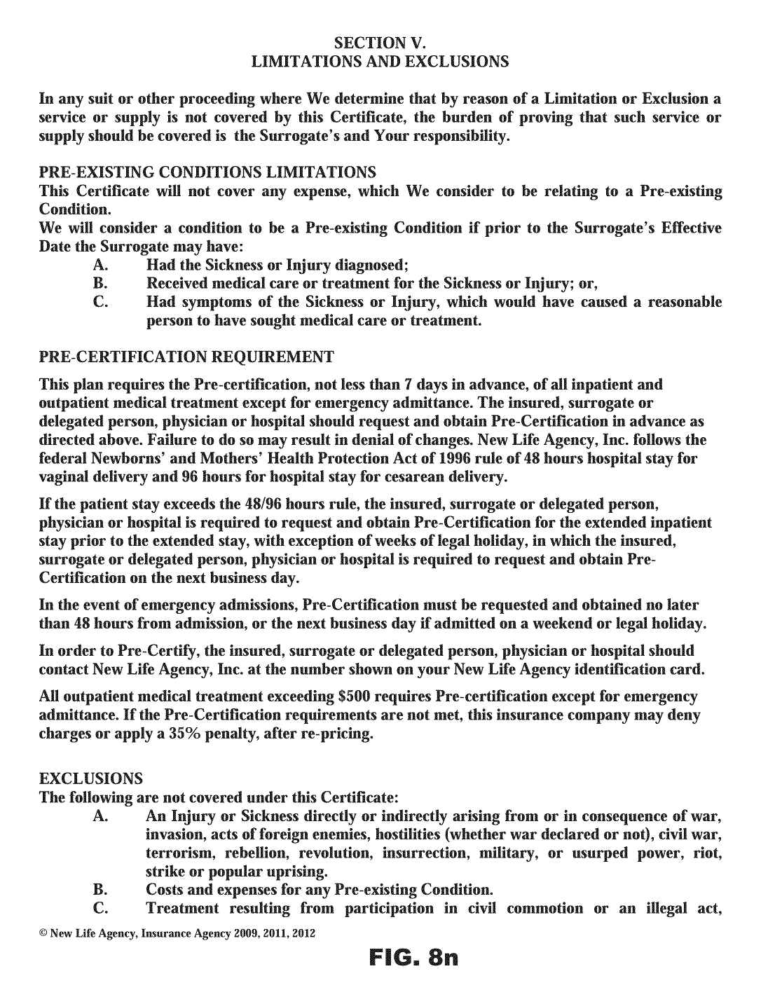

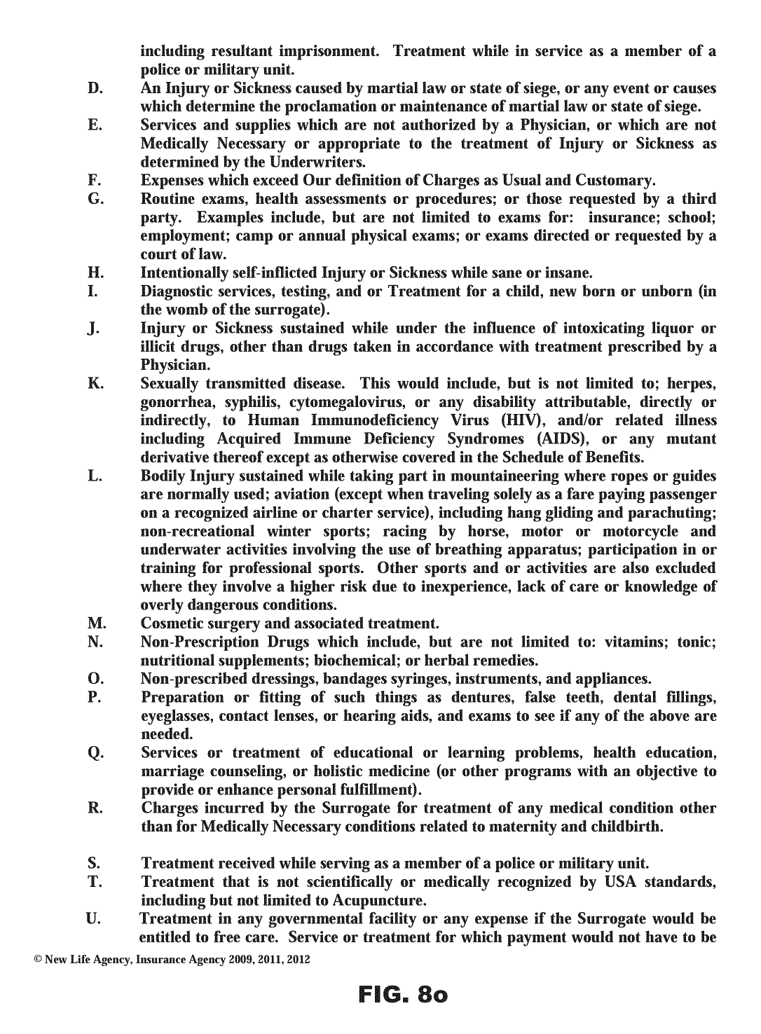

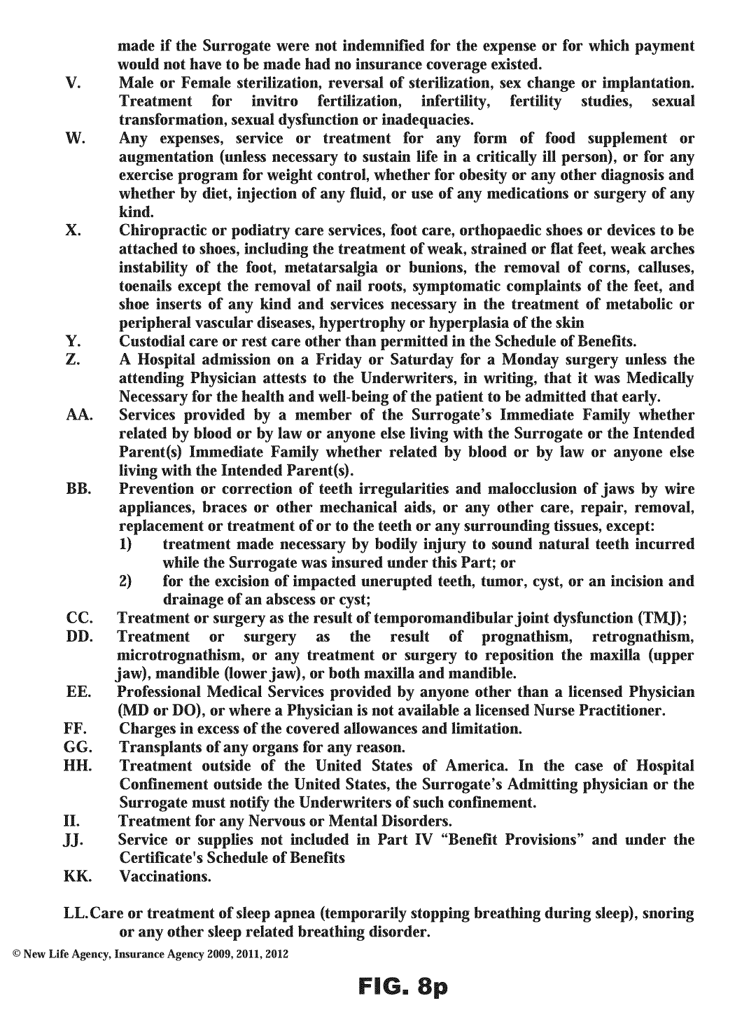

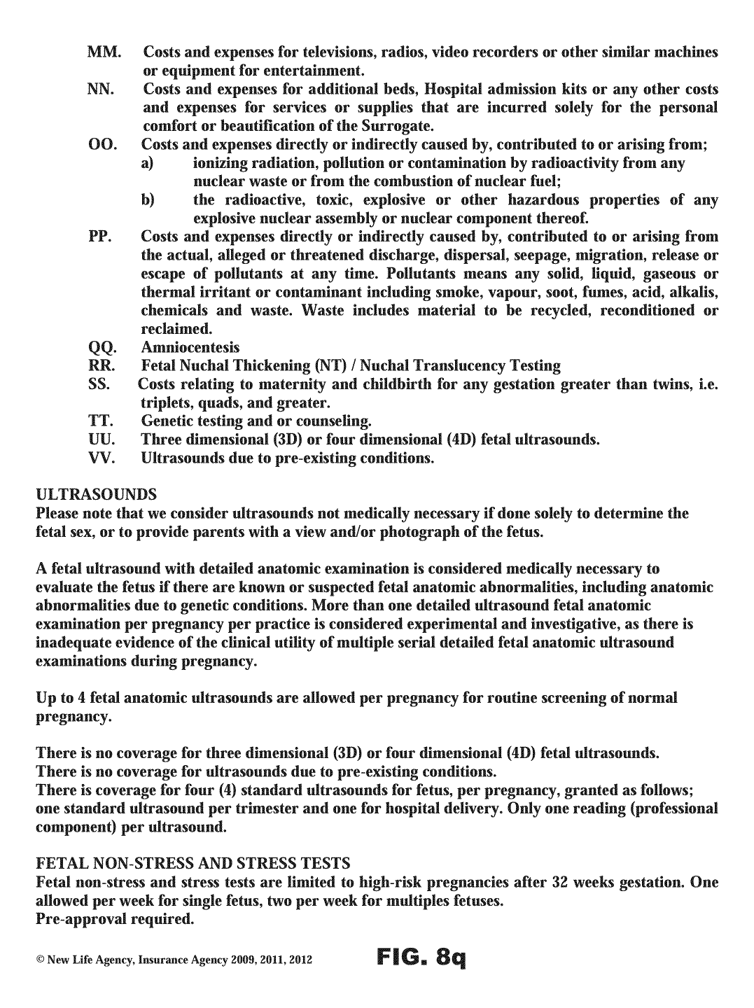

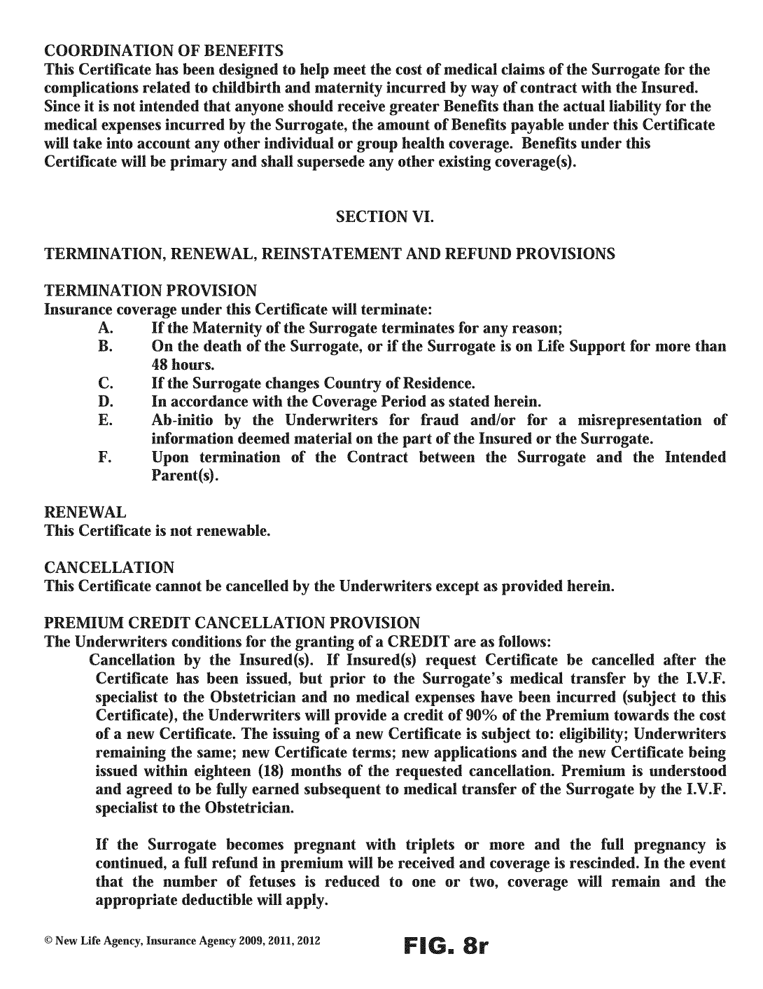

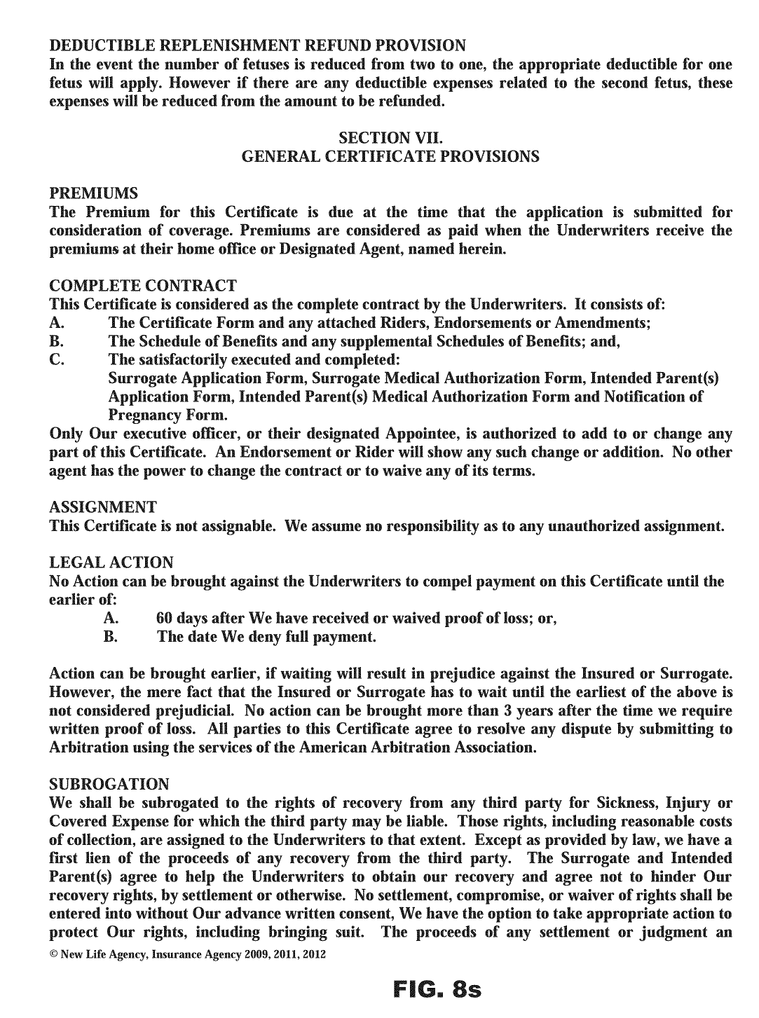

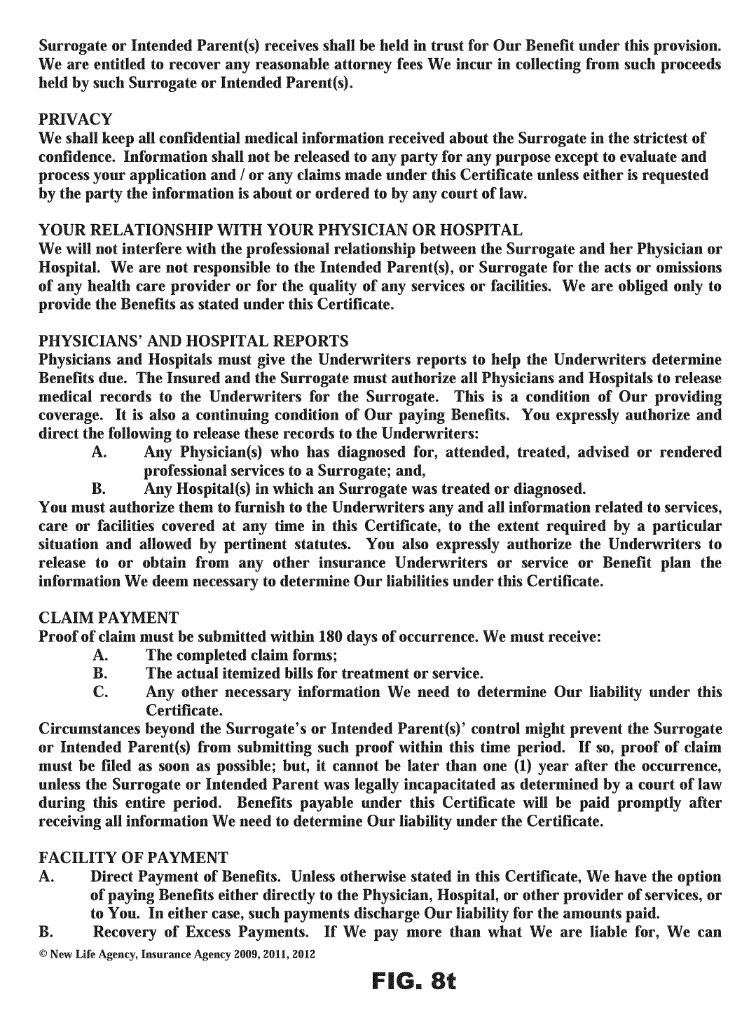

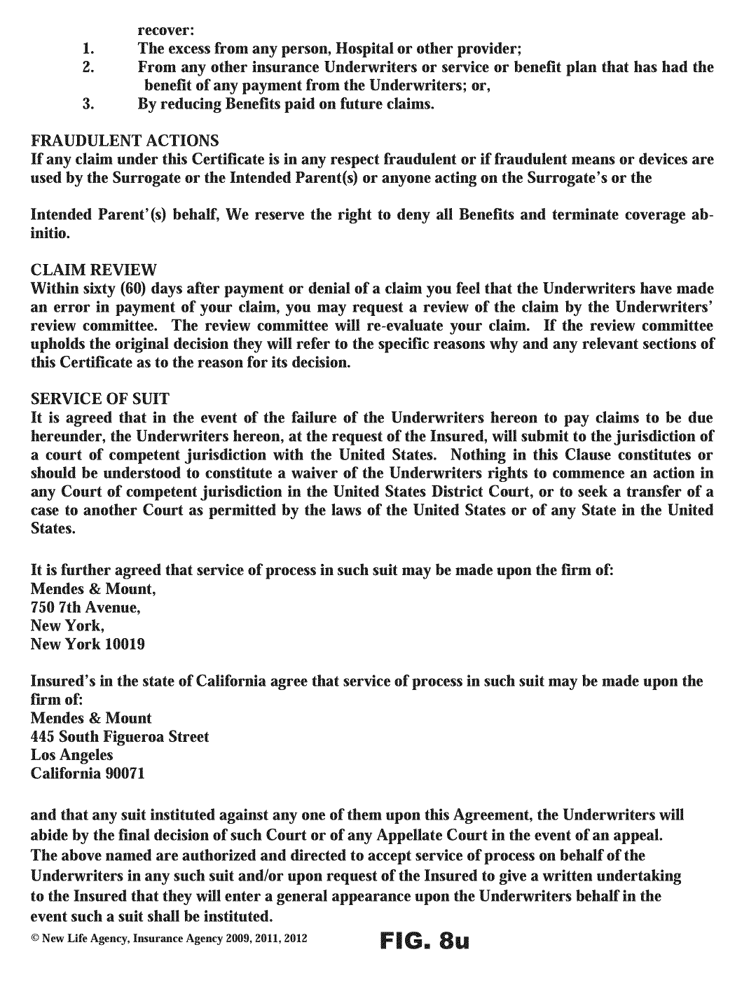

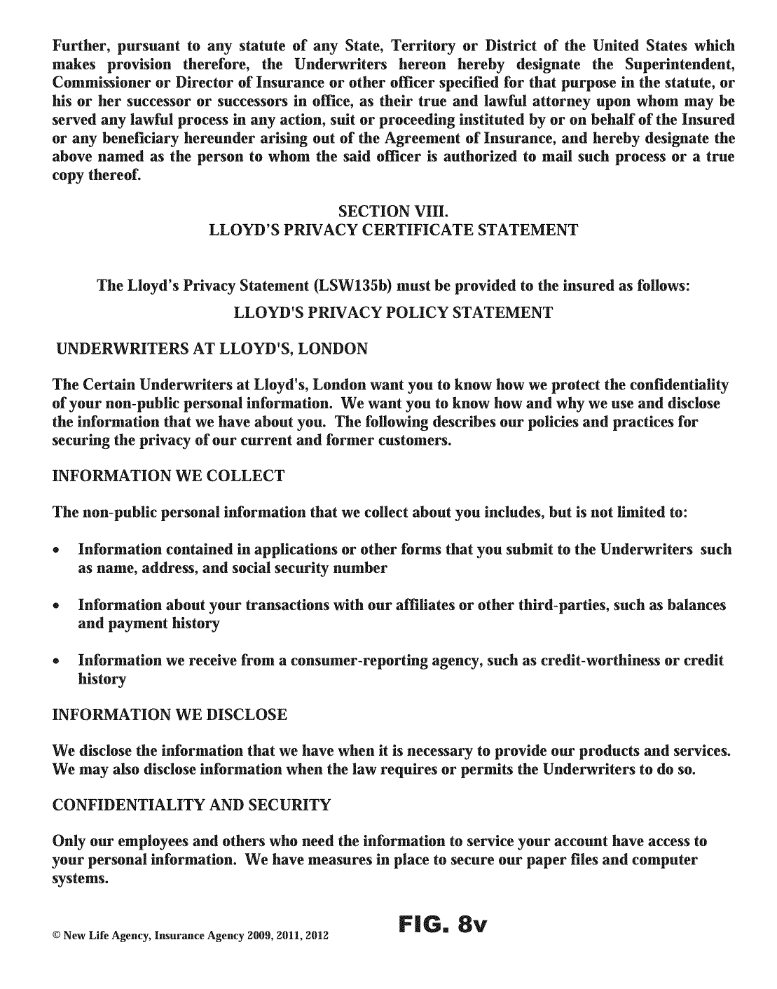

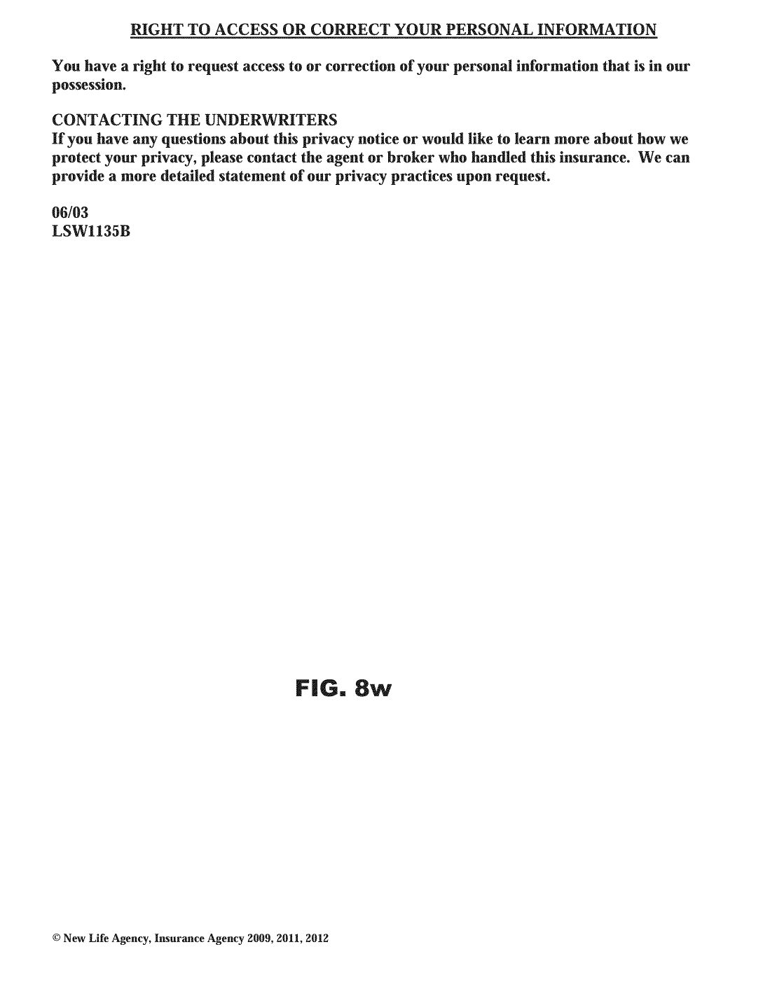

FIGS. 8 a-w are an illustration of one embodiment of an insurance certificate for complication insurance of the present invention with surrogacy pregnancy coverage.

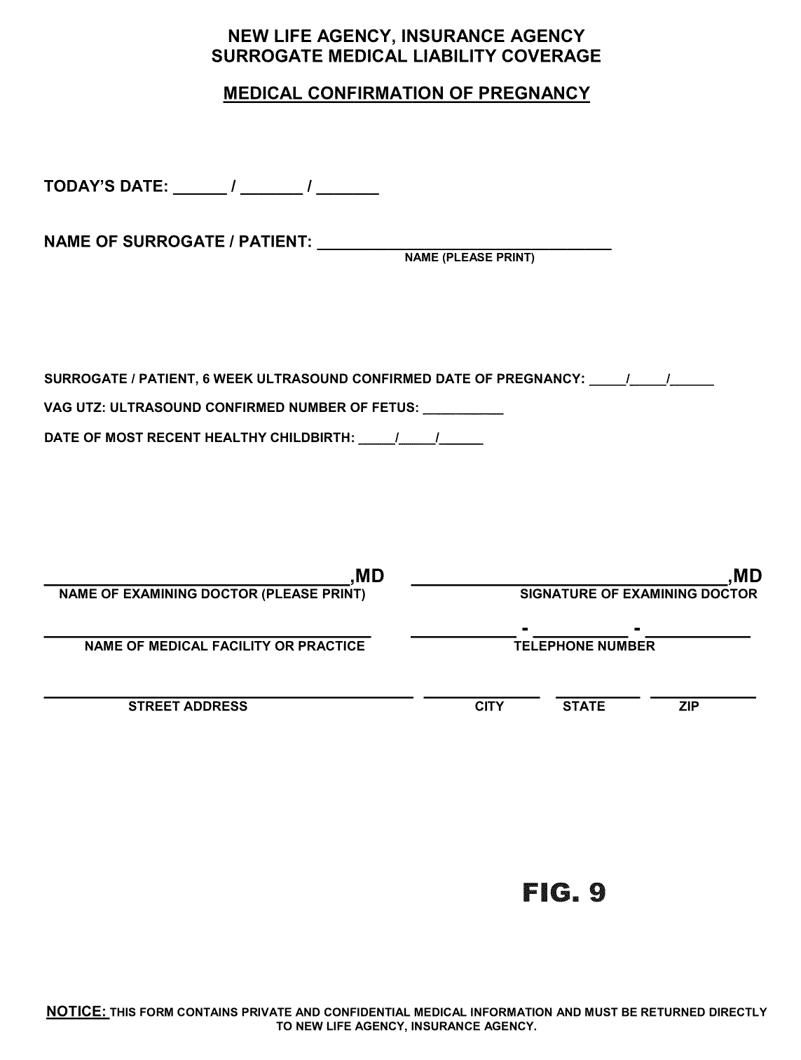

FIG. 9 is an illustration of one embodiment of a medical authorization of pregnancy form. Once the pregnancy is confirmed, the medical authorization of pregnancy form is preferably completed

Specialty medical treatment may include specialty pharmaceuticals and/or pharmacies.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method of providing discounted specialty medical treatment and complication insurance on the specialty medical treatment, the steps comprising:
contracting between a specialty medical treatment provider, an insurance agency, and an administrator to provide one or more patients with a discount on a specialty medical treatment and a complication insurance on said specialty medical treatment;
administrating by said administrator said specialty medical treatment and said complication insurance on said specialty medical treatment;
applying with said administrator by a patient for said complication insurance on said specialty medical treatment and for said specialty medical treatment;
purchasing by said patient said complication insurance on said specialty medical treatment and purchasing said specialty medical treatment;
providing to said patient by said specialty medical treatment provider with said discount on said specialty medical treatment;
providing to said patient by said insurance agency with said complication insurance on said specialty medical treatment.

2. The method of providing discounted specialty medical treatment and complication insurance on the specialty medical treatment of claim 1, wherein said specialty medical treatment provider is an In Vitro Fertilization center.

3. The method of providing discounted specialty medical treatment and complication insurance on the specialty medical treatment of claim 2, wherein said patient is one or more intended parents.

4. The method of providing discounted specialty medical treatment and complication insurance on the specialty medical treatment of claim 2, wherein said applying step includes completing at least a female application.

5. The method of providing discounted specialty medical treatment and complication insurance on the specialty medical treatment of claim 4, wherein said applying step includes completing a male application.

6. The method of providing discounted specialty medical treatment and complication insurance on the specialty medical treatment of claim 4, the steps further comprising:
completing a HIPAA form by said patient;
wherein said female application is approved by said insurance agency and a medical doctor.

7. The method of providing discounted specialty medical treatment and complication insurance on the specialty medical treatment of claim 6, the steps further comprising:
creating by said administrator an electronic and paper file for said patient;
creating by said administrator an electronic membership enrollment profile for said patient;
issuing by said administrator a membership ID card to said patient;
issuing an insurance certificate to said patient.

8. The method of providing discounted specialty medical treatment and complication insurance on the specialty medical treatment of claim 7, the steps further comprising:
submitting by said specialty medical treatment provider a regular online report to said administrator regarding one or more enrolled patients of said specialty medical treatment provider;
paying by said administrator said specialty medical treatment provider every month for said one or more enrolled patients until one event occurs from the events consisting of: pregnancy, exhausting of cycles, and payment in full.

9. The method of providing discounted specialty medical treatment and complication insurance on the specialty medical treatment of claim 8, the steps further comprising:
providing said one or more enrolled patients with a gift card and a pharmacy discount card.

10. A method of providing discounted specialty medical treatment and complication insurance on the specialty medical treatment, the steps comprising:
contracting between a specialty medical treatment provider, an insurance agency, and an administrator to provide one or more patients with a discount on a specialty medical treatment and a complication insurance on said specialty medical treatment;
marketing said discount on a specialty medical treatment and said complication insurance on said specialty medical treatment;
administrating by said administrator said specialty medical treatment and said complication insurance on said specialty medical treatment;
applying with said administrator by a patient for said complication insurance on said specialty medical treatment and for said specialty medical treatment by having said patient complete at least a female application;
wherein said female application is approved by said insurance agency and a medical doctor;
purchasing by said patient said complication insurance on said specialty medical treatment and purchasing said specialty medical treatment;
providing to said patient by said specialty medical treatment provider with said discount on said specialty medical treatment;
providing to said patient by said insurance agency with said complication insurance on said specialty medical treatment;
wherein said specialty medical treatment provider is an In Vitro Fertilization center;
completing a HIPAA form by said patient;
creating by said administrator an electronic and paper file for said patient;
creating by said administrator an electronic membership enrollment profile;
completing a medical authorization of pregnancy form by said patient if maternity plan is purchased;
issuing by said administrator a membership ID card to said patient;
issuing an insurance certificate to said patient;
submitting by said specialty medical treatment provider a regular online report to said administrator regarding one or more enrolled patients of said specialty medical treatment provider;
paying by said administrator said specialty medical treatment provider every month for said one or more enrolled patients until one event occurs from the events consisting of: pregnancy, exhausting of cycles, and payment in full;
providing said one or more enrolled patients with a gift card and a pharmacy discount card.

11. A computer-based method of administrating and providing discounted specialty medical treatment and complication insurance on the specialty medical treatment, the steps comprising:
contracting between a specialty medical treatment provider, an insurance agency, and an administrator to provide one or more patients with a discount on a specialty medical treatment and a complication insurance on said specialty medical treatment;
providing a computer-based program for administering said specialty medical treatment and complication insurance;
wherein said computer-based program for administering said specialty medical treatment and said complication insurance is operated by said administrator and is accessible to said insurance agency and said specialty medical treatment provider;
applying with said administrator by a patient for said complication insurance on said specialty medical treatment and for said specialty medical treatment;
purchasing by said patient said complication insurance on said specialty medical treatment and purchasing said specialty medical treatment;
providing to said patient by said specialty medical treatment provider with said discount on said specialty medical treatment;
providing to said patient by said insurance agency with said complication insurance on said specialty medical treatment.

12. The computer-based method of administrating and providing discounted specialty medical treatment and complication insurance on the specialty medical treatment, of claim 11, wherein said specialty medical treatment provider is an In Vitro Fertilization center.

13. The computer-based method of administrating and providing discounted specialty medical treatment and complication insurance on the specialty medical treatment, of claim 12, wherein said patient is one or more intended parents.

14. The computer-based method of administrating and providing discounted specialty medical treatment and complication insurance on the specialty medical treatment, of claim 12, wherein said applying step includes completing at least a female application.

15. The computer-based method of administrating and providing discounted specialty medical treatment and complication insurance on the specialty medical treatment, of claim 14, wherein said applying step includes completing a male application.

16. The computer-based method of administrating and providing discounted specialty medical treatment and complication insurance on the specialty medical treatment, of claim 14, the steps further comprising:
completing a HIPAA form by said patient;
wherein said female application is approved by said insurance agency and a medical doctor.

17. The computer-based method of administrating and providing discounted specialty medical treatment and complication insurance on the specialty medical treatment, of claim 16, the steps further comprising:
creating by said administrator paper file for said patient;
creating by said administrator an electronic file for said patient on said computer-based program for administering said specialty medical treatment and complication insurance;
creating by said administrator an electronic membership enrollment profile for said patient on said computer-based program for administering said specialty medical treatment and complication insurance;
issuing by said administrator a membership ID card to said patient;
generating an insurance certificate by said computer-based program for administering said specialty medical treatment and complication insurance;
issuing said insurance certificate to said patient.

18. The computer-based method of administrating and providing discounted specialty medical treatment and complication insurance on the specialty medical treatment, of claim 17, the steps further comprising:
submitting by said specialty medical treatment provider a regular online report to said administrator regarding one or more enrolled patients of said specialty medical treatment provider on said computer-based program for administering said specialty medical treatment and complication insurance;
paying by said administrator said specialty medical treatment provider every month for said one or more enrolled patients until one event occurs from the events consisting of: pregnancy, exhausting of cycles, and payment in full.

19. The computer-based method of administrating and providing discounted specialty medical treatment and complication insurance on the specialty medical treatment, of claim 18, the steps further comprising:
providing said one or more enrolled patients with a gift card and a pharmacy discount card;
wherein said pharmacy discount card is part of a computer-based discount management program.
